(19) United States
(12) Patent Application Publication
(10) Pub. No.: US 2012/0291205 A1
(43) Pub. Date: Nov. 22, 2012

(54) MATTRESS ASSEMBLIES AND RELATED METHODS EMPLOYING ELASTIC BAND(S) ENCASEMENT, INCLUDING FOR BEDDING AND SEATING APPLICATIONS

(75) Inventors: Christopher Dean Page, Nashville, NC (US); Timothy Michael Witherell, Gastonia, NC (US)

(73) Assignee: NOMACO INC., Zebulon, NC (US)

(21) Appl. No.: 13/473,141

(22) Filed: May 16, 2012

Related U.S. Application Data
(60) Provisional application No. 61/488,000, filed on May 19, 2011.
(60) Provisional application No. 61/521,130, filed on Aug. 8, 2011.

(51) Int. Cl. A47C 27/00; B68G 7/05; A47C 31/00

(52) U.S. Cl. 5/724; 5/739; 29/450

(57) ABSTRACT

Mattress assemblies and related methods employing elastic bands to provide at least a portion of an encasement, including for bedding and seating applications are disclosed. In one embodiment, a mattress assembly is provided. The mattress assembly may include a mattress core and an elastic foam edge-support band compressively engaged along the outer perimeter of the mattress core. The mattress core has a sleep surface and an outer perimeter width and length disposed in a corresponding width and length dimension of the sleep surface. Before assembly, the elastic foam edge-support band has a preassembled inner perimeter width and length, which are less in distance than the width and length of the mattress core. As disposed in the mattress assembly, the elastic foam edge-support band has an assembled inner perimeter width and length which are greater in distance than the preassembled inner perimeter width and length of the elastic foam edge-support band.

### PRIORITY APPLICATIONS

The present application claims priority to U.S. Patent Application Ser. No. 61/488,000 entitled “MATTRESS ASSEMBLIES AND RELATED METHODS EMPLOYING ELASTIC BAND(S) ENCASEMENT, INCLUDING FOR BEDDING AND SEATING APPLICATIONS” filed on May 19, 2011, which is incorporated herein by reference in its entirety.

The present application also claims priority to U.S. Patent Application Ser. No. 61/521,130 entitled “MATTRESS ASSEMBLIES AND RELATED METHODS EMPLOYING ELASTIC BAND(S) ENCASEMENT, INCLUDING FOR BEDDING AND SEATING APPLICATIONS” filed on Aug. 8, 2011, which is incorporated herein by reference in its entirety.

### RELATED APPLICATION

The present application is related to U.S. patent application Ser. No. 12/694,562 entitled “EXPANDABLE EDGE-SUPPORT MEMBERS, ASSEMBLIES, AND RELATED METHODS, SUITABLE FOR BEDDING AND SEATING APPLICATIONS AND INNERSPRINGS” filed on Jan. 27, 2010.

### FIELD OF THE DISCLOSURE

The technology of the disclosure relates generally to mattress assemblies, mattresses, and related methods providing support, including perimeter, edge, side, corner, and internal support, which may be employed in bedding and seating applications.

### BACKGROUND

Innerspring assemblies for mattresses or seating structures can be composed of a plurality of spring coils tied together in a matrix or array. An example of such an innerspring assembly is illustrated by the mattress 10 of FIG. 1. As illustrated therein, a mattress innerspring 12 (also called “innerspring 12” and “innerspring coil mattress core 12”) is provided as part of the mattress 10. Prior to its assembly of the innerspring 12 in the mattress 10 in FIG. 1, the innerspring 12 in this example is shown in FIG. 2. As illustrated in FIG. 2, the innerspring 12 has an outer perimeter width W, length L, and a height H based on the size and design requirements for the innerspring 12. As also shown in FIG. 2, the innerspring 12 is comprised of a plurality of traditional coils 14 arranged in an interconnected matrix to form a flexible core structure and support surfaces of the mattress. Adjacent coils 14 are secured to one another by lower interconnection helical wires 16 and upper interconnection helical wires 17. Perimeter innerspring coils of the traditional innerspring mattress core 12 are also connected to one another by upper and lower border wires 18, 20. Upper and lower border wires 18, 20 are attached to upper and lower end turns of the coils 14 to create a frame for the innerspring 12. The upper and lower border wires 18, 20 may provide firmness for edge support on the perimeter of the innerspring mattress core 12 where an individual may disproportionally place force on the innerspring mattress core 12, such as during mounting onto and dismounting from the mattress. The innerspring 12 may be disposed on top of a box spring 22 to provide base support.

With reference to the mattress 10 in FIG. 1, regard to an edge 23 of the innerspring 12, there are some general considerations regarding construction and manufacture. In normal use, the edge 23 is subjected to greater compression forces than an interior 24 of the innerspring 12 due to the common practice of sitting on the edge 23 of the mattress 10. The coils 14 located proximate to the edge 23 of the innerspring 12 are subjected to concentrated loads as opposed to coils 14 located in the interior 24. To provide further perimeter structure and edge-support for the innerspring 12, support members 25 may be disposed around the coils 14 disposed proximate to the edge 23 of the innerspring 12 between the box spring 22 and the upper and lower border wires 18, 20. The support members 25 may be extruded from polymer-foam as an example. One or more layers of padding material 26 can be disposed on top of the innerspring 12, and upholstery 27 is placed around the entire padding material 26, innerspring 12, and box spring 22 to provide a fully assembled mattress 10. This mattress structure in FIG. 1 may also be provided for other types of innersprings, including pocketed coils.

The dimensions of the innerspring support members 25 must be manufactured to be compatible with the size of the innerspring 12. For example, the length of the innerspring support members 25 must be properly sized to extend along the edge 23 of the innerspring 12 without extending beyond the corner 28 such that the innerspring support members 25 can be properly encased within the upholstery 27, as shown in FIG. 1. Further, the innerspring support members 25 should be sufficiently engaged with the innerspring 12 to provide stability and a uniform sleep surface for the mattress 10 between the edge 23 and the interior 24. However, spacing between adjacent coils 14 in the innerspring 12 can vary, thereby causing compatibility problems between innerspring support members 25 and different innersprings 12.

A mattress manufacturer maintains mattress assembly components in inventory. To provide edge-support for each of the variations and permutations of mattress core types, mattress perimeter widths and lengths, variations in interior coil types, widths, and lengths, and further due to variations in distance that may occur between the coils of a mattress core, a mattress manufacturer may currently have to maintain a large number of components and component stock-keeping units (SKUs), resulting in increased inventory costs. It may be desirable to provide for a reduced number of support member components and associated SKUs which are compatible with different mattress core types, different mattress perimeter widths and lengths, different variations in interior coil types, widths, and lengths, and different variations in distance that may occur between the coils of a mattress core, to reduce inventory associated costs.

Thus, it may be desirable to provide edge-support that is compatible with an innerspring having varying widths and lengths forming the innerspring perimeter. It may also be desirable to provide edge-support that is compatible with different types of innersprings that may have variations in perimeter widths and lengths between the different types of innersprings. It may also be desirable to provide edge-support for an innerspring that has perimeter coils having varying spacings between adjacent perimeter coils. It may also be desirable to provide edge-support that is compatible with different types of innersprings that may have variations in spacings between adjacent perimeter coils between the different types of innersprings.

Further, labor is expended assembling the support members 25 for the innerspring 12. For example, the support members 25 must be assembled to provide the interior 24 for the innerspring 12 to be located and disposed. Thus, it may also be desirable to provide for the support members 25 to be able to be easily and quickly provided and assembled for the innerspring 12 to provide efficient assembly and lower cost assembly labor.

### SUMMARY OF THE DETAILED DESCRIPTION

Embodiments disclosed in the detailed description include mattress assemblies and related methods employing one or more elastic bands to provide at least a portion of an encasement, including, but not limited to, for bedding and seating applications. In these embodiments, edge-support is provided which is compatible with various mattress cores, including innerspring coil mattress cores, having varying widths and lengths forming the mattress core perimeter. The provided edge-support is also compatible with different types of innersprings that may have variations in spacings between adjacent perimeter coils, including between different types of innersprings. In addition, these mattress assemblies provide efficient assembly and lower assembly labor cost. Furthermore, these mattress assemblies may be provided from a reduced number of components, resulting in fewer inventory stock-keeping units (SKUs) to maintain in inventory, reducing inventory associated costs.

In this regard, in one embodiment a mattress assembly is provided. The mattress assembly may include, as non-limiting examples, a mattress core and an elastic foam edge-support band compressively engaged along the outer perimeter of the mattress core to form the mattress assembly. In this embodiment, a top surface of the mattress core forms a sleep surface of the mattress assembly. This sleep surface is disposed within the outer perimeter of the mattress core. In this embodiment, the mattress core has an outer perimeter, including an outer perimeter width disposed in a width dimension of the sleep surface and an outer perimeter length disposed in a length dimension of the sleep surface. Prior to assembly of the mattress assembly, the elastic foam edge-support band has a preassembled inner perimeter. When disposed in rectangular form, the elastic foam edge-support band has a preassembled inner perimeter width and a preassembled inner perimeter length. The preassembled inner perimeter width of the elastic foam edge-support band is less in distance than the outer perimeter width of the mattress core. The preassembled inner perimeter length of the elastic foam edge-support band is less in distance than the outer perimeter length of the mattress core. As disposed in the mattress assembly, the elastic foam edge-support band can be disposed in a rectangular-shaped form around the outer perimeter of the mattress core. As also disposed in the mattress assembly, the elastic foam edge-support band can have an assembled inner perimeter width and an assembled inner perimeter length. The assembled inner perimeter width of the elastic foam edge-support band can be greater in distance than the preassembled inner perimeter width of the elastic foam edge-support band. Furthermore, the assembled inner perimeter length of the elastic foam edge-support band can be greater in distance than the preassembled inner perimeter length of the elastic foam edge-support band.

In another embodiment, a method of providing a mattress assembly is provided. This method comprises providing a mattress core. In this embodiment, the mattress core has an outer perimeter and a sleep surface disposed inside the outer perimeter. The outer perimeter of the mattress core has an outer perimeter width disposed in a width dimension of the sleep surface and an outer perimeter length disposed in a length dimension of the sleep surface. The method further comprises providing an elastic foam edge-support band. The provided elastic foam edge-support band has a preassembled inner perimeter. When disposed in rectangular form, the elastic foam edge-support band has a preassembled inner perimeter width and a preassembled inner perimeter length. The preassembled inner perimeter width of the elastic foam edge-support band is less in distance than the outer perimeter width of the mattress core. Furthermore, the preassembled inner perimeter length of the elastic foam edge-support band is less in distance than the outer perimeter length of the mattress core. The method further comprises disposing the elastic foam edge-support band along the outer perimeter of the mattress core to form the mattress assembly such that the elastic foam edge-support band compressively engages the outer perimeter of the mattress core along its width and length.

The elastic foam edge-support band can have an assembled inner perimeter width and an assembled inner perimeter length, when disposed in the mattress assembly. Furthermore, the assembled inner perimeter width of the elastic foam edge-support band can be greater in distance than the preassembled inner perimeter width of the elastic foam edge-support band. Furthermore, the assembled inner perimeter length of the elastic foam edge-support band can be greater in distance than the preassembled inner perimeter length of the elastic foam edge-support band.

In another embodiment, a further mattress assembly is provided. This mattress assembly may include, as non-limiting examples, a mattress core and an elastic foam edge-support band compressively engaged along the outer perimeter of the mattress core to form the mattress assembly. In this embodiment, a top surface of the mattress core forms a sleep surface of the mattress assembly. This sleep surface is disposed within the outer perimeter of the mattress core. In this embodiment, the mattress core has an outer perimeter, including an outer perimeter width disposed in a width dimension of the sleep surface and an outer perimeter length disposed in a length dimension of the sleep surface. Prior to assembly of the mattress assembly, the elastic foam edge-support band has a preassembled inner perimeter. When disposed in rectangular form, the elastic foam edge-support band has a preassembled inner perimeter width and a preassembled inner perimeter length. At least one of the preassembled inner perimeter width and the preassembled inner perimeter length of the preassembled inner perimeter is less in distance than a corresponding at least one outer perimeter width and outer perimeter length of the mattress core. As disposed in the mattress assembly, the elastic foam edge-support band is compressively engaged along the outer perimeter of the mattress core to form the mattress assembly. As also disposed in the mattress assembly, the elastic foam edge-support band has an assembled inner perimeter width and an assembled inner perimeter length. At least one of the assembled inner perimeter width and the assembled inner perimeter length is greater in distance than a corresponding at least one of the preassembled inner perimeter width and the preassembled inner perimeter length of the elastic foam edge-support band.

The aforementioned mattress assemblies provide edge-support that is compatible with various mattress cores, including innerspring coil mattress cores, having varying widths and lengths forming the mattress core perimeter. The assemblies also provide edge-support that is compatible with different types of innersprings that may have variations in perimeter widths and lengths between the different types of innersprings. These mattress assemblies also provide edge-support that is compatible with different types of innersprings that may have variations in spacings between adjacent perimeter coils between the different types of innersprings. These mattress assemblies may be provided in reduced mattress assembly times. Furthermore, these mattress assemblies may be provided at a reduced cost. For example, the assemblies disclosed herein may provide efficient assembly and lower cost assembly labor. In addition, these mattress assemblies may be provided from a reduced number of components, which may result in a fewer number of inventory SKUs (for example, a reduced number of mattress assembly edge-support components) to maintain in inventory, reducing inventory associated costs.

### BRIEF DESCRIPTION OF THE DRAWINGS

FIG. 1 is an exemplary prior art mattress employing innerspring coils;

FIG. 2 is a perspective view of an exemplary prior art mattress core, employing innerspring coils interconnected by (upper and lower) helical coils and (upper and lower) border wires;

FIG. 3A is a perspective view of an exemplary elastic foam edge-support band for providing edge support and corner support for a mattress assembly;

FIG. 3B is a perspective view illustrating the elastic foam edge-support band of FIG. 3A stretched around an exemplary innerspring coil mattress core;

FIG. 3C is a perspective view of a mattress assembly comprised of the elastic foam edge-support band of FIG. 3A for providing edge support and corner support for a mattress assembly disposed around an exemplary innerspring coil mattress core;

FIG. 4A is a perspective view of an exemplary mattress assembly comprised of the exemplary elastic foam edge-support band of FIG. 3A for providing edge support and corner support for a mattress assembly disposed around an exemplary pocketed coil mattress core;

FIG. 4B is a perspective view of a mattress assembly comprised of the exemplary elastic foam edge-support band of FIG. 3A disposed around an exemplary foam mattress core;

FIG. 5A is a perspective view of another exemplary elastic foam edge-support band for providing edge support and corner support for a mattress assembly, the exemplary elastic foam edge-support band comprising integrally formed expansion joints for expanding the perimeter of the exemplary elastic foam edge-support band;

FIG. 5B is a perspective view illustrating the exemplary elastic foam edge-support band of FIG. 5A stretched around an exemplary innerspring coil mattress core;

FIG. 5C is a perspective view of an exemplary mattress assembly comprised of the exemplary elastic foam edge-support band of FIG. 5A for providing edge support and corner support for a mattress assembly disposed around an exemplary innerspring coil mattress core;

FIG. 6A is a perspective view of another exemplary elastic foam edge-support band for providing edge support and corner support for a mattress assembly, the exemplary elastic foam edge-support band comprising integrally formed expansion joints for expanding the perimeter of the exemplary foam edge-support band;

FIG. 6B is a perspective view of an exemplary mattress assembly comprised of the exemplary elastic foam edge-support band of FIG. 6A for providing edge support and corner support for a mattress assembly disposed around an exemplary innerspring coil mattress core;

FIG. 7A is a perspective view of another exemplary elastic foam edge-support band for providing edge support and corner support for a mattress assembly, the exemplary elastic foam edge-support band comprising integrally formed expansion joints for expanding the perimeter of the exemplary foam edge-support band;

FIG. 7B is a perspective view of an exemplary mattress assembly comprised of the exemplary elastic foam edge-support band of FIG. 7A for providing edge support and corner support for a mattress assembly disposed around an exemplary innerspring coil mattress core;

FIG. 8A is a perspective view of another exemplary elastic foam edge-support band for providing edge support and corner support for a mattress assembly, the exemplary elastic foam edge-support band comprising integrally formed expansion joints for expanding the perimeter of the exemplary foam edge-support band;

FIG. 8B is a perspective view of an exemplary mattress assembly comprised of the exemplary elastic foam edge-support band of FIG. 8A for providing edge support and corner support for a mattress assembly disposed around an exemplary innerspring coil mattress core;

FIG. 9A is a perspective view of another exemplary elastic foam edge-support band for providing edge support and corner support for a mattress assembly, the exemplary elastic foam edge-support band comprising integrally formed expansion joints for expanding the perimeter of the exemplary foam edge-support band;

FIG. 9B is a perspective view of an exemplary mattress assembly comprised of the exemplary elastic foam edge-support band of FIG. 9A for providing edge support and corner support for a mattress assembly disposed around an exemplary innerspring coil mattress core;

FIG. 10A is a perspective view of another exemplary elastic foam edge-support band for providing edge support and corner support for a mattress assembly, the exemplary elastic foam edge-support band comprising integrally formed expansion joints for expanding the perimeter of the exemplary foam edge-support band;

FIG. 10B is a perspective view of an exemplary mattress assembly comprised of the exemplary elastic foam edge-support band of FIG. 10A for providing edge support and corner support for a mattress assembly disposed around an exemplary innerspring coil mattress core;

FIG. 11 is a perspective view of another exemplary elastic foam edge-support band for providing edge support and corner support for a mattress assembly, the exemplary elastic foam edge-support band comprised of an elongated member having a first and second end which are secured together to form the elastic foam edge-support band;

FIG. 12 is a perspective view of another exemplary elastic foam edge-support band for providing edge support and corner support for a mattress assembly, the exemplary elastic foam edge-support band comprised of a plurality of side-support members and a plurality of corner-support members secured together to form the elastic foam edge-support band;

FIG. 13A illustrates an exemplary rectangular-shaped cross section of an elastic foam edge-support band;

FIG. 13B illustrates an exemplary square-shaped cross section of an elastic foam edge-support band;

FIG. 13C illustrates an exemplary oval-shaped cross section of an elastic foam edge-support band;

FIG. 13D illustrates an exemplary circular-shaped cross section of an elastic foam edge-support band;

FIG. 14 is a perspective view of another exemplary mattress assembly comprised of a plurality of exemplary elastic foam edge-support bands for providing edge support and corner support for a mattress assembly disposed around an exemplary innerspring coil mattress core;

FIG. 15 is a perspective view of an exemplary mattress assembly comprised of an exemplary foam edge-support band disposed around an innerspring coil mattress core, the exemplary foam edge-support band having ventilation channels for ventilating atmosphere from the outer perimeter of the exemplary elastic foam edge-support band to the mattress core;

FIG. 16A is a partial perspective view of another exemplary mattress assembly illustrating attachment members fastening an exemplary foam edge-support band to innerspring coils of the mattress core;

FIG. 16B is a perspective view of an exemplary mattress assembly comprised of an exemplary elastic foam edge-support band disposed around an exemplary innerspring coil mattress core, the exemplary foam edge-support band having ventilation channels for ventilating atmosphere from the outer perimeter of the exemplary elastic foam edge-support band to the mattress core, and attachment members each threading through a ventilation channel of the elastic foam edge-support band and puncturing the elastic foam edge-support band to encircle at least a portion of the outer perimeter coils of the mattress core and the elastic foam edge-support band, thereby attaching the elastic foam edge-support band to the mattress core;

FIG. 17A is a partial perspective view of another exemplary elastic foam edge-support band having an exemplary integrally formed C-shaped spacer disposed in a corner of the exemplary elastic foam edge-support band for positioning the corner of the elastic foam edge-support band in relation to a corner coil of the mattress core;

FIG. 17B is a perspective view of an exemplary mattress assembly comprised of an exemplary elastic foam edge-support band disposed around an exemplary innerspring coil mattress core, the exemplary elastic foam edge-support band having the exemplary integrally formed C-shaped spacers of FIG. 17A disposed in each corner of the exemplary elastic foam edge-support band and positioning each corner of the exemplary elastic foam edge-support band in relation to a corner coil of the mattress core;

FIG. 18A is a partial perspective view of another exemplary elastic foam edge-support band having an integrally formed X-shaped spacer for positioning at least a portion of the elastic foam edge-support band in relation to at least one pair of adjacent outer coils of a mattress core;

FIG. 18B is a perspective view of an exemplary mattress assembly comprised of an exemplary elastic foam edge-support band disposed around an exemplary innerspring coil mattress core, the exemplary elastic foam edge-support band having the exemplary integrally formed X-shaped spacers of FIG. 18A disposed along the length of the band, each X-shaped spacer positioning at least a portion of the elastic foam edge-support band in relation to at least one pair of adjacent outer coils of the mattress core;

FIG. 19 is a perspective view of an exemplary mattress assembly comprising an exemplary elastic foam edge-support band disposed around an exemplary innerspring coil mattress core, the elastic foam edge-support band having C-shaped spacers (FIG. 17A) and X-shaped spacers (FIG. 18A), the elastic foam edge-support band and innerspring coil mattress core being further disposed upon a foam base;

FIG. 20A is a cross-sectional view of an exemplary elastic foam edge-support band having a C-shaped cross section;

FIG. 20B is a cross-sectional view of the elastic foam edge support-band of FIG. 20A, illustrating the elastic foam edge-support band stretched above the top and below the bottom of an innerspring mattress core;

FIG. 21A is a cross-sectional view of another exemplary elastic foam edge-support band having a C-shaped cross section;

FIG. 21B is a cross-sectional view of the elastic foam edge support-band of FIG. 21A, illustrating the elastic foam edge-support band stretched above the top and below the bottom of an innerspring mattress core;

FIG. 22A is a partial perspective view of an exemplary elastic foam edge-support band having a C-shaped cross section stretched above the top and below the bottom of an exemplary innerspring mattress core such that a top portion of the C-shaped foam edge-support band overlaps a top border wire of the innerspring mattress core along the top perimeter of the mattress core and a bottom portion of the C-shaped foam edge-support band overlaps a bottom border wire of the innerspring mattress core;

FIG. 22B is a partial perspective view of an exemplary elastic foam edge-support band having a C-shaped cross section stretched above the top and below the bottom of an exemplary innerspring mattress core;

FIG. 23A is a perspective view of an exemplary elastic foam edge-support band having a C-shaped cross section;

FIG. 23B is a perspective view illustrating the elastic foam edge-support band of FIG. 23A stretched around an exemplary innerspring coil mattress core;

FIG. 24A is a partial perspective view of an exemplary elastic foam edge-support band having a C-shaped cross section and an integrally formed arrowhead-shaped spacer for positioning at least a portion of the elastic foam edge-support band in relation to at least one pair of adjacent outer coils of a mattress core;

FIG. 24B is a partial perspective view of the exemplary elastic foam edge-support band of FIG. 24A stretched above the top and below the bottom of an exemplary innerspring mattress core, such that a top portion of the C-shaped foam edge-support band overlaps a top border wire of the innerspring mattress core along the top perimeter of the mattress core and a bottom portion of the C-shaped foam edge-support band overlaps a bottom border wire of the innerspring mattress core;

FIG. 24C is a partial perspective view of the exemplary elastic foam edge-support band of FIG. 24A stretched above the top and below the bottom of an exemplary innerspring mattress core, the integrally formed arrowhead-shaped spacer positioning at least a portion of the elastic foam edge-support band in relation to a pair of adjacent outer coils of a mattress core;

FIG. 25A is a perspective view of an exemplary elastic foam edge-support band having a C-shaped cross section and a plurality of integrally formed arrowhead-shaped spacers positioned between and abutting an interior top portion of the C-shaped cross section and an interior bottom portion of the C-shaped cross section;

FIG. 25B is a perspective view of the exemplary elastic foam edge-support band of FIG. 25A stretched above the top and below the bottom of an exemplary innerspring mattress core.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description include mattress assemblies and related methods employing one or more elastic bands to provide at least a portion of an encasement, including, but not limited to, for bedding and seating applications. In these embodiments, edge-support is provided which is compatible with various mattress cores, including innerspring coil mattress cores, having varying widths and lengths forming the mattress core perimeter. The provided edge-support is also compatible with different types of innersprings that may have variations in spacings between adjacent perimeter coils, including between different types of innersprings. In addition, these mattress assemblies provide efficient assembly and lower assembly labor cost. Furthermore, these mattress assemblies may be provided from a reduced number of components, resulting in fewer inventory stock-keeping units (SKUs) to maintain in inventory, reducing inventory associated costs.

In this regard, in one embodiment a mattress assembly is provided. The mattress assembly may include, as non-limiting examples, a mattress core and an elastic foam edge-support band compressively engaged along the outer perimeter of the mattress core to form the mattress assembly. In this embodiment, a top surface of the mattress core forms a sleep surface of the mattress assembly. This sleep surface is disposed within the outer perimeter of the mattress core. For example, the sleep surface may be circumscribed by the outer perimeter of the mattress core. In this embodiment, the mattress core has an outer perimeter, including an outer perimeter width disposed in a width dimension of the sleep surface and an outer perimeter length disposed in a length dimension of the sleep surface. Prior to assembly of the mattress assembly, the elastic foam edge-support band has a preassembled inner perimeter. When disposed in rectangular form, the elastic foam edge-support band has a preassembled inner perimeter width and a preassembled inner perimeter length. The preassembled inner perimeter width of the elastic foam edge-support band is less in distance than the outer perimeter width of the mattress core. The preassembled inner perimeter length of the elastic foam edge-support band is less in distance than the outer perimeter length of the mattress core.

As disposed in the mattress assembly, the elastic foam edge-support band can be disposed in a rectangular-shaped form around the outer perimeter of the mattress core. As also disposed in the mattress assembly, the elastic foam edge-support band can have an assembled inner perimeter width and an assembled inner perimeter length. The assembled inner perimeter width of the elastic foam edge-support band can be greater in distance than the preassembled inner perimeter width of the elastic foam edge-support band. Furthermore, the assembled inner perimeter length of the elastic foam edge-support band can be greater in distance than the preassembled inner perimeter length of the elastic foam edge-support band. Note that the mattress assembly and elastic foam edge-support band examples herein may be provided singly or in any combinations together as desired.

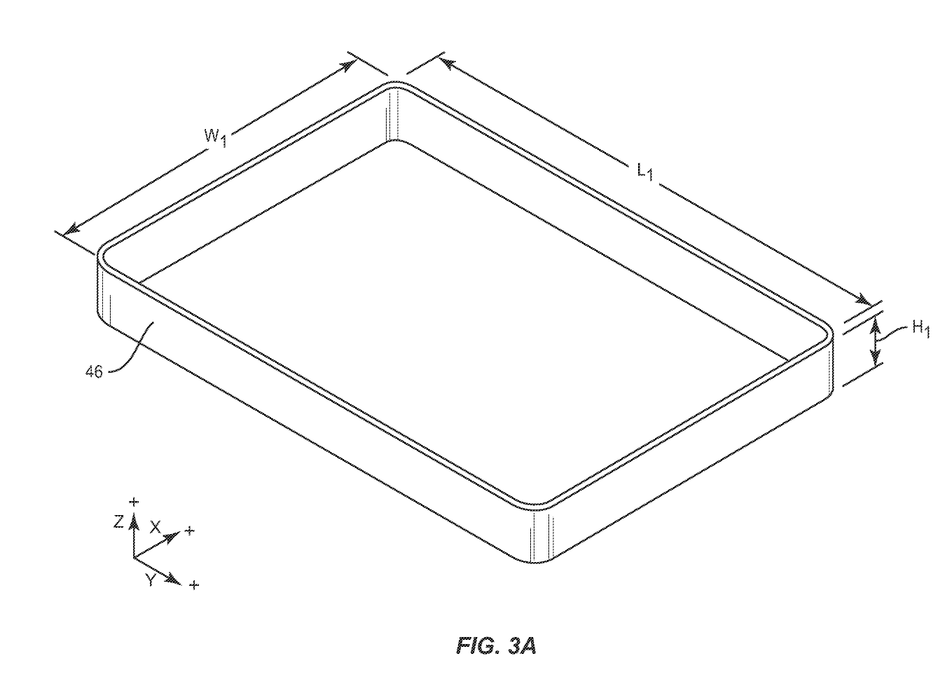

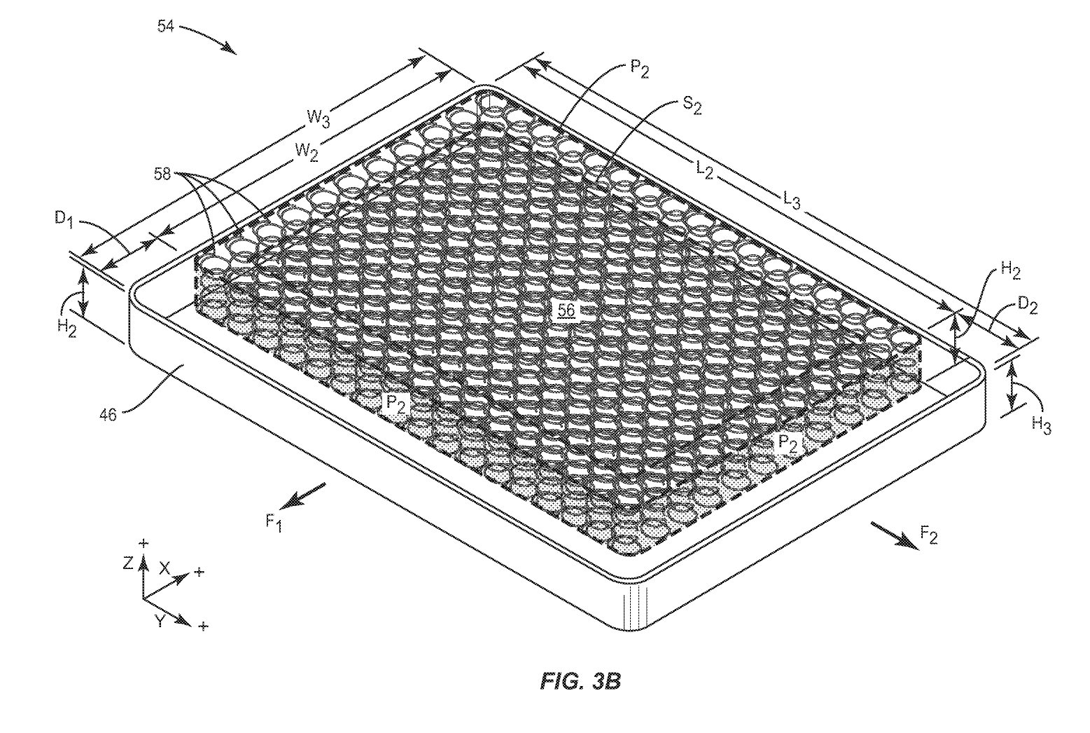

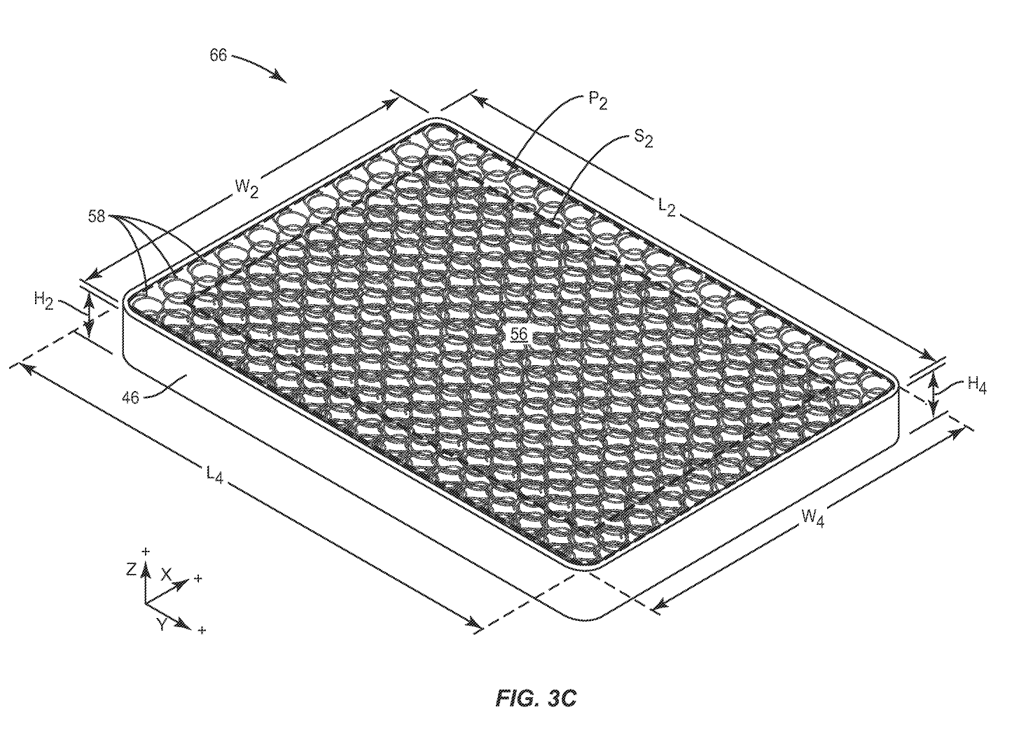

As illustrated in FIGS. 3A, 3B, 3C, a mattress assembly may be formed by disposing (e.g. stretching) an elastic foam edge-support band around the outer perimeter of a mattress core to provide a mattress assembly. This embodiment can address the problems discussed in the background. For example, the ability of the elastic foam edge-support band to be able to be stretched to different sizes may allow the band to be used to provide edge-support for various mattress core types and sizes, including for any of a plurality of mattress cores having different mattress perimeter widths and lengths. In addition, the ability of the elastic foam edge-support band to be able to be stretched may provide edge-support for any of a plurality of mattress cores each having variations in interior coil types, widths, and/or lengths. The ability of the elastic foam edge-support band to be able to be stretched may also provide edge-support despite variations in distance that may occur between the coils of a mattress core. Furthermore, the ability of the elastic foam edge-support band to be able to be stretched may reduce inventory costs for a mattress manufacturer since a single type band may accommodate a variety of mattress cores having differing perimeter widths and lengths, as well as mattress cores having differing variations in perimeter coil sizes and spacings.

In this regard, FIG. 3A shows an elastic foam edge-support band 46 prior to the assembling of a mattress assembly 66. When disposed in a rectangular shape, the elastic foam edge-support band 46 has a preassembled inner perimeter width W₁, a preassembled inner perimeter length L₁, and a preassembled height H₁. These dimensions are the unstretched dimensions of the elastic foam edge support band 46, before the elastic foam edge-support band 46 is stretched around a mattress core, as will later be described in FIGS. 3B and 3C. Herein, a “band” refers to material provided in the shape of a closed loop. A band has a certain thickness, a height, and a perimeter (or circumference). When disposed in a rectangular-shaped form, a band has an interior perimeter width and an interior perimeter length.

In order to form a mattress assembly, the elastic foam edge-support band 46 may be stretched around the outer perimeter of a mattress core such that the inner perimeter of the elastic foam edge-support band compressively engages the outer perimeter of the mattress core. Once disposed around the outer perimeter of the mattress core, at least one of the inner perimeter width and length of the elastic foam edge-support band 46 when assembled as part of the mattress assembly (the “assembled inner perimeter width” and “assembled inner perimeter length”) may be greater than the corresponding inner perimeter width and length of the elastic foam edge-support band before being stretched around the mattress core (“the preassembled inner perimeter width” and “the preassembled inner perimeter length”).

In this regard, FIG. 3B shows an interim assembly 54 in which the elastic foam edge-support band 46 in FIG. 3A is disposed along a portion of the width W₂ and length L₂ of a mattress core 56 comprised of innerspring coils 58. The mattress core 56 has a width W₂, length L₂, and height H₂. As illustrated in dashed lines in FIG. 3B, a top of the mattress core 56 forms a sleep surface S₂ disposed within the outer perimeter P₂ of the mattress core 56. Herein, a “sleep surface” of a mattress assembly refers to a top surface of a mattress assembly adapted to provide support to a person sleeping upon the mattress assembly. A “sleep surface” need not directly contact a person sleeping upon a mattress assembly, but may be adapted to provide support through additional layers of the mattress (e.g. through additional mattress layers, sheets, or ticking). Though the sleep surface S₂ illustrated in dashed lines in FIG. 3C is shown as a portion of the top surface of the mattress core 56, the sleep surface S₂ of the mattress core 56 may extend to the outer perimeter P₂ of the mattress core 56.

With continuing reference to FIG. 3B, the elastic foam edge-support band 46 is stretched a distance D₁, D₂ beyond the width W₂ and length L₂ dimensions of the mattress core 56. The elastic foam edge-support band 46 is stretched around the outer perimeter P₂ of the mattress core 56 in order to position the inner perimeter of the elastic foam edge-support band 46 about the mattress core 56 so that the inner perimeter of the elastic foam edge-support band 46 may abut the outer perimeter P₂ of the mattress core 56. For example, as illustrated in FIG. 3B, application of forces F₁, F₂ may be used to stretch the elastic foam edge-support band 46 about at least a portion of the perimeter P₂ of the mattress core 56. Furthermore, the stretching of the elastic foam edge-support band 46 around the outer perimeter P₂ of the mattress core 56 may tension portions of the elastic foam edge-support band 46 around portions of the mattress core 56. Thereafter, removal of the at least one forces F₁, F₂ stretching the elastic foam edge-support band 46 around the mattress core 56 allows remaining portions of the elastic foam edge-support band 46 to compressively engage remaining portions of the perimeter P₂ of the mattress core 56.

In this regard, as shown in FIG. 3B, the elastic foam edge-support band 46 has been stretched to a width W₃, length L₃, and height H₃. The distances D₁, D₂ beyond which the elastic foam edge-support band 46 is stretched beyond the width W₂ and length L₂ of the mattress core 56 need not be as far in distances D₁, D₂ as is illustrated in FIG. 3B. The elastic foam edge-support band 46 need only be stretched as far as is necessary to snugly fit the elastic foam edge-support band 46 around the outer perimeter P₂ of the mattress core 56. Herein, an “elastic” band refers to a band which has elastic properties (hereinafter an “elastic band”). For example, an “elastic band” tends to expand in distance (along the perimeter or circumference of the band) when a tension force is placed along at least a portion of the perimeter or circumference of the band. By way of further example, an “elastic band” also tends to contract in distance (along the perimeter or circumference of the band) when a tension force expanding at least a portion of the band is removed.

After stretching the elastic foam edge-support band 46 around the outer perimeter P₂ of the mattress core 56, the elastic foam edge-support band 46 can be positioned around outer perimeter P₂ of the mattress core 56. After the elastic foam edge-support band 46 is positioned as desired, the forces F₁, F₂ can be removed to release the tension in the elastic foam edge-support band 46 around the outer perimeter P₂ of the mattress core, thus providing a mattress assembly having side supports. The elastic foam edge-support band 46 is securely fitted to the outer perimeter P₂ of the mattress core 56. In this regard, FIG. 3C shows a mattress assembly 66 formed after the elastic foam edge-support band 46 has been disposed along the outer perimeter of the mattress core 56. The mattress assembly 66 comprises a mattress core 56 and an elastic foam edge-support band 46 disposed around the outer perimeter of the mattress core 56. A top surface S₂ of the mattress core 56 is a sleep surface S₂ of the mattress assembly 66. The mattress core 56 has an outer perimeter P₂ having a width W₂ disposed in a width dimension (dimension X, in this embodiment) of the sleep surface S₂, an outer perimeter length L₂ disposed in a length dimension (dimension Y, in this embodiment) of the sleep surface S₂, and a height H₂ disposed in a height dimension (dimension Z, in this embodiment).

As illustrated in FIG. 3C, the elastic foam edge-support band 46 is disposed (e.g. stretched) in a rectangular-shaped form around the outer perimeter P₂ of the mattress core 56. As disposed in the mattress assembly 66 in FIG. 3C, the preassembled inner perimeter width W₁ (FIG. 3A) of the elastic foam edge-support band 46 is less in distance than the outer perimeter P₂ width W₂ of the mattress core 56. As also disposed in the mattress assembly 66, the preassembled inner perimeter length L₁ (FIG. 3A) of the elastic foam edge-support band 46 is less in distance than the outer perimeter length L₂ of the mattress core 56 in FIG. 3C. As a result, the elastic foam edge-support band 46 disposed in the mattress assembly 66 is compressively engaged along the outer perimeter P₂ of the mattress core 56 to form the mattress assembly 66.

As also disposed in the mattress assembly 66, the elastic foam edge-support band 46 has an assembled inner perimeter width W₄, an assembled inner perimeter length L₄, and an assembled inner perimeter height H₄. As illustrated in FIG. 3C, the assembled inner perimeter width W₄ of the elastic foam edge-support band 46 is greater in distance than the preassembled inner perimeter width W₁ (FIG. 3A) of the elastic foam edge-support band 46. Furthermore, the assembled inner perimeter length L₄ of the elastic foam edge-support band 46 is greater in distance than the preassembled inner perimeter length L₁ (FIG. 3A) of the elastic foam edge-support band 46.

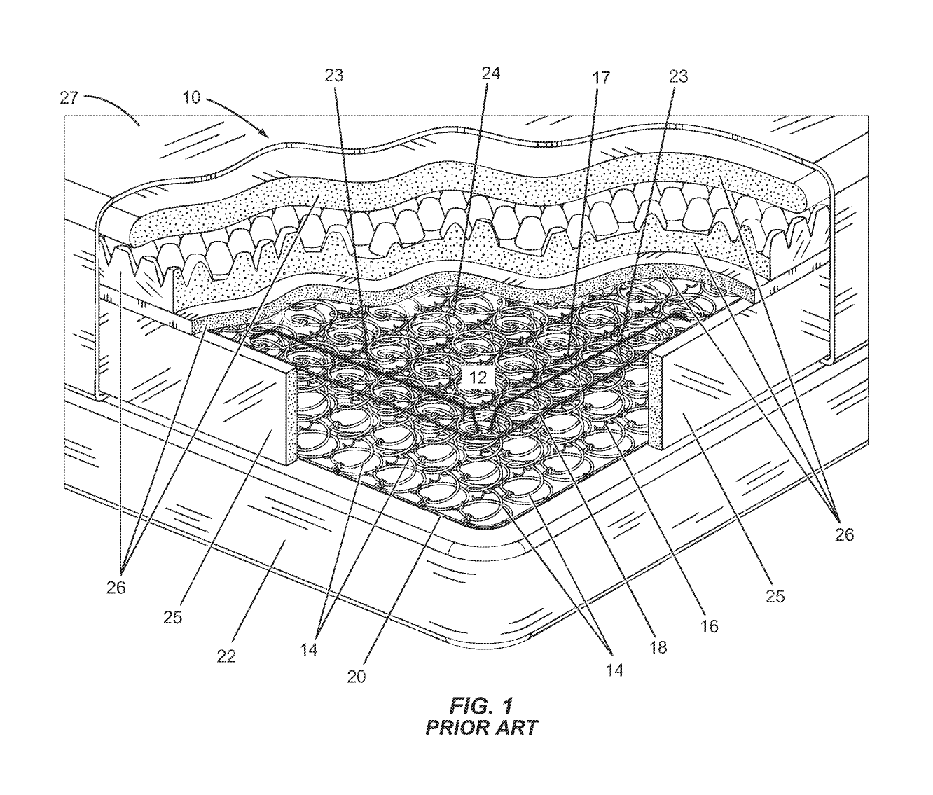

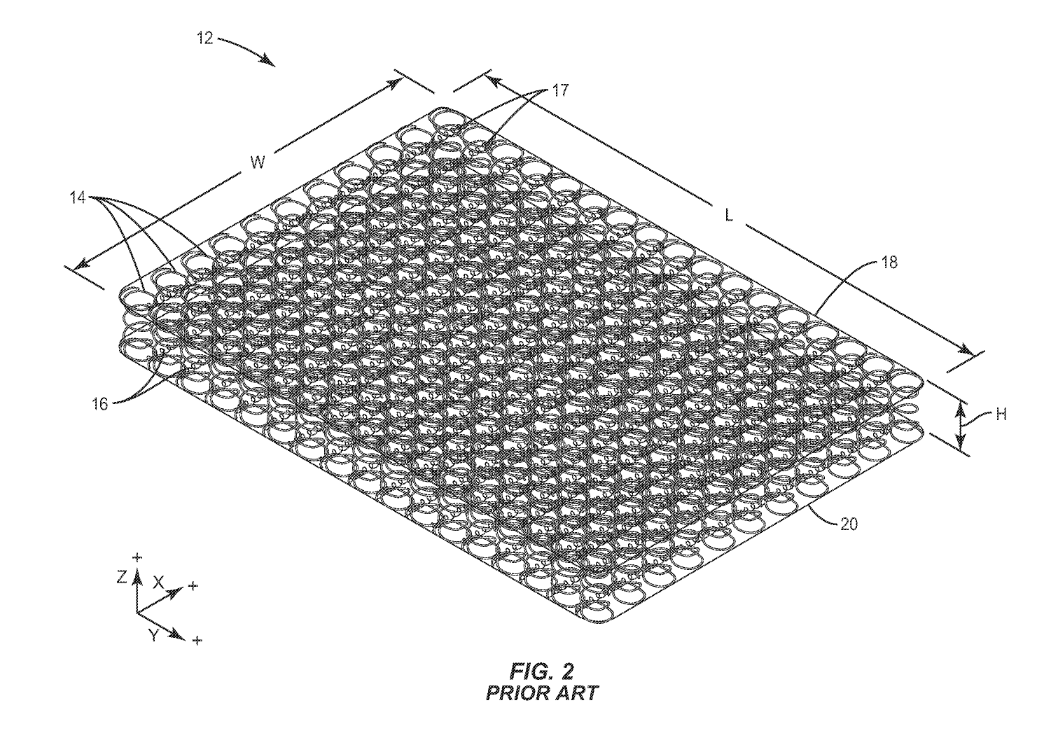

Because the elastic foam edge-support band 46 may have a preassembled inner perimeter width W₁ and length L₁ (FIG. 3A) which are lesser in distance than the outer perimeter width W₂ and length L₂ of the mattress core, the elastic foam edge-support band 46 may provide a compression force along the length and width of the perimeter of the mattress core 56. The compression force which the elastic foam edge-support band 46 provides to the mattress core 56 may hold members of the mattress core 56 (for example, innerspring coils 58) together. As a result, the members of the mattress core 56 (for example, innerspring coils 58) may not require interconnection by other means. For example, because of the compression force which the elastic foam edge-support band 46 provides to the mattress core 56, the mattress assembly 66 may be provided without interconnection helical wires (for example, see interconnection helical wires 16, 17 in FIGS. 1 and 2) interconnecting the innerspring coils 58. However, the elastic foam edge-support band 46 may also be provided around the perimeter of a mattress core having interconnection helical wires interconnecting the innerspring coils 58.

In addition, the elastic foam edge-support band 46 may provide a greater resistance to z-axis compression at the perimeter of the mattress assembly than the z-axis compressive resistance provided by the innerspring coils 58 of the mattress core 56. Because of a greater resistance to z-axis compression of the perimeter of the mattress assembly 66 provided by the elastic foam edge-support band 46, the mattress assembly 66 may provide firmness for edge support on the perimeter of the mattress assembly 66 where an individual may disproportionately place force on the mattress assembly 66, such as during mounting onto and dismounting from the mattress assembly 66. Herein, “edge-support” refers to an ability to provide a greater resistance to z-axis compression at the perimeter of a mattress assembly than the z-axis compressive resistance provided by the interior (e.g. innerspring coils) of the mattress core. Because of a greater resistance to z-axis compression of the perimeter of the mattress assembly 66, the mattress assembly 66 may be provided without border wires (for example, see upper or lower border wires 18, 20 in FIG. 2) around the perimeter of the mattress core 56. However, a mattress assembly 66 may also be provided by disposing an elastic foam edge-support band 46 around the perimeter of a mattress core 56 having border wires (for example, upper and/or lower border wires) provided around the perimeter of the mattress core 56.

The embodiment provided in FIGS. 3A-3C provides edge-support compatible with various mattress cores, including various innerspring coil mattress cores, having varying widths and lengths forming the mattress core perimeter. This embodiment also provides edge-support compatible with different types of innersprings that may have variations in spacings between adjacent perimeter coils, including between different types of innersprings. Furthermore, mattress assemblies may be more efficiently assembled utilizing this embodiment, reducing assembly labor costs. Furthermore, mattress assemblies utilizing this embodiment may be provided from a reduced number of components, reducing inventory associated costs. In addition, various mattress assemblies having different widths, lengths, and mattress cores may be assembled utilizing this embodiment. As a result, the various mattress assemblies may be provided from an inventory having fewer inventory stock-keeping units (SKUs), reducing inventory associated costs.

The elastic foam edge-support band 46 may be formed from any material desired, which may or may not be foamed. These material examples include, but are not limited to a polymer, a polymer foam, latex, a viscoelastic, and a viscoelastic foam, as examples. Further, the elastic foam edge-support band 46 may be formed from one or more materials selected from the group consisting of a polystyrene, a polyolefin, a polyethylene, a polybutane, a polybutylene, a polyurethane, a polyester, an ethylene acrylic copolymer, an ethylene-vinyl-acetate copolymer, an ethylene-methyl acrylate copolymer, an ethylene-butyl-acrylate copolymer, an ionomer, a polypropylene, a copolymer of polypropylene, latex rubber, a thermoset material, and the like, as non-limiting examples. Further, the elastic edge-support bands may be formed from a combination of thermoset and thermoplastic material(s), either one foamed or not, to provide cushioning of characteristics of both resiliency and structural support.

Further, elastic foam edge-support band 46 may be formed from fillers. These filler material examples include, but are not limited to a ground foam reclaim material, a nano clay, carbon nano tubes, calcium carbonate, flyash, corc dust, and the like, as examples. Further, the elastic edge-support bands may exhibit any degree of firmness desired.

Mattress assemblies employing elastic foam edge-support bands may be provided for a variety of mattress dimensions. For a particular mattress core's dimensions, elastic foam edge-support bands having an excessive perimeter may not adequately contain members of the mattress core. Furthermore, elastic foam edge-support bands having an insufficient perimeter may exceed the tensile strength of at least a portion of the elastic foam edge-support band when disposed around a mattress core, causing the elastic foam edge-support band to fail (e.g. tear).

Though each elastic foam edge-support band may accommodate a range of variations in mattress core dimensions, innerspring coil sizes, and intercoil spacings, elastic foam edge-support bands comprised of certain materials may not accommodate some major variations. For example, elastic foam edge-support bands may not accommodate major variations in mattress core dimensions, depending, for example, upon the materials from which the elastic foam edge-support band was formed.

In this regard, elastic foam edge-support band 46 may be provided in sizes suitable for a particular mattress core size. Embodiments having a range of dimensions for various mattress sizes are now discussed. In one embodiment, a mattress assembly may be provided with an elastic foam edge-support band (disposed around a mattress core) having an inner perimeter which is inclusively between 80.0 percent and 98.3 percent of the distance of the outer perimeter of the mattress core. In a further embodiment, a mattress assembly may be provided having an inner perimeter which is inclusively between 95.9 percent and 98.3 percent of the distance of the outer perimeter of the mattress core. In a further embodiment, a mattress assembly may be provided with the elastic foam edge-support band 46 having an inner perimeter, which is 96 percent of the distance of the outer perimeter of the mattress core.

The elastic foam edge-support band 46 may be used to form a twin size mattress assembly. Even though a twin size mattress is supposed to be of a standard size, variations can be present. Thus, the elastic foam edge-support band 46 may be particularly suited for accommodating these variations while providing side support. In this regard, for example, one embodiment of a mattress assembly for a twin mattress may be comprised of an elastic foam edge-support band disposed in a rectangular-shaped form having a preassembled inner perimeter width inclusively between 29.2 and 35.9 inches (74.1 and 91.2 cm) and a preassembled inner perimeter length inclusively between 58.4 and 71.8 inches (148.3 and 182.3 cm) disposed around a twin-sized mattress core. As a non-limiting example, the twin-sized mattress core may have an outer perimeter width of substantially 36.5 inches (92.7 cm) and an outer perimeter length of substantially 73.0 inches (185.4 cm). As another non-limiting example, the twin-sized mattress core may be comprised of 252 coils, arranged in a grid pattern 12 coils wide and 21 coils long. As a further non-limiting example, the twin-sized mattress core may have an outer perimeter width inclusively between 28.5 and 36.5 inches (72.3 cm and 92.7 cm), and an outer perimeter length inclusively between 65.0 and 73.0 inches (165.1 and 185.4 cm).

An embodiment of a mattress assembly for a twin XL mattress may be comprised of the elastic foam edge-support band 46 disposed in a rectangular-shaped form having a preassembled inner perimeter width inclusively between 29.2 and 35.9 inches (74.1 and 91.2 cm) and a preassembled inner perimeter length inclusively between 62.4 and 76.7 inches (158.4 and 194.8 cm) disposed around a twin XL-sized mattress core. As a non-limiting example, the twin XL-sized mattress core may have an outer perimeter width of substantially 36.5 inches (92.7 cm) and an outer perimeter length of substantially 78.0 inches (198.1 cm). As another non-limiting example, the twin XL-sized mattress core may be comprised of 276 coils, arranged in a grid pattern 12 coils wide and 23 coils long. As a further non-limiting example, the twin XL-sized mattress core may have an outer perimeter width inclusively between 28.5 and 36.5 inches (72.3 and 92.7 cm), and an outer perimeter length inclusively between 70.0 and 78.0 inches (177.8 and 198.1 cm).

An embodiment of a mattress assembly for a full mattress may be comprised of the elastic foam edge-support band 46 disposed in a rectangular-shaped form having a preassembled inner perimeter width inclusively between 41.2 and 50.7 inches (104.6 and 128.6 cm) and a preassembled inner perimeter length inclusively between 58.4 and 71.8 inches (148.3 and 182.3 cm) disposed around a full-sized mattress core. As a non-limiting example, the full-sized mattress core may have an outer perimeter width of substantially 51.5 inches (130.8 cm) and an outer perimeter length of substantially 73.0 inches (185.4 cm). As another non-limiting example, the full-sized mattress core may be comprised of 357 coils, arranged in a grid pattern 17 coils wide and 21 coils long. As a further non-limiting example, the full-sized mattress core may have an outer perimeter width inclusively between 43.5 and 51.5 inches (110.4 and 130.8 cm), and an outer perimeter length inclusively between 65.0 and 73.0 inches (165.1 and 185.4 cm).

An embodiment of a mattress assembly for a full XL mattress may be comprised of the elastic foam edge-support band 46 disposed in a rectangular-shaped form having a preassembled inner perimeter width inclusively between 41.2 and 50.7 inches (104.6 and 128.6 cm) and a preassembled inner perimeter length inclusively between 62.4 and 76.7 inches (158.4 and 194.8 cm) disposed around a full XL-sized mattress core. As a non-limiting example, the full XL-sized mattress core may have an outer perimeter width of substantially 51.5 inches (130.8 cm) and an outer perimeter length of substantially 78.0 inches (198.1 cm). As another non-limiting example, the full XL-sized mattress core may be comprised of 391 coils, arranged in a grid pattern 17 coils wide and 23 coils long. As a further non-limiting example, the full XL-sized mattress core may have an outer perimeter width inclusively between 43.5 and 51.5 inches (110.4 and 130.8 cm), and an outer perimeter length inclusively between 70.0 and 78.0 inches (177.8 and 198.1 cm).

An embodiment of a mattress assembly for a queen mattress may be comprised of the elastic foam edge-support band 46 disposed in a rectangular-shaped form having a preassembled inner perimeter width inclusively between 46.8 and 57.6 inches (118.8 and 146.1 cm) and a preassembled inner perimeter length inclusively between 62.4 and 76.7 inches (158.4 and 194.8 cm) disposed around a queen-sized mattress core. As a non-limiting example, the queen-sized mattress core may have an outer perimeter width of substantially 58.5 inches (148.6 cm) and an outer perimeter length of substantially 78.0 inches (198.1 cm). As another non-limiting example, the queen-sized mattress core may be comprised of 460 coils, arranged in a grid pattern 20 coils wide and 23 coils long. As a further non-limiting example, the queen-sized mattress core may have an outer perimeter width inclusively between 50.5 and 58.5 inches (128.2 and 148.6 cm), and an outer perimeter length inclusively between 70.0 and 78.0 inches (177.8 and 198.1 cm).

An embodiment of a mattress assembly for a king mattress may be comprised of the elastic foam edge-support band 46 disposed in a rectangular-shaped form having a preassembled inner perimeter width inclusively between 59.6 and 73.3 inches (151.3 and 186.1 cm) and a preassembled inner perimeter length inclusively between 62.4 and 76.7 inches (158.4 and 194.8 cm) disposed around a king-sized mattress core. As a non-limiting example, the king-sized mattress core may have an outer perimeter width of substantially 74.5 inches (189.2 cm) and an outer perimeter length of substantially 78.0 inches (198.1 cm). As another non-limiting example, the king-sized mattress core may be comprised of 575 coils, arranged in a grid pattern 25 coils wide and 23 coils long. As a further non-limiting example, the king-sized mattress core may have an outer perimeter width inclusively between 66.5 and 74.5 inches (168.9 and 189.2 cm), and an outer perimeter length inclusively between 70.0 and 78.0 inches (177.8 and 198.1 cm).

An embodiment of a mattress assembly for a “California king” mattress may be comprised of the elastic foam edge-support band 46 disposed in a rectangular-shaped form having a preassembled inner perimeter width inclusively between 56.4 and 69.4 inches (143.2 and 176.1 cm) and a preassembled inner perimeter length inclusively between 65.6 and 80.7 inches (166.6 and 204.8 cm) disposed around a California king-sized mattress core. As a non-limiting example, the California king-sized mattress core may have an outer perimeter width of substantially 70.5 inches (179.1 cm) and an outer perimeter length of substantially 82.0 inches (208.3 cm). As another non-limiting example, the California king-sized mattress core may be comprised of 576 coils, arranged in a grid pattern 24 coils wide and 24 coils long. As a further non-limiting example, the California king-sized mattress core may have an outer perimeter width inclusively between 62.5 and 70.5 inches (158.7 and 179.1 cm), and an outer perimeter length inclusively between 74.0 and 82.0 inches (188.0 and 208.3 cm).

In a further embodiment, the height of the elastic foam edge-support band 46 may be provided so as to match the height of a mattress core when the elastic foam edge support band is assembled (for example, stretched) onto the mattress assembly. As non-limiting examples, an elastic foam edge-support band 46 may be provided to form a mattress assembly having a height of substantially 5 inches (10.2 cm), 6 inches (12.7 cm), or 7 inches (15.2 cm) when the elastic foam edge support band is assembled (for example, stretched) onto the mattress assembly.

The elastic foam edge-support band 46 may be provided of varying or different thicknesses. Bands having insufficient thickness may exceed the tensile strength of at least a portion of the elastic foam edge-support band when disposed around a mattress core, causing the elastic foam edge-support band to fail (e.g. tear). Bands having excessive thickness waste material. Embodiments having various thicknesses are now discussed. In one embodiment, a mattress assembly 66 may be provided with the elastic foam edge-support band 46 having a thickness inclusively between one-eighth of an inch (3.18 mm) and two inches (51 mm). In another embodiment, the elastic foam edge-support band may have a thickness inclusively between one-half of an inch (12.7 mm) and five-eighths of an inch (15.9 mm). In another embodiment, the elastic foam edge-support band 46 may have a thickness of five-eighths of an inch (15.9 mm). In a further embodiment, the elastic foam edge-support band 46 may have a thickness of one-half of an inch (12.7 mm). The elastic foam edge-support band 46 may also be provided of varying or different heights. In one embodiment, the height of the elastic foam edge-support band 46 is inclusively between 3 inches (7.6 cm) and 18 inches (45.7 cm).

Mattress assemblies may also be provided by disposing an elastic foam edge-support band 46 around other types of mattress cores other than the unpocketed coils in the innerspring in FIGS. 3A through 3C which have an outer perimeter width and length greater than the preassembled inner perimeter width W₁ and length L₁ of the elastic foam edge-support band 46 (FIG. 3A). For example, the elastic foam edge-support band 46 may be disposed around a mattress core consisting of at least one from the group of innerspring coils, pocketed coils (e.g. marshall coils), and a cellular material (for example, a foam), and the like, as non-limiting examples.

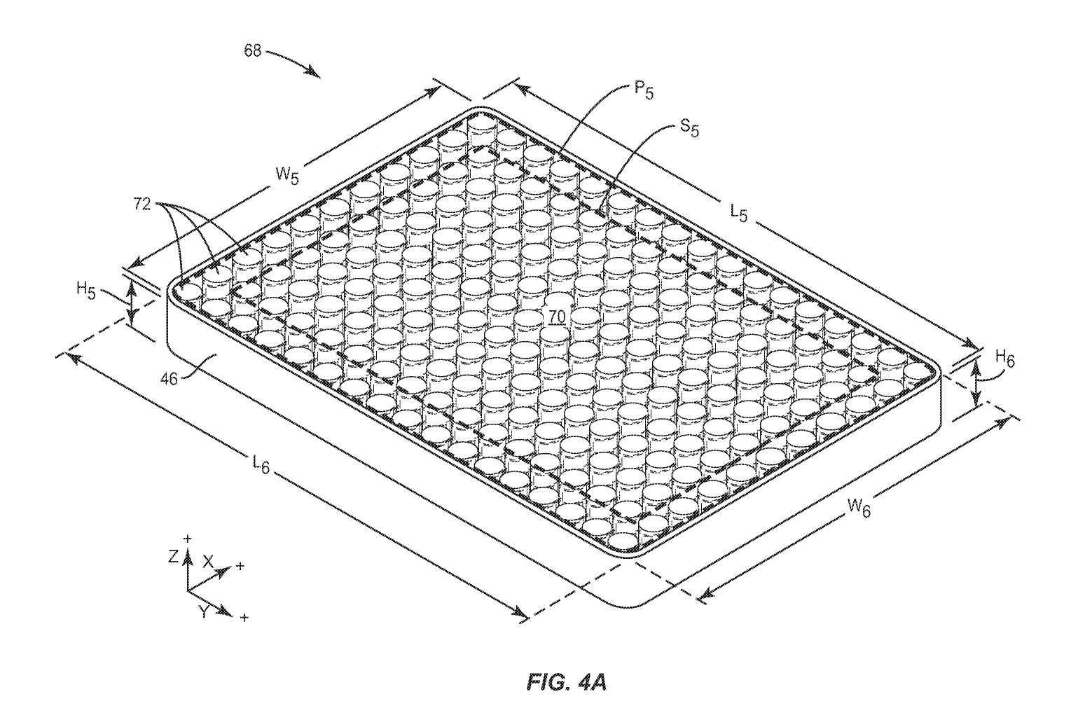

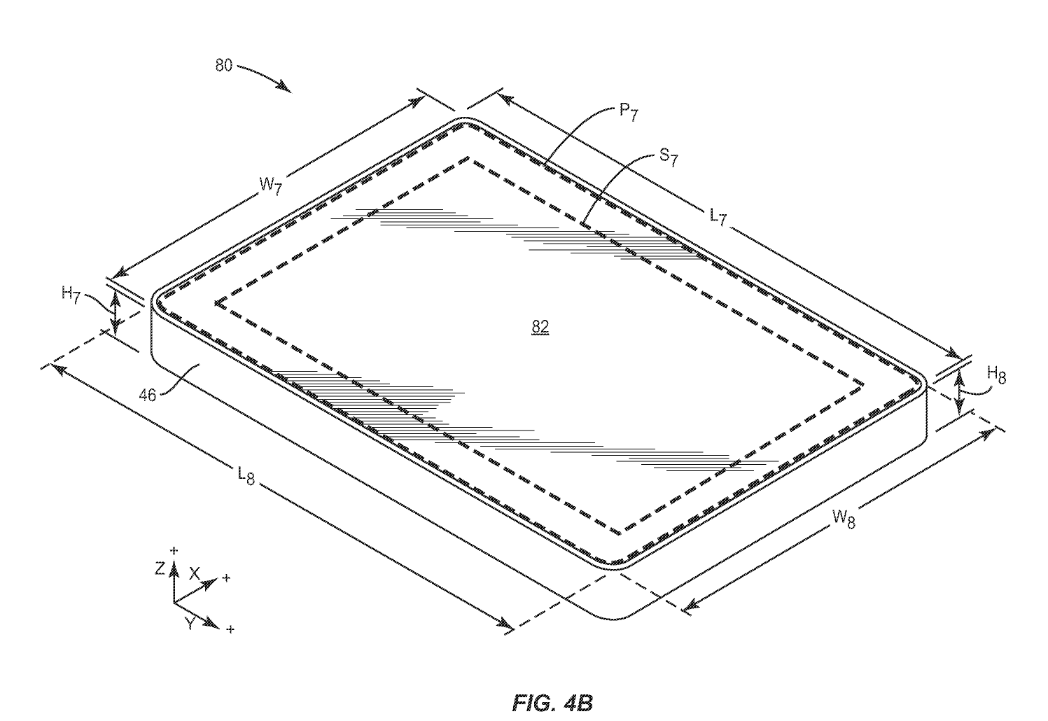

In this regard, FIG. 4A illustrates a mattress assembly 68 provided by disposing the elastic foam edge-support band 46 in FIGS. 3A-3C around a mattress core 70 comprising a plurality of pocketed coils 72. In this embodiment, mattress core 70 has an outer perimeter width W₅, length L₅, and height H₅ and the elastic foam edge-support band has an assembled perimeter width W₆, an assembled perimeter length L₆, and an assembled height H₆. A top surface of the mattress core 70 provides a sleep surface S₅ disposed within a perimeter P₅ of the mattress core 70. The preassembled inner perimeter width W₁ and length L₁ of the elastic foam edge-support band 46 are lesser in distance than the outer perimeter width W₅ and length L₅ of the pocketed coil mattress core 70. As a result, the elastic foam edge-support band 46 provides a compression force along the width W₅ and length L₅ of the perimeter of the mattress core 70. The compression force which the elastic foam edge-support band 46 provides to the mattress core 56 holds members of the mattress core 56 (for example, pocketed coils 72) together. The elastic foam edge-support band 46 may also provide a greater resistance to z-axis compression at the perimeter P₅ of the mattress assembly 68 than the z-axis compressive resistance provided by the pocketed coils 72 of the mattress core 70. As a result, the mattress assembly 68 may provide firmness for edge support on the perimeter P₅ of the mattress assembly 68 where an individual may disproportionately place force on the mattress assembly 68, such as during mounting onto and dismounting from the mattress assembly 68. Other features in FIGS. 3A-3C are also possible for FIG. 4A.

The elastic foam edge-support band 46 may also be provided around a mattress core formed from a cellular material. In this regard, FIG. 4B illustrates a mattress assembly 80 provided by disposing an elastic foam edge-support band 46 around a mattress core 82 comprised of foam (as opposed to innerspring or pocketed coils). The foam mattress core 82 has an outer perimeter width W₇, length L₇, and height H₇. In this embodiment, the elastic foam edge-support band 46 has an assembled width W₈, an assembled length L₈, and an assembled height H₈. A top surface of the mattress core 82 provides a sleep surface S₇ disposed within a perimeter P₇ of the mattress core 82. The preassembled inner perimeter width W₁ and length L₁ (FIG. 3A) of the elastic foam edge-support band 46 are lesser in distance than the outer perimeter width W₇ and length L₇ of the foam mattress core 82. As a result, the elastic foam edge-support band 46 provides a compression force along the width W₇ and length L₇ of the perimeter of the mattress core 82. The elastic foam edge-support band 46 may also provide a greater resistance to z-axis compression at the perimeter P₇ of the mattress assembly 80 than the z-axis compressive resistance provided by the foam mattress core 82. As a result, the mattress assembly 80 may provide firmness for edge support on the perimeter P₇ of the mattress assembly 80 where an individual may disproportionately place force on the mattress assembly 80, such as during mounting onto and dismounting from the mattress assembly 80. Other features in FIGS. 3A-3C are also possible for FIG. 4B.

Other embodiments of an elastic foam edge-support band and mattress assemblies incorporating the same are discussed below. For example, an elastic foam edge-support band may be disposed from one or more materials which do not expand in distance as desired. This may occur, for example, when the one or more materials from which the elastic foam edge-support band is formed have an elastic modulus which is greater than desired for allowing the elastic foam edge-support band to stretch around a given mattress core. As a result, the elastic foam edge-support band could compress the mattress core with more force than is desired. Alternatively, an elastic foam edge-support band may not expand in distance as desired, for example, when the one or more materials from which the elastic foam edge-support band is formed have a tensile strength which is lesser than desired for allowing the elastic foam edge-support band to stretch around a given mattress core. As a result, the elastic foam edge-support band could have a greater tendency to fail (e.g. tear) than is desired. To address such issues, an elastic foam edge-support band may be comprised of one or more integrally formed expansion joints.

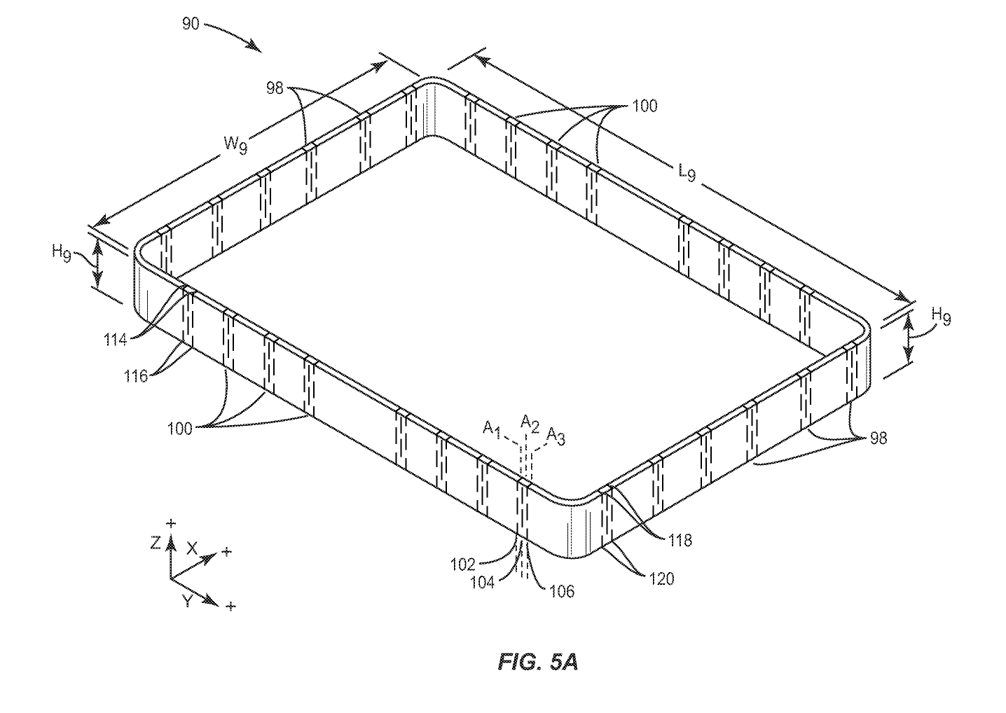

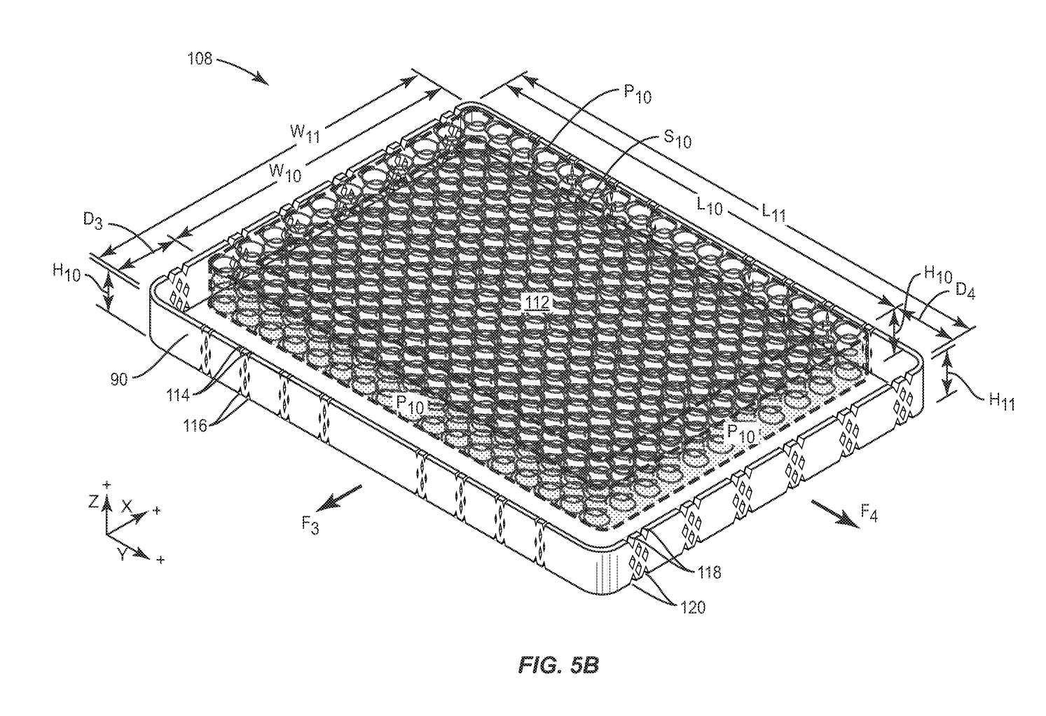

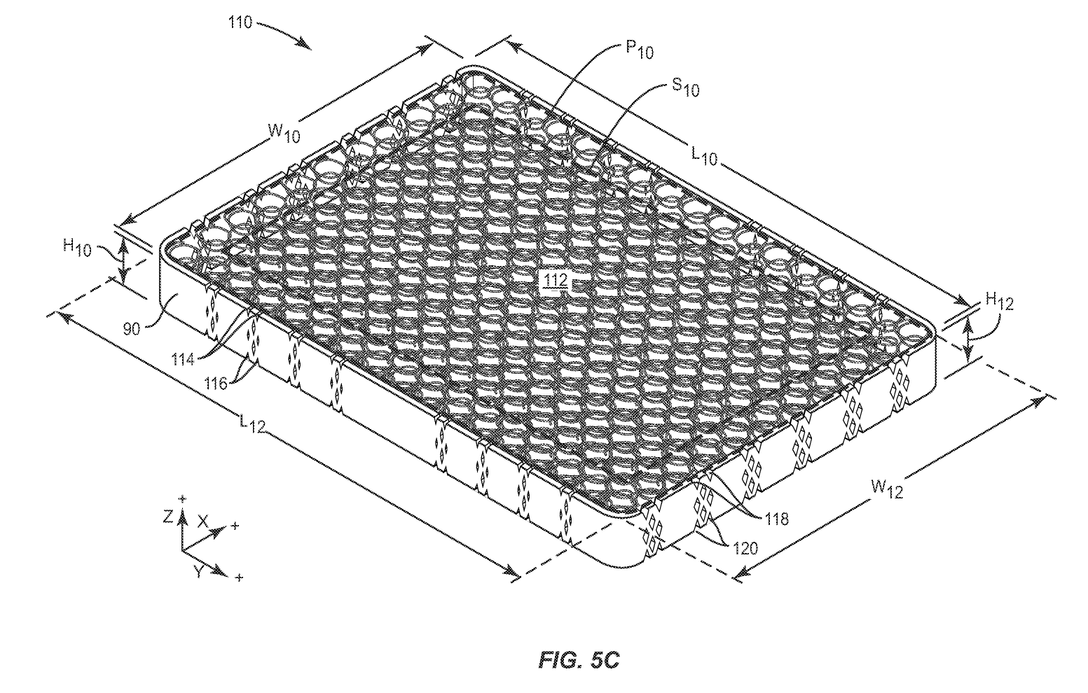

In this regard, FIG. 5A illustrates another exemplary elastic foam edge-support band 90 having an inner perimeter width W₉, an inner perimeter length L₉, and height H₉ with a plurality of integrally formed expansion joints 98, 100 disposed along the width W₉ and length L₉ of the elastic foam edge-support band 90. FIG. 5A shows the elastic foam edge-support band 90 prior to the assembling of a mattress assembly 110 (FIG. 5C). Each of the integrally formed expansion joints 98, 100 is configured to expand in at least one of a width (dimension X, in this embodiment) or length (dimension Y, in this embodiment) direction of the elastic foam edge-support band 90 to allow the perimeter of the elastic foam edge-support band 90 to be expanded. For example, each of the integrally formed expansion joints 98 is configured to expand the width W₉ of the elastic foam edge-support band 90 when a tension force is placed upon the elastic foam edge-support band 90. Each of the integrally formed expansion joints 100 is configured to expand the length L₉ of the elastic foam edge-support band 90 when a tension force is placed upon the elastic foam edge-support band 90. When provided in rectangular form, the perimeter, P₉, of the elastic foam edge-support band 90 may be twice the width W₉ of the elastic foam edge-support band 90 plus twice the length L₉ of the elastic foam edge-support band 90. (P₉=2W₉+2L₉). Accordingly, placing a tension force upon the elastic foam edge-support band 90 also increases the perimeter P₉ of the elastic foam edge-support band 90.

In this embodiment, integrally formed expansion joints 100 are comprised of a plurality of openings 114, 116, 118, 120 integrally formed in the elastic foam edge-support band 90. One purpose of the plurality of openings 114, 116, 118, 120 is to increase an amount of perimeter expansion that an area of the elastic foam edge-support band 90 will undergo when the elastic foam edge-support band 90 is tensioned. A further purpose of the plurality of openings 114, 116, 118, 120 may be to decrease the elastic modulus of the elastic foam edge-support band 90. In this regard, the plurality of openings 114, 116, 118, 120 of the integrally formed expansion joint 100 may each be configured to expand to a different size when a tension force is placed on the elastic foam edge-support band 90. First openings 114, 118 among the plurality of openings of the integrally formed expansion joint 100 may be disposed on a top edge of the elastic foam edge-support band 90. Second openings 116, 120 among the plurality of openings of the integrally formed expansion joint 100 may be disposed on a bottom edge of the elastic foam edge-support band 90. A plurality of openings 102, 104, 106 among the plurality of openings may form openings along a vertical axis A₁, A₂, A₃ of the elastic foam edge-support band 90. The plurality of openings 102, 104, 106 of the integrally formed expansion joint 100 may be formed in the elastic foam edge-support band 90 using an extrusion process or cutting process, such as die cutting, as non-limiting examples.

As illustrated by the series of FIGS. 5A, 5B, and 5C, a mattress assembly 110 (FIG. 5C) may be formed by disposing (e.g. stretching) the elastic foam edge-support band 90 around the outer perimeter of the mattress core 112 to provide the mattress assembly 110. This embodiment addresses problems discussed in the background. For example, this embodiment may provide edge-support for various mattress core types, including for any of a plurality of mattress cores having different mattress perimeter widths and lengths. In addition, this embodiment may provide edge-support for any of a plurality of mattress cores each having variations in interior coil types, widths, and/or lengths. This embodiment provides edge-support despite variations in distance that may occur between the coils of a mattress core. Furthermore, this embodiment may reduce inventory costs for a mattress manufacturer. For example, each embodiment may accommodate a variety of mattress cores having differing perimeter widths and lengths, as well as mattress cores having differing variations in perimeter coil sizes and spacings.

FIG. 5A shows an elastic foam edge-support band 90 prior to the assembling of a mattress assembly 110. When disposed in a rectangular shape, the elastic foam edge-support band 90 has a preassembled inner perimeter width W₉, a preassembled inner perimeter length L₉, and a preassembled height H₉. These dimensions are the unstretched dimensions of the elastic foam edge support band 90, before the elastic foam edge-support band 90 is stretched around a mattress core 112, as will later be described in FIGS. 5B and 5C.

In order to form a mattress assembly, an elastic foam edge-support band may be stretched around the outer perimeter of a mattress core such that the inner perimeter of the elastic foam edge-support band compressively engages the outer perimeter of the mattress core. Once disposed around the outer perimeter of the mattress core, at least one of the inner perimeter width and length of the elastic foam edge-support band when assembled as part of the mattress assembly (the “assembled inner perimeter width” and “assembled inner perimeter length”) may be greater than the corresponding inner perimeter width and length of the elastic foam edge-support band before being stretched around the mattress core (“the preassembled inner perimeter width” and “the preassembled inner perimeter length”).

In this regard, FIG. 5B shows an interim assembly 108 in which the elastic foam edge-support band 90 is disposed along a portion of the width W₁₀ and length L₁₀ of a mattress core 112 comprised of innerspring coils. The mattress core 112 has an outer perimeter width W₁₀, an outer perimeter length L₁₀, and a height H₁₀. As illustrated in dashed lines in FIG. 5B, a top surface of the mattress core 112 forms a sleep surface S₁₀ disposed within the outer perimeter P₁₀ of the mattress core 112. Though the sleep surface S₁₀ illustrated in dashed lines in FIG. 5C is shown as a portion of the top surface of the mattress core 112, the sleep surface S₁₀ of the mattress core 112 may extend to the outer perimeter P₁₀ of the mattress core 112.

With continuing reference to FIG. 5B, the elastic foam edge-support band 90 is stretched a distance D₃, D₄ beyond the width W₁₀ and length L₁₀ dimensions of the mattress core 112. The elastic foam edge-support band 90 is stretched around the outer perimeter P₁₀ of the mattress core 112 in order to position the inner perimeter of the elastic foam edge-support band 90 about the mattress core 112 so that the inner perimeter of the elastic foam edge-support band 90 may abut the outer perimeter P₁₀ of the mattress core 112. For example, as illustrated in FIG. 5B, forces F₃, F₄ may stretch the elastic foam edge-support band 90 about at least a portion of the perimeter P₁₀ of the mattress core 112. Furthermore, the stretching of the elastic foam edge-support band 90 around the outer perimeter P₁₀ of the mattress core 112 may tension portions of the elastic foam edge-support band 90 around portions of the mattress core 112. Thereafter, removal of the at least one forces F₃, F₄ stretching the elastic foam edge-support band 90 around the mattress core 112 allows remaining portions of the elastic foam edge-support band 90 to compressively engage remaining portions of the perimeter P₁₀ of the mattress core 112.

In this regard, as shown in FIG. 5B, the elastic foam edge-support band 90 has been stretched to a width W₁₁, length L₁₁, and height H₁₁. The distances D₃, D₄ beyond which the elastic foam edge-support band 90 is stretched beyond the width W₁₀ and length L₁₀ of the mattress core 112 need not be as far in distances D₃, D₄ as is illustrated in FIG. 5B. The elastic foam edge-support band 90 need only be stretched as far as is necessary to snugly fit the elastic foam edge-support band 90 around the outer perimeter P₁₀ of the mattress core 112.

After stretching the elastic foam edge-support band 90 around the outer perimeter P₁₀ of the mattress core 112, positioning the elastic foam edge-support band 90 around outer perimeter P₁₀ of the mattress core 112, and removing the at least one forces F₃, F₄ stretching the elastic foam edge-support band 90 around the outer perimeter P₁₀ of the mattress core, a mattress assembly is provided having side supports (e.g., the elastic foam edge-support band 90) securely fitted to the outer perimeter P₁₀ of the mattress core 112.

In this regard, FIG. 5C shows a mattress assembly 110 formed after the elastic foam edge-support band 90 has been disposed along the outer perimeter of the mattress core 112. The mattress assembly 110 comprises a mattress core 112 and an elastic foam edge-support band 90 disposed around the outer perimeter P₁₀ of the mattress core 112. A top surface S₁₀ of the mattress core 112 is a sleep surface S₁₀ of the mattress assembly 110. The mattress core 112 has an outer perimeter P₁₀ having a width W₁₀ disposed in a width dimension (dimension X, in this embodiment) of the sleep surface S₁₀, an outer perimeter length L₁₀ disposed in a length dimension (dimension Y, in this embodiment) of the sleep surface S₁₀, and a height H₁₀ disposed in a height dimension (dimension Z, in this embodiment).

As illustrated in FIG. 5C, the elastic foam edge-support band 90 is disposed (e.g. stretched) in a rectangular-shaped form around the outer perimeter P₁₀ of the mattress core 112. As disposed in the mattress assembly 110 in FIG. 5C, the preassembled inner perimeter width W₉ (FIG. 5A) of the elastic foam edge-support band 90 is less in distance than the outer perimeter P₁₀ width W₁₀ of the mattress core 112. As also disposed in the mattress assembly 110, the preassembled inner perimeter length L₉ (FIG. 5A) of the elastic foam edge-support band 90 is less in distance than the outer perimeter length L₁₀ of the mattress core 112 in FIG. 5C. As a result, the elastic foam edge-support band 90 disposed in the mattress assembly 110 is compressively engaged along the outer perimeter P₁₀ of the mattress core 112 to form the mattress assembly 110.

As also disposed in the mattress assembly 110, the elastic foam edge-support band 90 has an assembled inner perimeter width W₁₂, an assembled inner perimeter length L₁₂, and an assembled inner perimeter height H₁₂. As illustrated in FIG. 5C, the assembled inner perimeter width W₁₂ of the elastic foam edge-support band 90 is greater in distance than the preassembled inner perimeter width W₉ (FIG. 5A) of the elastic foam edge-support band 90. Furthermore, the assembled inner perimeter length L₁₂ of the elastic foam edge-support band 90 is greater in distance than the preassembled inner perimeter length L₉ (FIG. 5A) of the elastic foam edge-support band 90.

Because the elastic foam edge-support band 90 may have a preassembled inner perimeter width W₉ and length L₉ (FIG. 5A) which are lesser in distance than the outer perimeter width W₁₀ and outer perimeter length L₁₀ of the mattress core, the elastic foam edge-support band 90 may provide a compression force along the width W₁₀ and length L₁₀ of the perimeter P₁₀ of the mattress core 112. The compression force which the elastic foam edge-support band 90 provides to the mattress core 112 may hold members of the mattress core 112 (for example, innerspring coils of the mattress core 112) together. As a result, the members of the mattress core 112 (for example, innerspring coils of the mattress core 112) may not require interconnection by other means. For example, because of the compression force which the elastic foam edge-support band 90 provides to the mattress core 112, the mattress assembly 110 may be provided without interconnection helical wires (for example, see interconnection helical wires 16, 17 in FIGS. 1 and 2) interconnecting the innerspring coils of the mattress core 112. However, the elastic foam edge-support band 90 may also be provided around the perimeter of a mattress core having interconnection helical wires interconnecting the innerspring coils of the mattress core 112.

In addition, the elastic foam edge-support band 90 may provide a greater resistance to z-axis compression at the perimeter of the mattress assembly than the z-axis compressive resistance provided by the innerspring coils of the mattress core 112. Because of a greater resistance to z-axis compression of the perimeter of the mattress assembly 110 provided by the elastic foam edge-support band 90, the mattress assembly 110 may provide firmness for edge support on the perimeter P₁₀ of the mattress assembly 110 where an individual may disproportionately place force on the mattress assembly 110, such as during mounting onto and dismounting from the mattress assembly 110. Because of a greater resistance to z-axis compression of the perimeter of the mattress assembly 110, the mattress assembly 110 may be provided without border wires (for example, see upper or lower border wires 18, 20 in FIG. 2) around the perimeter P₁₀ of the mattress core 112. However, a mattress assembly 110 may also be provided by disposing an elastic foam edge-support band 90 around the perimeter of a mattress core 112 having border wires (for example, upper and/or lower border wires) provided around the perimeter of the mattress core 112.

The embodiment provided in FIGS. 5A-5C provides edge-support compatible with various mattress cores, including various innerspring coil mattress cores, having varying widths and lengths forming the mattress core perimeter. This embodiment also provides edge-support compatible with different types of innersprings that may have variations in spacings between adjacent perimeter coils, including between different types of innersprings. Furthermore, mattress assemblies may be more efficiently assembled utilizing this embodiment, reducing assembly labor costs. Furthermore, mattress assemblies utilizing this embodiment may be provided from a reduced number of components, reducing inventory associated costs. In addition, various mattress assemblies having different widths, lengths, and mattress cores may be assembled utilizing this embodiment. As a result, the various mattress assemblies may be provided from an inventory having fewer inventory stock-keeping units (SKUs), reducing inventory associated costs.

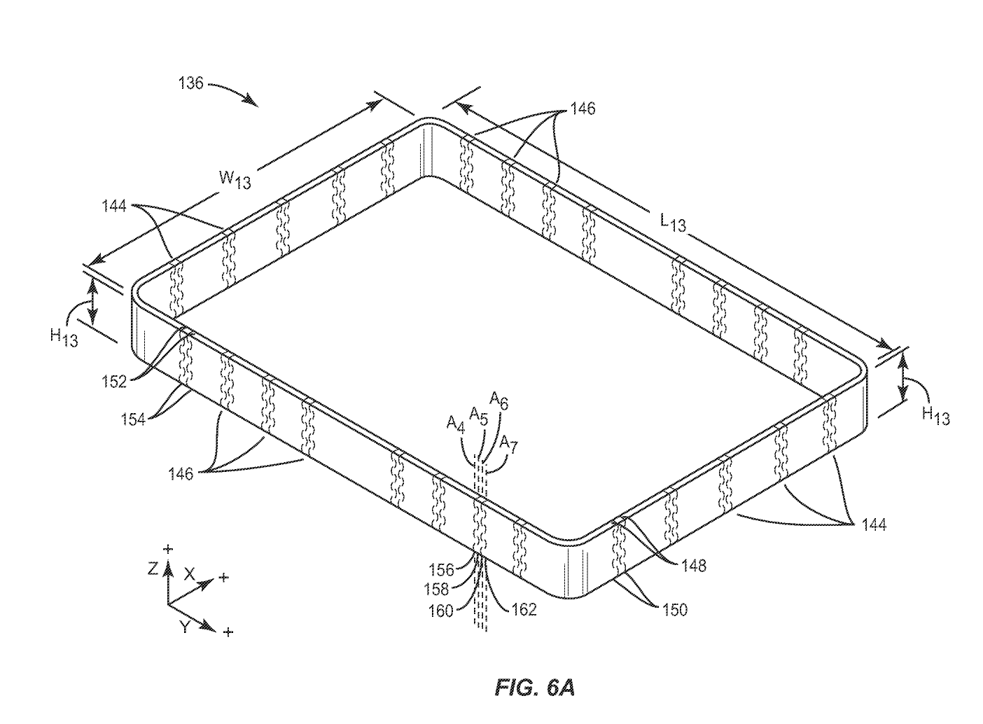

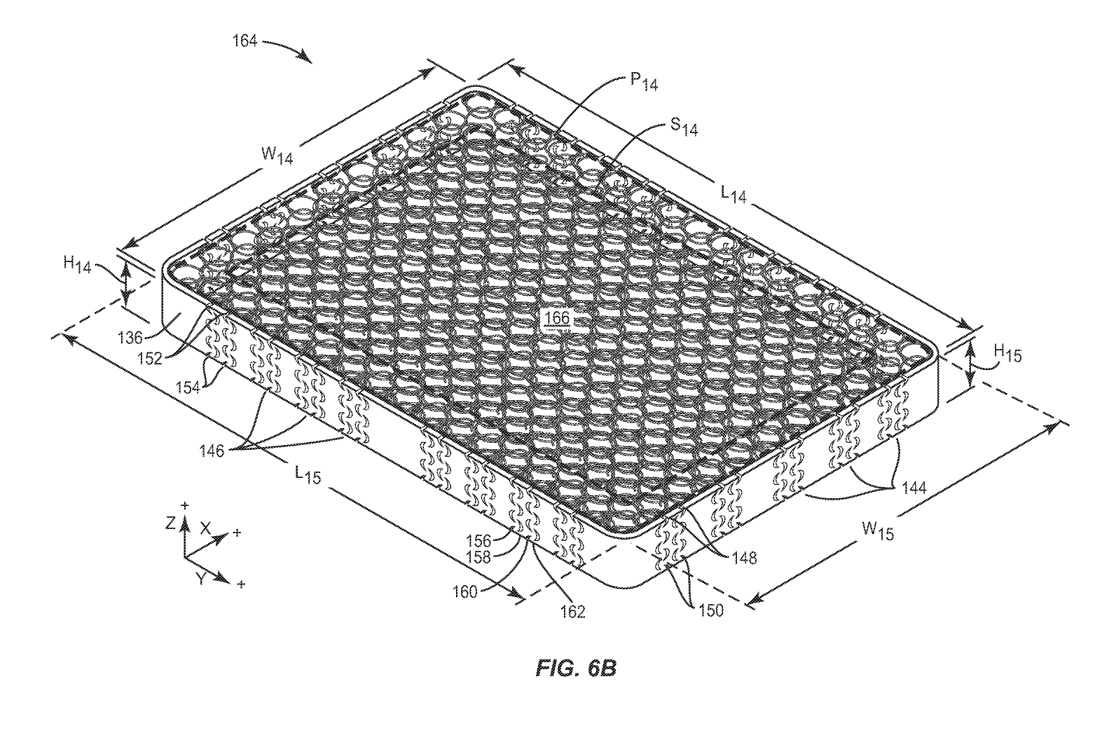

One or more expansion joints in an elastic foam edge-support band may also be provided using other shapes, orientations, and/or patterns of openings in the elastic foam edge-support band. In this regard, FIG. 6A is a perspective view of another embodiment of an exemplary elastic foam edge-support band 136 for providing edge support and corner support for a mattress assembly. In this embodiment, elastic foam edge-support band 136 has a preassembled inner perimeter width W₁₃, a preassembled inner perimeter length L₁₃, and a preassembled height H₁₃. Elastic foam edge-support band 136 is comprised of integrally formed expansion joints 144, 146 disposed along the width W₁₃ and length L₁₃ of the elastic foam edge-support band 136. Each of the integrally formed expansion joints 144 are configured to expand the width W₁₃ of the elastic foam edge-support band 136 when a tension force is placed upon the elastic foam edge-support band 136. Each of the integrally formed expansion joints 146 are configured to expand the length L₁₃ of the elastic foam edge-support band 136 when a tension force is placed upon the elastic foam edge-support band 136. In this embodiment, integrally formed expansion joints 144, 146 are comprised of a plurality of openings 148, 150, 152, 154 integrally formed in the elastic foam edge-support band 136. The plurality of openings of the integrally formed expansion joint 144, 146 are each configured to be expanded to different sizes when a tension force is placed on the elastic foam edge-support band 136. First openings 148, 152 among the plurality of openings of the integrally formed expansion joint 146, 144 are disposed on a top edge of the elastic foam edge-support band. Second openings 150, 154 among the plurality of openings of the integrally formed expansion joint 144, 146 are disposed on a bottom edge of the elastic foam edge-support band. A plurality of openings 156, 158, 160, 162 among the plurality of openings of the integrally formed expansion joint 144, 146 form openings along a vertical axis A₄, A₅, A₆, A₇ of the elastic foam edge-support band 136. The plurality of openings of the integrally formed expansion joints 144, 146 may be formed in the elastic foam edge-support band 136 using an extrusion process or cutting process, such as die cutting, as non-limiting examples. In this embodiment, the plurality of openings along each axis A₄, A₅, A₆, A₇ are comprised of a series of opposing C-shaped openings.

FIG. 6B illustrates a mattress assembly 164 comprised of an elastic foam edge-support band 136 disposed around the outer perimeter of a mattress core 166. The mattress core 166 has an outer perimeter width W₁₄ disposed in a width dimension (dimension X, in this embodiment) of the sleep surface S₁₄ of the mattress core 166 and an outer perimeter length L₁₄ disposed in a length dimension (dimension Y, in this embodiment) of the sleep surface S₁₄. The mattress core 166 also has a height H₁₄. Elastic foam edge-support band 136 is disposed in a rectangular-shaped form around the outer perimeter P₁₄ of the mattress core 166. As disposed in the mattress assembly 164, the preassembled inner perimeter width W₁₃ (FIG. 6A) of the elastic foam edge-support band 136 is less in distance than the outer perimeter width W₁₄ of the mattress core 166. As also disposed in the mattress assembly 164, the preassembled inner perimeter length L₁₃ (FIG. 6A) of the elastic foam edge-support band 136 is less in distance than the outer perimeter length L₁₄ of the mattress core 166. The elastic foam edge-support band 136 disposed in the mattress assembly 164 is compressively engaged along the outer perimeter P₁₄ of the mattress core 166 to form the mattress assembly 164. As disposed in the mattress assembly 164, the elastic foam edge-support band 136 has an assembled inner perimeter width W₁₅, an assembled inner perimeter length L₁₅, and an assembled height H₁₅. The assembled inner perimeter width W₁₅ of the elastic foam edge-support band 136 is greater in distance than the preassembled inner perimeter width W₁₃ (FIG. 6A) of the elastic foam edge-support band 136. Furthermore, the assembled inner perimeter length L₁₅ of the elastic foam edge-support band 136 is greater in distance than the preassembled inner perimeter length L₁₃ (FIG. 6A) of the elastic foam edge-support band 136.

As depicted in FIGS. 5A-5C and 6A-6B, the plurality of openings of the integrally formed expansion joints 98, 100, 144, 146 may be formed in various shapes, sizes, and patterns. For example, various shapes, sizes, and/or patterns of openings may be formed by disposing cuts of various shapes, sizes, and/or patterns in the elastic foam edge-support band 90, 136. The amount of tension provided by the elastic foam edge-support band 90, 136, when stretched, may be controlled by the disposing of different shapes, sizes, and/or patterns of the cuts and/or openings in the elastic foam edge-support band 90, 136.

One or more expansion joints in an elastic foam edge-support band may also be provided using expansion joints other than expansion joints comprising a plurality of openings. For example, an expansion joint of the elastic foam edge-support band may be provided by a non-planar portion of the elastic foam edge-support band.

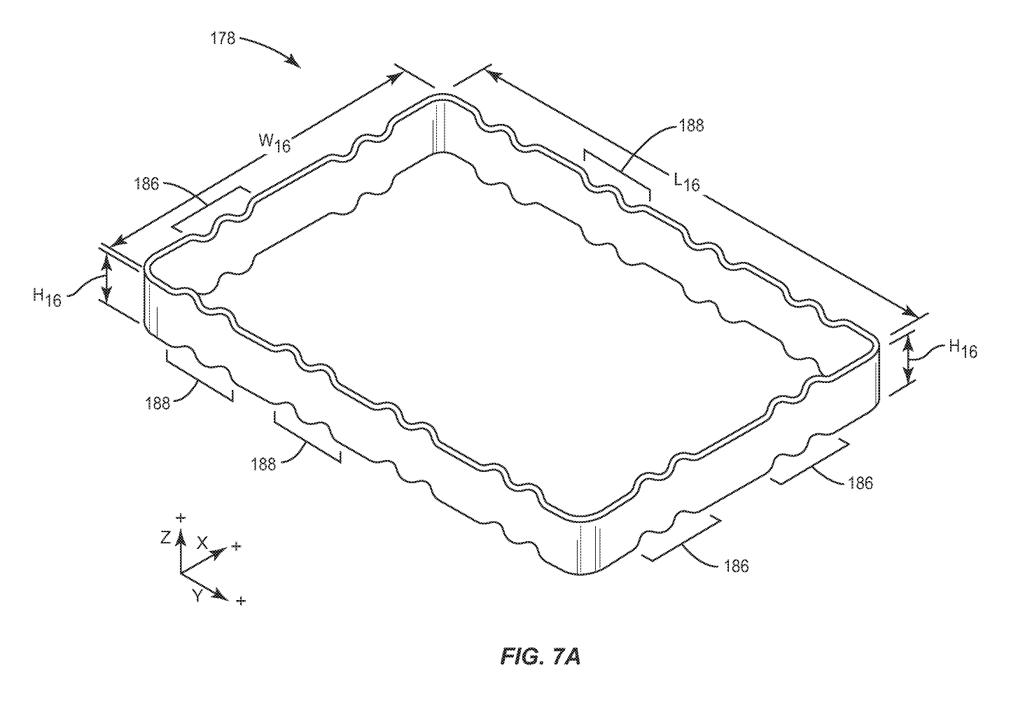

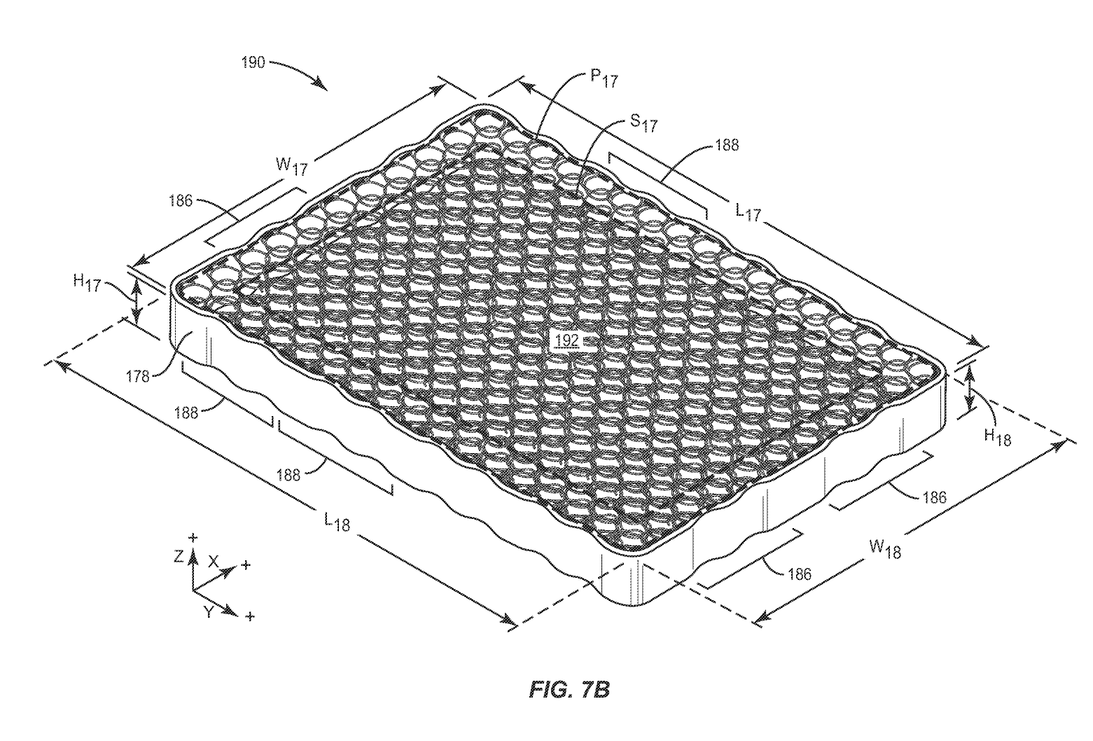

In this regard, FIG. 7A is a perspective view of another exemplary elastic foam edge-support band 178 for providing edge support and corner support for a mattress assembly. Elastic foam edge-support band 178 has an assembled inner perimeter width W16, an assembled inner perimeter length L16, and an assembled height H₁₆. Elastic foam edge-support band 178 is comprised of integrally formed expansion joints 186, 188 disposed along the width W₁₆ and length L₁₆ of the elastic foam edge-support band 178. Each of the integrally formed expansion joints 186 are configured to expand the width W₁₆ of the elastic foam edge-support band 178 when a tension force is placed upon the elastic foam edge-support band 178. Each of the integrally formed expansion joints 188 are configured to expand the length L₁₆ of the elastic foam edge-support band 178 when a tension force is placed upon the elastic foam edge-support band 178. In this embodiment, integrally formed expansion joints 186, 188 are comprised of a non-planar portion of the elastic foam edge-support band 178. By a non-planar portion, it is meant that a disruption of some type or form is disposed in the planarity of sides of the elastic foam edge-support band 178 along the width W₁₆ and/or length W₁₈ of the elastic foam edge-support band 178 such that the non-planar portion is non-planar along the width W₁₆ and/or length L₁₆ of the elastic foam edge-support band 178. As illustrated in FIG. 7A, integrally formed expansion joints 186, 188 extend between a top edge and a bottom edge of the elastic foam edge-support band 178. Furthermore, integrally formed expansion joints 186, 188 form S-shaped portions in the elastic foam edge-support band 178. As such, the S-shaped portions in the elastic foam edge-support band 178 provide at least one inflection plane in the elastic foam edge-support band 178. These S-shaped portions may include rounded, straight, or other shapes, as desired. When a tension force is placed on the S-shaped integrally formed expansion joints 186, the width W₁₆ of the elastic foam edge-support band 178 is increased. When a tension force is placed on the S-shaped integrally formed expansion joints 188, the length L₁₆ of the elastic foam edge-support band 178 is increased. The non-planar integrally formed expansion joints 186, 188 may be formed in the elastic foam edge-support band 178 as part of a mold, die, or other tooling to form the elastic foam edge-support band 178. Also, the non-planar integrally formed expansion joints 186, 188 may be formed by a roller, cutter, or other forming device. Any method to form the non-planar portions 186, 188 into the elastic foam edge-support band 178 can be employed and is encompassed herein.

FIG. 7B illustrates a mattress assembly 190 comprised of an elastic foam edge-support band 178 disposed around the outer perimeter P₁₇ of a mattress core 192. The mattress core 192 has an outer perimeter width W₁₇ disposed in a width dimension (dimension X, in this embodiment) of the sleep surface S₁₇ of the mattress core 192 and an outer perimeter length L₁₇ disposed in a length dimension (dimension Y, in this embodiment) of the sleep surface of the mattress core 192. The mattress core also has a height H₁₇. Elastic foam edge-support band 178 is disposed in a rectangular-shaped form around the outer perimeter of the mattress core 192. As disposed in the mattress assembly 190, the preassembled inner perimeter width W₁₆ (FIG. 7A) of the elastic foam edge-support band 178 is less in distance than the outer perimeter width W₁₇ of the mattress core 192. As also disposed in the mattress assembly 190, the preassembled inner perimeter length L₁₆ (FIG. 7A) of the elastic foam edge-support band 178 is less in distance than the outer perimeter length L₁₇ of the mattress core 192. The elastic foam edge-support band 178 disposed in the mattress assembly 190 is compressively engaged along the outer perimeter P₁₇ of the mattress core 192 to form the mattress assembly 190. As disposed in the mattress assembly 190, the elastic foam edge-support band 178 has an assembled inner perimeter width W₁₈, an assembled inner perimeter length L₁₈, and an assembled height H₁₈. The assembled inner perimeter width W₁₈ of the elastic foam edge-support band 178 is greater in distance than the preassembled inner perimeter width 180 (FIG. 7A) of the elastic foam edge-support band 178. Furthermore, the assembled inner perimeter length L₁₈ of the elastic foam edge-support band 178 is greater in distance than the preassembled inner perimeter length 182 (FIG. 7A) of the elastic foam edge-support band 178.

Other types of non-planar expansion joints may also be disposed in the elastic foam edge-support band. For example, an expansion joint of the elastic foam edge-support band may be provided by an expandable enclosure disposed in the elastic foam edge-support band.

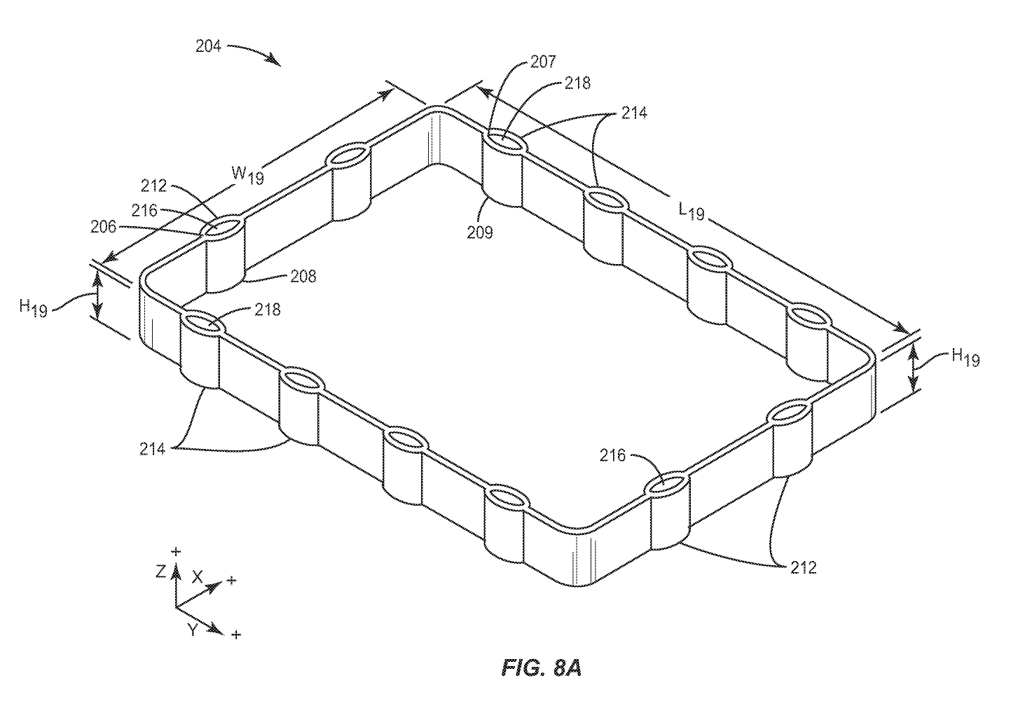

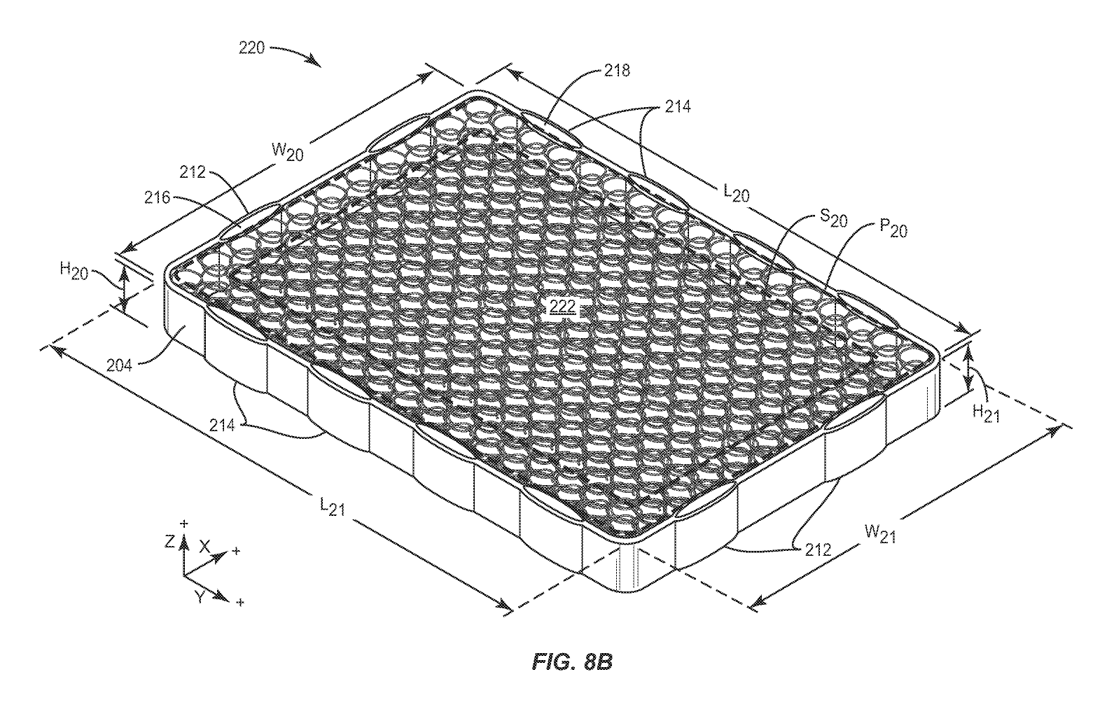

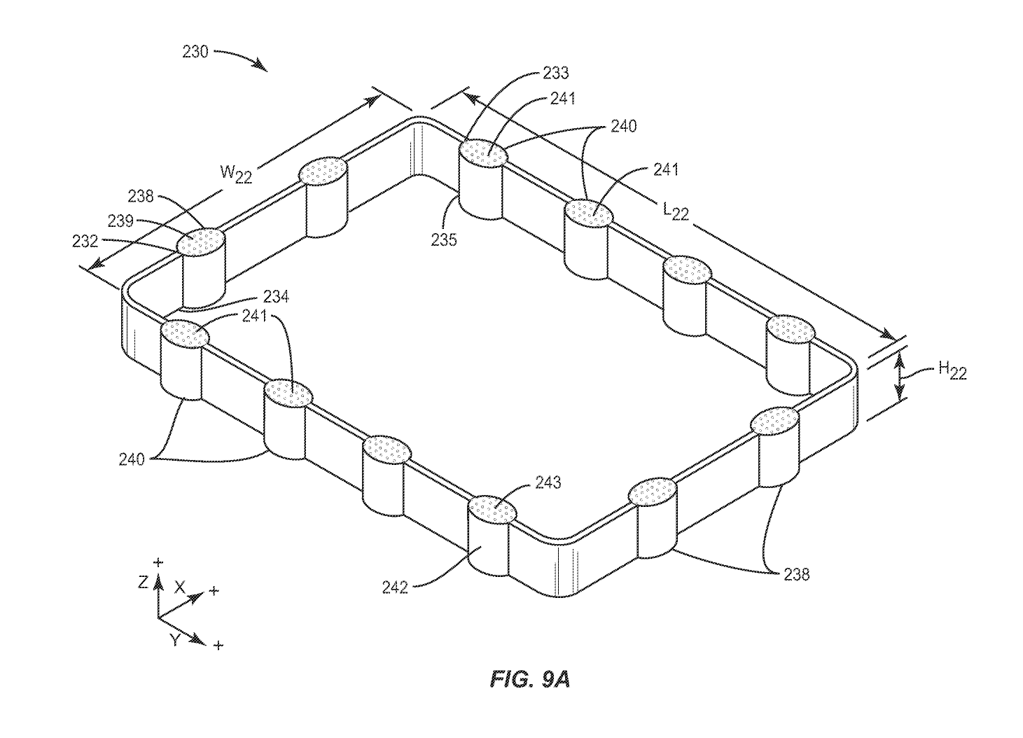

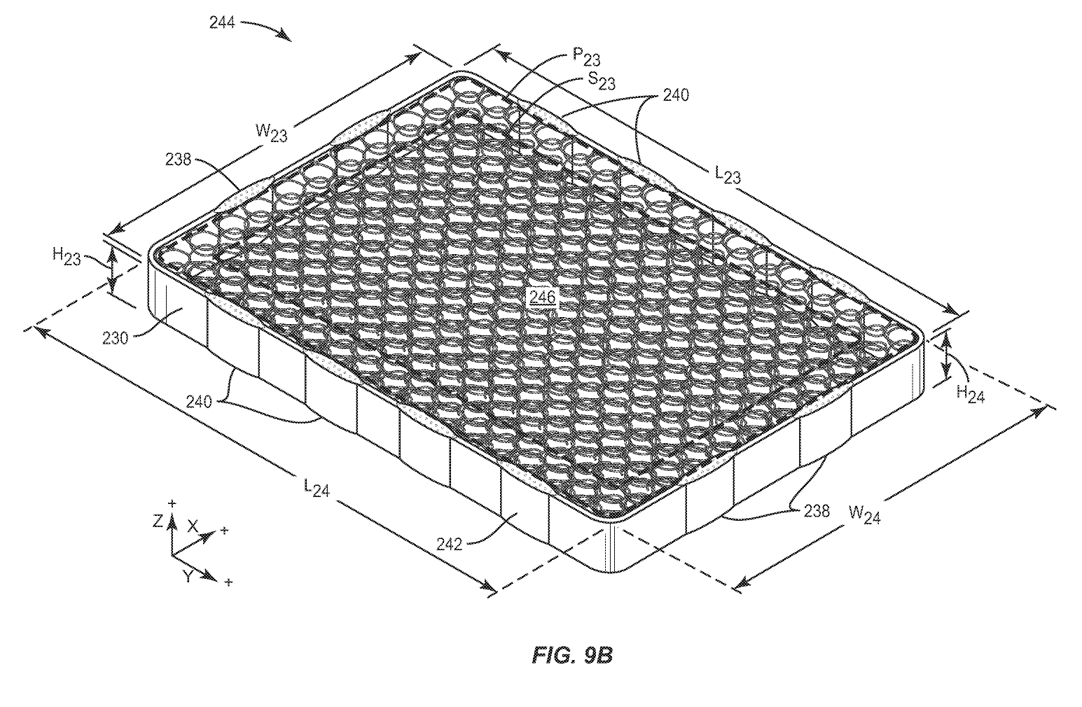

In this regard, FIG. 8A is a perspective view of another embodiment of an exemplary elastic foam edge-support band 204 for providing edge support and corner support for a mattress assembly. In this embodiment, the elastic foam edge-support band 204 has a preassembled inner width W₁₉, a preassembled inner length L₁₉, and a preassembled height H₁₉. Elastic foam edge-support band 204 is comprised of integrally formed expansion joints 212, 214 disposed along the width W₁₉ and length L₁₉ of the elastic foam edge-support band 204. Each of the integrally formed expansion joints 212, 214 are configured to expand the width W₁₉ of the elastic foam edge-support band 204 when a tension force is placed upon the elastic foam edge-support band 204. Each of the integrally formed expansion joints 214 are configured to expand the length L₁₉ of the elastic foam edge-support band 204 when a tension force is placed upon the elastic foam edge-support band 204. In this embodiment, integrally formed expansion joints 212, 214 are comprised of a non-planar portion of the elastic foam edge-support band. As illustrated in FIG. 8A, integrally formed expansion joints 212, 214 extend between a top edge 206, 207 and a bottom edge 208, 209 of the elastic foam edge-support band 204. Furthermore, integrally formed expansion joints 212, 214 form expandable enclosures in the elastic foam edge-support band 204. The expandable enclosures 212, 214 each have an interior 216, 218. The interiors 216, 218 can be left void of additional material, as illustrated in FIGS. 8A and 8B. As will be discussed below regarding FIGS. 9A and 9B, the interiors 216, 218 may also have a compressible material disposed in the interior 216, 218 of the expandable enclosures 212, 214. For example, a thermoset material may be disposed in the interior 216, 218 of the expandable enclosures 212, 214. When a tension force is placed on the integrally formed expandable enclosure expansion joints 212, the width W₁₉ of the elastic foam edge-support band 204 is increased. When a tension force is placed on the integrally formed expandable enclosure expansion joints 214, the length L₁₉ of the elastic foam edge-support band 204 is increased. The non-planar integrally formed expansion joints 212, 214 may be formed in the elastic foam edge-support band 204 as part of a mold, die, or other tooling to form the elastic foam edge-support band 204. Also, the non-planar integrally formed expansion joints 212, 214 may be formed by a cutter or other forming device. Any method to form the non-planar portions 212, 214 into the elastic foam edge-support band 204 can be employed and is encompassed herein.

FIG. 8B illustrates a mattress assembly 220 comprised of an elastic foam edge-support band 204 disposed around the outer perimeter of a mattress core 222. The mattress core 222 has an outer perimeter width W₂₀ disposed in a width dimension (dimension X, in this embodiment) of the sleep surface S₂₀ of the mattress core 222, an outer perimeter length L₂₀ disposed in a length dimension (dimension Y, in this embodiment) of the sleep surface S₂₀ of the mattress core 222, and a height H₂₀. Elastic foam edge-support band 204 is disposed in a rectangular-shaped form around the outer perimeter of the mattress core 222. As disposed in the mattress assembly 220, the preassembled inner perimeter width W₁₉ (FIG. 8A) of the elastic foam edge-support band 204 is less in distance than the outer perimeter width W₂₀ of the mattress core 222. As also disposed in the mattress assembly 220, the preassembled inner perimeter length L₁₉ (FIG. 8A) of the elastic foam edge-support band 204 is less in distance than the outer perimeter length L₂₀ of the mattress core 222. The elastic foam edge-support band 204 disposed in the mattress assembly 220 is compressively engaged along the outer perimeter P₂₀ of the mattress core 222 to form the mattress assembly 220. As disposed in the mattress assembly 220, the elastic foam edge-support band 204 has an assembled inner perimeter width W₂₁, an assembled inner perimeter length L₂₁, and an assembled height H₂₁. The assembled inner perimeter width W₂₁ of the elastic foam edge-support band 204 is greater in distance than the preassembled inner perimeter width W₁₉ (FIG. 8A) of the elastic foam edge-support band 204. Furthermore, the assembled inner perimeter length L₂₁ of the elastic foam edge-support band 204 is greater in distance than the preassembled inner perimeter length L₁₉ (FIG. 8A) of the elastic foam edge-support band 204.

In lieu of leaving an interior 216, 218 of an expandable enclosure (forming an expansion joint 212, 214 in an elastic foam edge-support band 204) void of additional material, as illustrated in FIGS. 8A and 8B, expandable enclosures may also be provided from one or more compressible materials.

In this regard, FIG. 9A is a perspective view of another exemplary elastic foam edge-support band 230 for providing edge support and corner support for a mattress assembly. Elastic foam edge-support band 230 is comprised of integrally formed expansion joints 238, 240 disposed along the width W₂₂ and length L₂₂ of the elastic foam edge-support band 230. Each of the integrally formed expansion joints 238 are configured to expand the width W₂₂ of the elastic foam edge-support band 230 when a tension force is placed upon the elastic foam edge-support band 230. Each of the integrally formed expansion joints 240 are configured to expand the length L₂₂ of the elastic foam edge-support band 230 when a tension force is placed upon the elastic foam edge-support band 230. In this embodiment, integrally formed expansion joints 238, 240 are comprised of a non-planar portion of the elastic foam edge-support band 230. As also illustrated in FIG. 9A, integrally formed expansion joints 238, 240 extend between a top edge 232, 233 and a bottom edge 234, 235 of the elastic foam edge-support band 230. Furthermore, integrally formed expansion joints 238, 240 form expandable enclosures in the elastic foam edge-support band 230. The expandable enclosures 238, 240 each have an interior 239, 241. As illustrated in FIGS. 9A-9B, the expandable enclosures 238, 240 have a compressible material disposed in the interior 239, 241 of the expandable enclosures 238, 240. For example, a thermoset material may be disposed in the interior 239, 241 of the expandable enclosures 238, 240. When a tension force is placed on the integrally formed expandable enclosure expansion joints 238, the width W₂₂ of the elastic foam edge-support band 230 is increased. When a tension force is placed on the integrally formed expandable enclosure expansion joints 240, the length L₂₂ of the elastic foam edge-support band 230 is increased. The non-planar integrally formed expansion joints 238, 240 may be formed in the elastic foam edge-support band 230 as part of a mold, die, or other tooling to form the elastic foam edge-support band 230. Also, the non-planar integrally formed expansion joints 238, 240 may be formed by a cutter or other forming device. The compressible material disposed in interior portions 239, 241 of the non-planar integrally formed expansion joints 238, 240 may be poured into the expandable enclosures 238, 240 after the expandable enclosures 238, 240 of the elastic foam edge-support band 230 has been formed. Furthermore, the compressible material disposed in interior portions 239, 241 of the non-planar integrally formed expansion joints 238, 240 may be co-extruded with other material forming the elastic foam edge-support band 230. Any method to form the non-planar expansion joints 238, 240 and dispose the compressible material in interior portions 239, 241 into the elastic foam edge-support band 230 can be employed and is encompassed herein.

In addition, the interior 239, 241 of one or more expansion joints 238, 240, 242 may or may not be punctured. For example, one or more punctures 243 may be provided through the expandable enclosures 238, 240, 242. Puncturing the expansion joints 238, 240, 242 may allow the expansion joints 238, 240, 242 to expand farther than when provided without punctures. The farther expansion may occur because providing punctures 243 in the expansion joint 238, 240, 242 may reduce the elastic modulus of the expansion joint 238, 240, 242. Reducing the elastic modulus of the expansion joint 238, 240, 242 allows the expansion joint 238, 240, 242 to expand farther under a given force.

In this regard, FIG. 9B illustrates a mattress assembly 244 comprised of an elastic foam edge-support band 230 disposed around the outer perimeter of a mattress core 246. The mattress core 246 has an outer perimeter width W₂₃ disposed in a width dimension (dimension X, in this embodiment) of the sleep surface S₂₃ of the mattress core 246 and an outer perimeter length L₂₃ disposed in a length dimension (dimension Y, in this embodiment) of the sleep surface S₂₃ of the mattress core 246. Elastic foam edge-support band 230 is disposed in a rectangular-shaped form around the outer perimeter of the mattress core 246. As disposed in the mattress assembly 244, the preassembled inner perimeter width W₂₂ (FIG. 9A) of the elastic foam edge-support band 230 is less in distance than the outer perimeter width W₂₃ of the mattress core 246. As also disposed in the mattress assembly 244, the preassembled inner perimeter length L₂₂ (FIG. 9A) of the elastic foam edge-support band 244 is less in distance than the outer perimeter length L₂₃ of the mattress core 246. The elastic foam edge-support band 230 disposed in the mattress assembly 246 is compressively engaged along the outer perimeter P₂₃ of the mattress core 246 to form the mattress assembly 244. As disposed in the mattress assembly 244, the elastic foam edge-support band 230 has an assembled inner perimeter width W₂₄, an assembled inner perimeter length L₂₄, and an assembled height H₂₄. The assembled inner perimeter width W₂₄ of the elastic foam edge-support band 230 is greater in distance than the preassembled inner perimeter width W₂₂ (FIG. 9A) of the elastic foam edge-support band 230. Furthermore, the assembled inner perimeter length L₂₄ of the elastic foam edge-support band 230 is greater in distance than the preassembled inner perimeter length L₂₂ (FIG. 9A) of the elastic foam edge-support band 230.

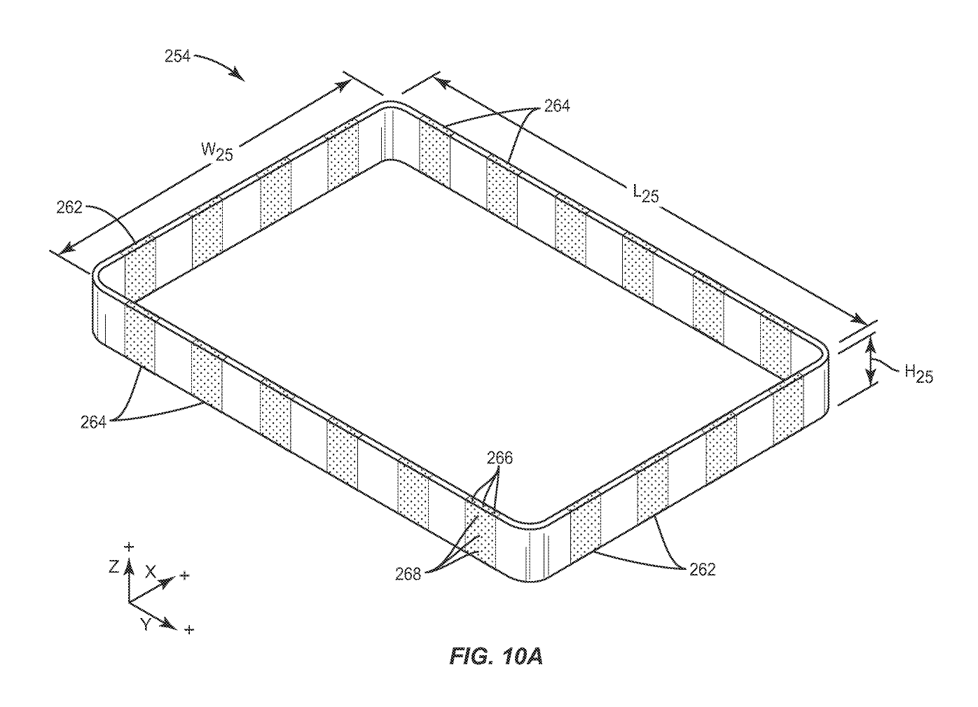

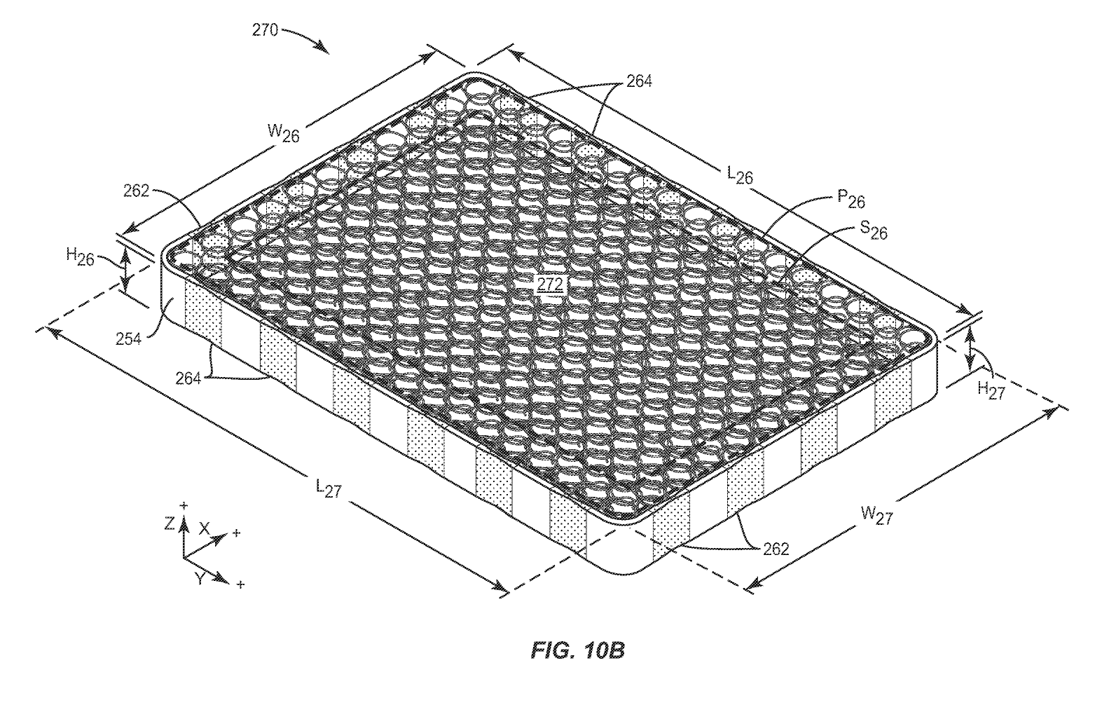

Integrally formed expansion joints of an elastic foam edge-support band may also be provided by other methods. In this regard, FIG. 10A illustrates another embodiment of an elastic foam edge-support band including integrally formed expansion joints formed from providing punctures. In this embodiment, the elastic foam edge-support band has a preassembled inner perimeter width W₂₅, a preassembled inner perimeter length L₂₅, and a preassembled height H₂₅. FIG. 10A provides a perspective view of an elastic foam edge-support band 254 for providing edge support and corner support for a mattress assembly in unexpanded form. In this embodiment, elastic foam edge-support band 254 is comprised of integrally formed expansion joints 262, 264 disposed along the width W₂₅ and length L₂₅ of the elastic foam edge-support band 254. Each of the integrally formed expansion joints 262 are configured to expand the width W₂₅ of the elastic foam edge-support band 254 when a tension force is placed upon the elastic foam edge-support band 254. Each of the integrally formed expansion joints 264 are configured to expand the length L₂₅ of the elastic foam edge-support band 254 when a tension force is placed upon the elastic foam edge-support band 254. In this embodiment, integrally formed expansion joints 262, 264 are comprised of an integrally formed elongated member 262, 264 allowing the elastic foam edge-support band 254 to expand along its perimeter. In one embodiment, the integrally formed elongated member 262, 264 may be comprised of an elastic material consisting of at least one material different from the material forming other portions of the elastic foam edge-support band 254. As a non-limiting example, the integrally formed elongated member 262, 264 may be formed from a thermoset material, while other portions of the elastic foam edge-support band 254 are formed from a thermoplastic material. In a further embodiment, the integrally formed elongated member 262, 264 may be comprised of a plurality of punctures 266, 268. The punctured elongated member 262, 264 may or may not be comprised of the same material forming other portions of the elastic foam edge-support band 254. When a tension force is placed on the integrally formed expansion joints 262, the width W₂₅ of the elastic foam edge-support band 254 is increased. When a tension force is placed on the integrally formed expansion joints 264, the length L₂₅ of the elastic foam edge-support band 254 is increased. The integrally formed expansion joints 262, 264 may be formed in the elastic foam edge-support band 254 as part of a mold, die, or other tooling to form the elastic foam edge-support band 254. In addition, integrally formed expansion joints 262, 264 may be welded (e.g. cohesively welded) to other portions of the elastic foam edge-support band 254 to form the elastic foam edge-support band 254. Any method to form the expansion joints 262, 264 into the elastic foam edge-support band 254 can be employed and is encompassed herein.

FIG. 10B illustrates a mattress assembly 270 comprised of an elastic foam edge-support band 254 disposed around the outer perimeter P₂₆ of a mattress core 272. The mattress core 272 has an outer perimeter width W₂₆ disposed in a width dimension (dimension X, in this embodiment) of the sleep surface S₂₆ of the mattress core 272 and an outer perimeter length L₂₆ disposed in a length dimension (dimension Y, in this embodiment) of the sleep surface S₂₆ of the mattress core 272. The mattress core 272 also has a height H₂₆. Elastic foam edge-support band 254 is disposed in a rectangular-shaped form around the outer perimeter of the mattress core 272. As disposed in the mattress assembly 270, the preassembled inner perimeter width W₂₅ (FIG. 10A) of the elastic foam edge-support band 254 is less in distance than the outer perimeter width W₂₆ of the mattress core 272. As also disposed in the mattress assembly 270, the preassembled inner perimeter length L₂₅ (FIG. 10A) of the elastic foam edge-support band 254 is less in distance than the outer perimeter length L₂₆ of the mattress core 272. The elastic foam edge-support band 254 disposed in the mattress assembly 270 is compressively engaged along the outer perimeter P₂₆ of the mattress core 272 to form the mattress assembly 270. As disposed in the mattress assembly 270, the elastic foam edge-support band 254 has an assembled inner perimeter width W₂₇, an assembled inner perimeter length L₂₇, and an assembled height H₂₇. The assembled inner perimeter width W₂₇ of the elastic foam edge-support band 254 is greater in distance than the preassembled inner perimeter width W₂₅ (FIG. 10A) of the elastic foam edge-support band 254. Furthermore, the assembled inner perimeter length L₂₇ of the elastic foam edge-support band 254 is greater in distance than the preassembled inner perimeter length L₂₅ (FIG. 10A) of the elastic foam edge-support band 254.

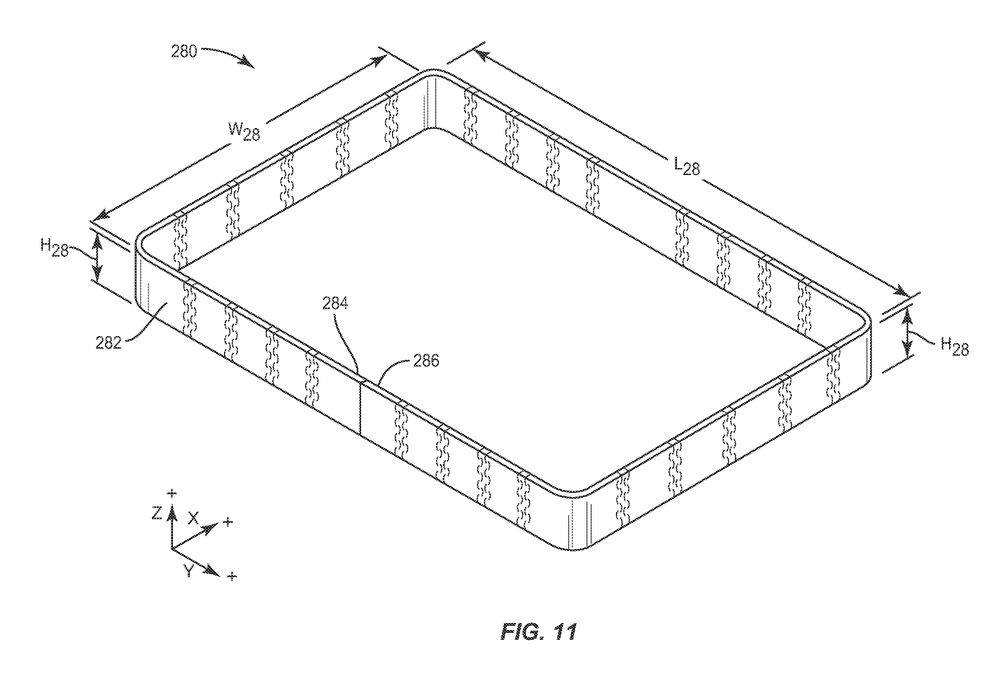

An elastic foam edge-support band may be formed from a single member. In this regard, referring now to FIG. 11, an elastic foam edge-support band 280 may be comprised of an elongated member 282. The elongated member 282 may be formed by a variety of processes. For example, in one embodiment the elongated member 282 may be formed in a mold. In another embodiment, the elongated member 282 may be formed from a substantially straight extrusion which is cut to a desired length. In a further embodiment, an elongated member 282 may be formed from a spirally, or helically, formed extrusion which is cut to a desired length. An example of a spirally, or helically, formed extrusion and methods for manufacturing the same are disclosed in U.S. Pat. No. 6,537,405 entitled “Spiral Formed Products and Method of Manufacture,” and U.S. Pat. No. 6,306,235 entitled “Spiral Formed Products and Method of Manufacture,” both of which are incorporated herein by reference in their entireties. Along its length, the elongated member 282 may have a first end 284 and a second end 286. The first end 284 and the second end 286 of the elongated member 282 may be secured to one another to form an elastic foam edge-support band 280. For example, the first and second ends 284, 286 of the elongated member 282 may be secured together by a variety of mechanisms. For example, the first and second ends 284, 286 of the elongated member 282 may be secured together by a weld (e.g. a cohesive weld), an integrally formed tongue and groove, an adhesive (e.g. a glue), or a mechanical fastener (e.g. a crimped ring, staple, or clamp), as non-limiting examples.

Once the first and second ends 284, 286 are secured together, the elastic foam edge-support band 280 is provided in a rectangular-shaped form. In this form, the elastic foam edge-support band 280 has a preassembled inner perimeter width W₂₈, a preassembled inner perimeter length L₂₈, and a preassembled height H₂₈.

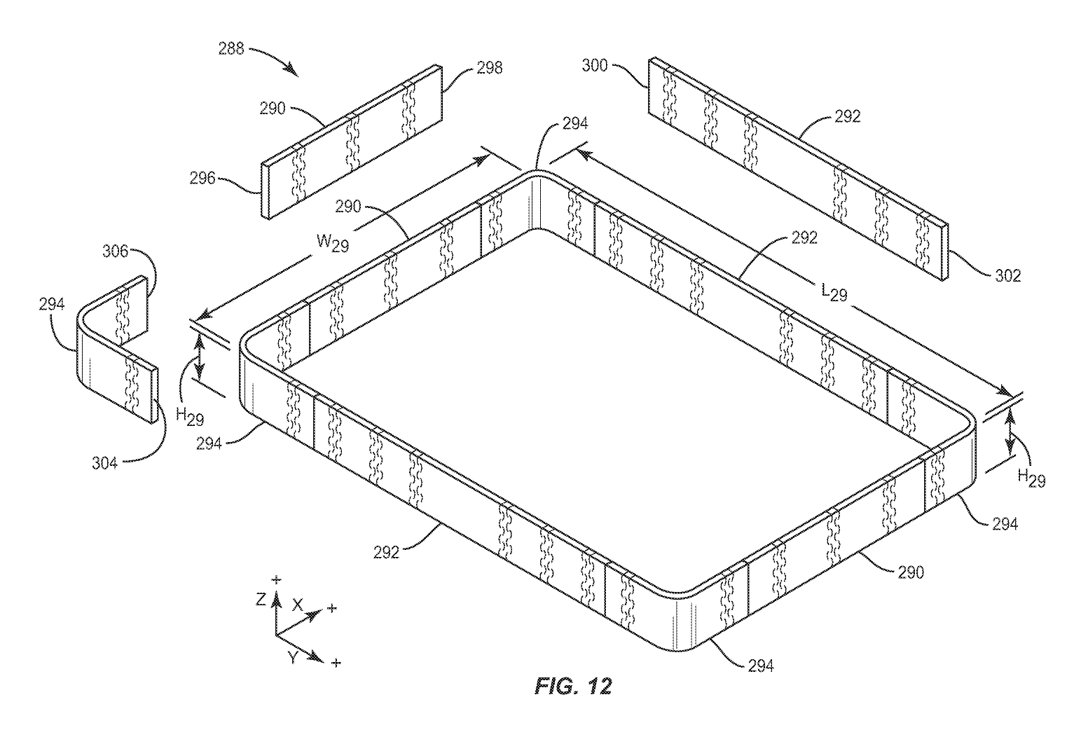

Instead of being formed from a single member, an elastic foam edge-support band may be formed from a plurality of members. In this regard, referring now to FIG. 12, an elastic foam edge-support band 288 may be formed from a plurality of side members 290, 292 and corner members 294. Along its length, each side member 290, 292 may have a first end 296, 300 and a second end 298, 302. Along its length, each corner member may also have a first end 304 and a second end 306. The side members 290, 292 and the corner members 294 may be secured together to form an elastic foam edge-support band 288 having a desired perimeter. For example, each end 304, 306 of each corner member 294 of the plurality of corner members 294 may be secured to an end 296, 298, 300, 302 of a side member 290, 292 of the plurality of side members to form an elastic foam edge-support band 288. (Alternatively, the band 288 may be formed from a plurality of corner members 294 and no side members 290, 292. For example, each first end 304 of each corner member 294 of the plurality of corner members could be secured to a second end 306 of another corner member to form an elastic foam edge-support band 288.) When the elastic foam edge-support band 288 is provided in a rectangular form, the elastic foam edge-support band 288 has a preassembled inner perimeter width W₂₉, a preassembled inner perimeter length L₂₉, and a preassembled height H₂₉. The side members 290, 292 and corner members 294 may be secured to one another using a variety of mechanisms. For example, the side members 290, 292 and corner members 294 may be secured to one another via a weld (e.g. a cohesive weld), an integrally formed tongue and groove, an adhesive, or a mechanical fastener (e.g. a crimped ring, staple, or clamp), as non-limiting examples.

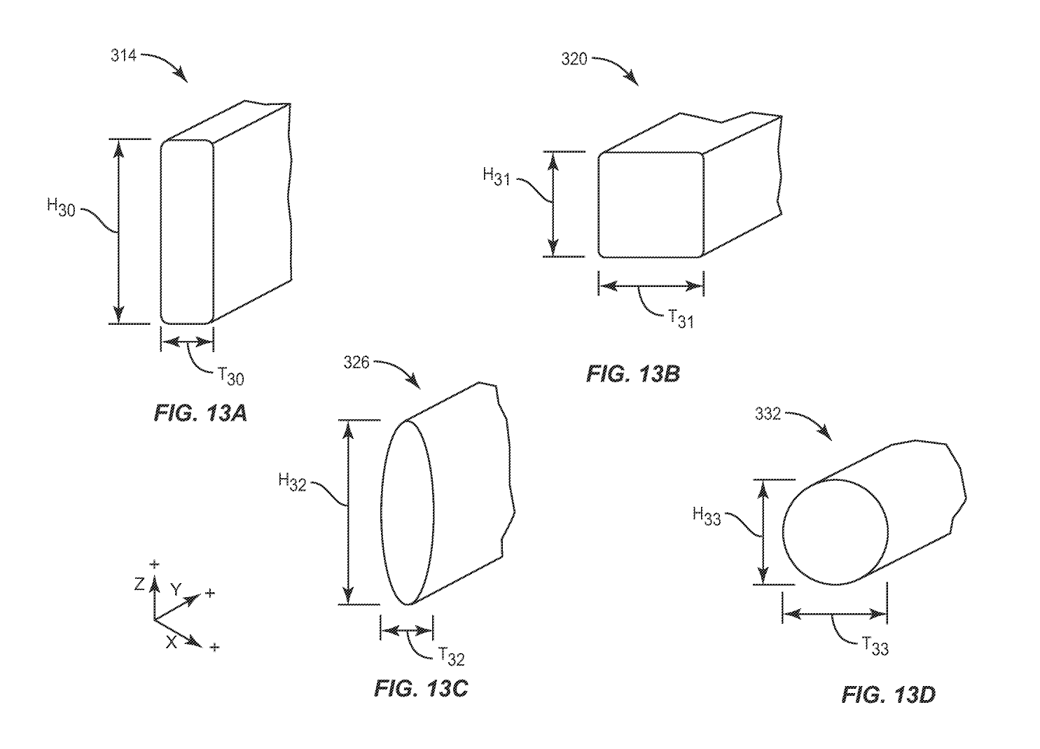

Referring now to FIGS. 13A, 13B, 13C, 13D, an elastic foam edge-support band 314, 320, 326, 332 may have a variety of cross-section shapes. For example, an elastic foam edge-support band 314, 320, 326, 332 may have a rectangular shape (FIG. 13A), a square shape (FIG. 13B), an oval shape (FIG. 13C), or a circular shape (FIG. 13D). In addition, the cross-section shape of the elastic foam edge-support band 314, 320, 326, 332 may or may not have hollow interior portions (not shown) running along the length of the elastic foam edge-support band 314, 320, 326, 332. The elastic foam edge-support band 314, 320, 326, 332 may be formed with a desired height H₃₀, H₃₁, H₃₂, H₃₃ and thickness T₃₀, T₃₁, T₃₂, T₃₃, consistent with its shape.

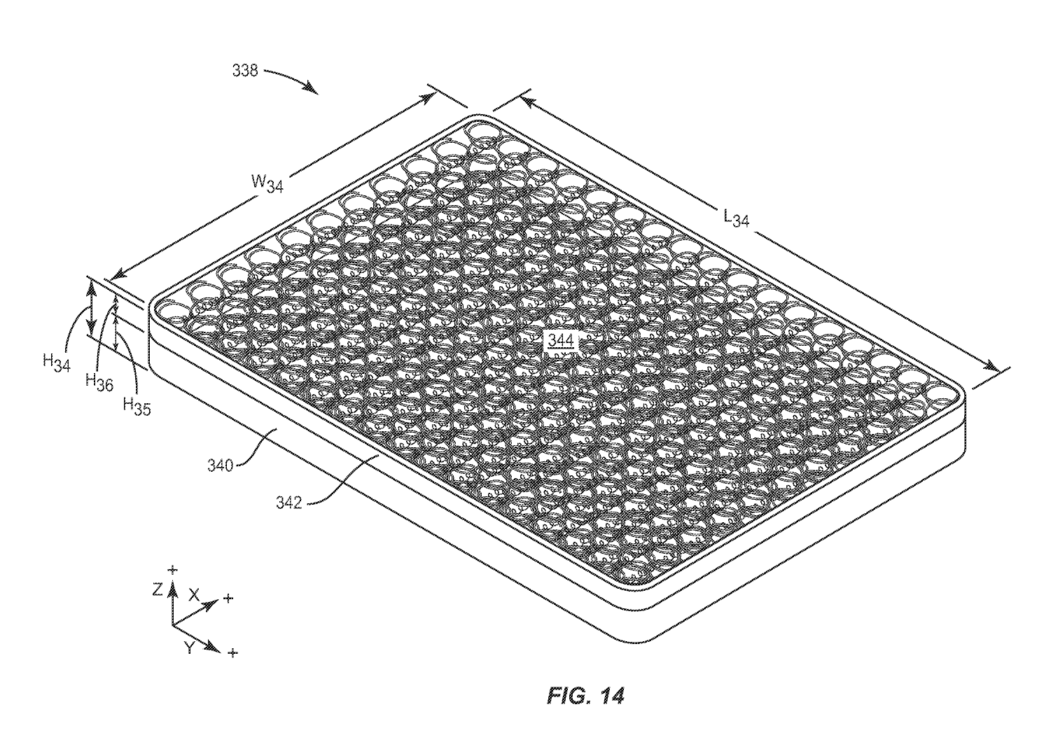

Referring now to FIG. 14, a mattress assembly 338 may be provided by disposing a plurality of elastic foam edge-support bands 340, 342 around the perimeter P₃₄ of a mattress core 344. A first elastic foam edge-support band 340 of the plurality of elastic foam edge-support bands 340, 342 may have different dimensions from a second elastic edge-support band 342 of the plurality of elastic edge-support bands. For example, as illustrated in FIG. 14, a first elastic foam edge-support band 340 disposed around a mattress core 344 may have a greater height H₃₅ than the height H₃₆ of a second elastic foam edge-support band 342 disposed around the mattress core 344. When the first and second elastic foam edge-support bands 340, 342 are provided to abut along their width W₃₄ and length L₃₄ one on top of the other, the first and second elastic foam edge-support bands 340, 342 may have a combined height H₃₄, which is the sum of their individual heights H₃₅, H₃₆.

The first and second elastic foam edge-support bands may also vary in other dimensions, including, for example, perimeter (e.g. perimeter width and/or perimeter length) or thickness T₃₄, T₃₅. The different dimensions of the first and second foam edge-support bands 340, 342 may result in a mattress assembly 338 having an upper portion of the mattress assembly 338 under either a lesser or a greater compressive force than a bottom portion of the mattress assembly 338. Providing bands of differing dimensions provides an ability to adjust and/or customize the feel of the mattress assembly 338, for example, to increase or decrease the firmness of the mattress assembly 338 and/or increase or decrease the softness of the mattress assembly 338. Providing bands of differing dimensions may also provide an ability to adjust the aesthetics (exterior appearance) of the mattress assembly 338.

A mattress assembly 338 may also be comprised of a first elastic foam edge-support band 340 formed from at least one first material and a second elastic foam edge-support band 342 formed from at least one material different form the at least one first material(s). The differences in materials of the first and second foam edge-support bands 340, 342 of the mattress assembly 338 may result in a mattress assembly 338 having an upper portion of the mattress assembly 338 under either a lesser or a greater compressive force than a bottom portion of the mattress assembly 338. Providing bands formed from differing materials also provides an ability to adjust and/or customize the feel of the mattress assembly 338, for example, to increase or decrease the firmness of the mattress assembly 338 and/or increase or decrease the softness of the mattress assembly 338. Providing bands of differing materials may also provide an ability to adjust the aesthetics (exterior appearance) of the mattress assembly 338.

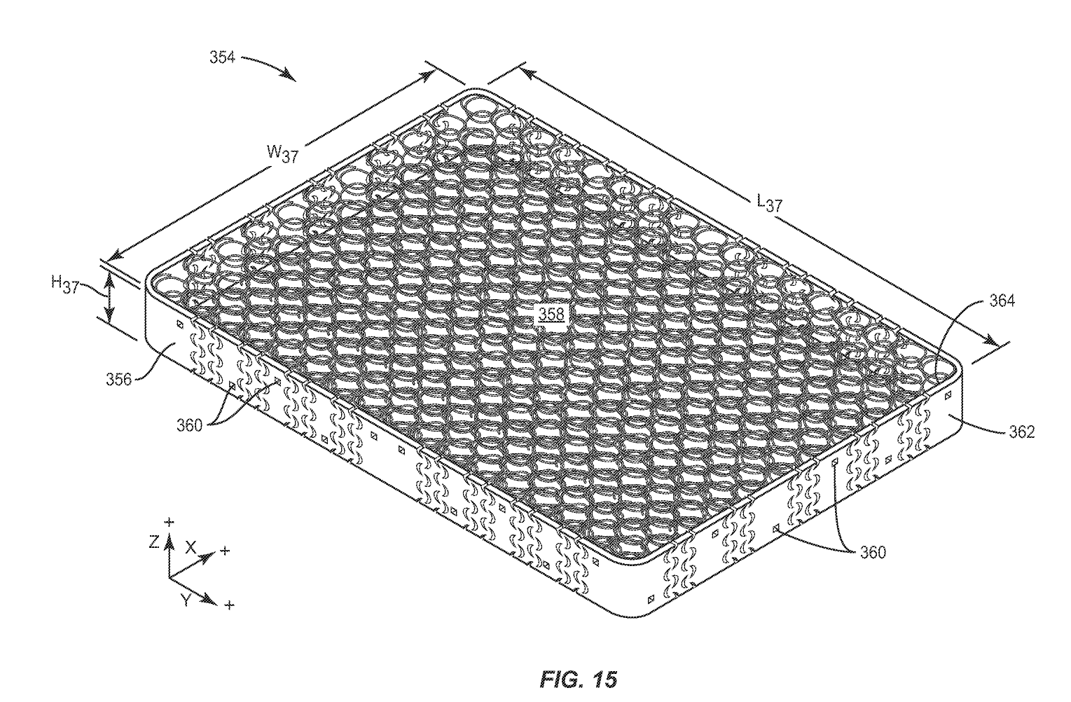

As illustrated by FIG. 15, a mattress assembly 354 may be provided in which one or more ventilation channels 360 are disposed in the elastic foam edge-support band 356 of the mattress assembly 354 to ventilate atmosphere from the assembled outer perimeter 362 of the elastic foam edge-support band 356 to the assembled inner perimeter 364 of the elastic foam edge-support band 356. With these ventilation channels 360, the rate of exchange of air interior to the mattress assembly 354 with air exterior to the mattress assembly 354 may be increased.

Because of the compression force which the elastic foam edge-support band 356 provides to the mattress core 358, the mattress assembly 354 may be provided without attachment members for attaching the elastic foam edge-support band 356 to the mattress core 358. However, attachment members may also be provided for attaching the elastic foam edge-support band 356 to the mattress core 358. In this embodiment, the outer perimeter width, outer perimeter length, and height of the mattress core may be substantially the same as the assembled inner perimeter width, assembled inner perimeter length, and assembled height of the elastic foam edge-support band, namely W₃₇, L₃₇, and H₃₇, respectively.

In some embodiments, a bowing of the elastic foam edge-support band along the perimeter width, perimeter length, and/or perimeter height of the mattress assembly may occur when a force is applied to an edge of the mattress assembly, for example, such as during mounting onto and dismounting from the mattress assembly. This bowing may result in a middle portion of the band being displaced further away from mattress core. Embodiments are now discussed which reduce the bowing of the elastic foam edge-support band from the mattress core. These embodiments provide attachment of the elastic foam edge-support band to the perimeter of a mattress core, resulting in a resilient conformance of the elastic foam edge-support band to the perimeter of the mattress core, when a force is applied or removed from an edge of the mattress assembly, for example, such as during mounting onto and dismounting from the mattress assembly.

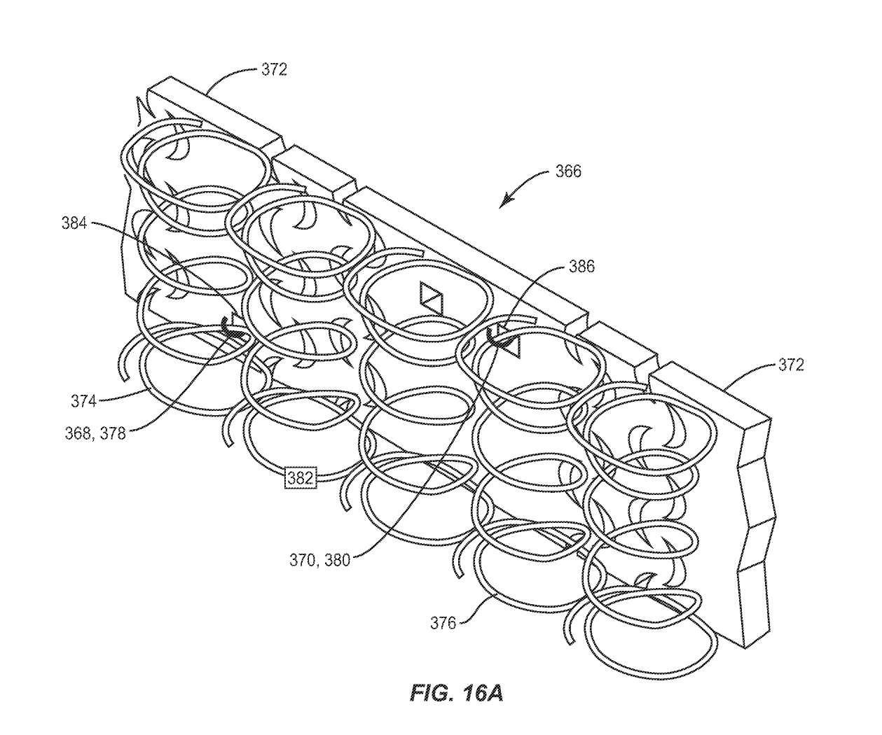

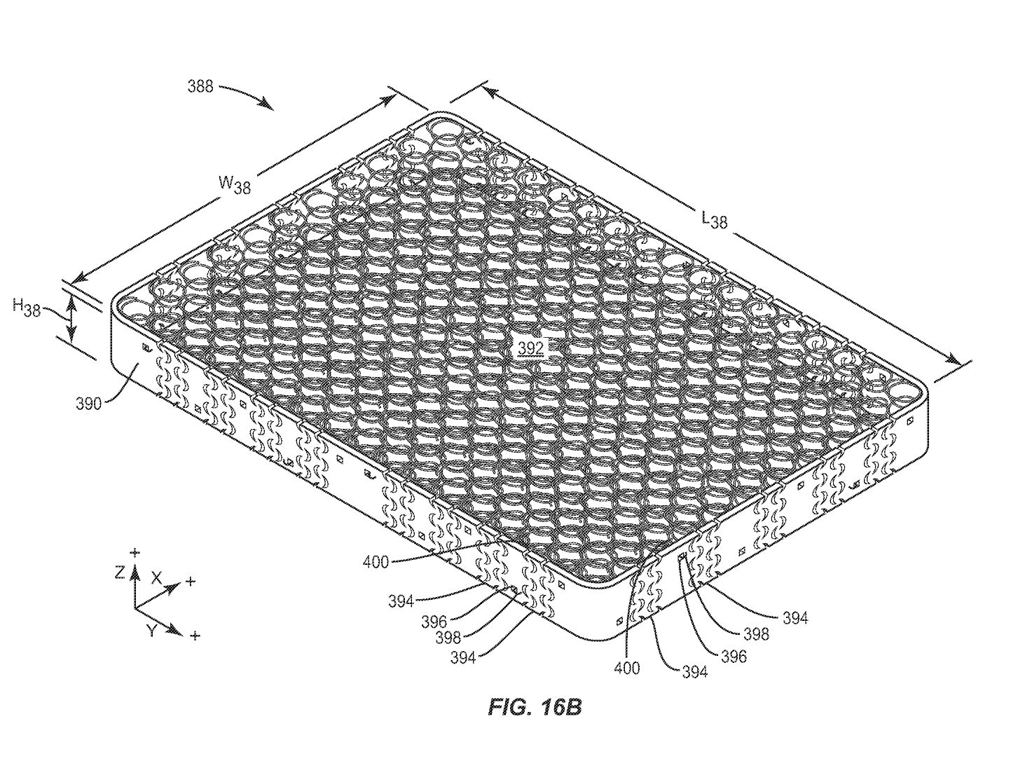

FIG. 16A provides a partial perspective view of a mattress assembly 366 having attachment members 368, 370 securing an elastic foam edge-support band 372 to peripheral innerspring coils 374, 376 of a mattress core 382. In one embodiment, an attachment member 368, 370 may comprise a crimpable ring 378, 380 which has been crimped so as to encircle at least a portion of the mattress core 382 and at least a portion of the elastic foam support band 372, thereby fastening or securing the elastic foam edge-support band 372 to that portion of the mattress core 382. For example, the crimpable ring 378, 380 may be a hog ring. As illustrated in FIG. 16A, the crimpable ring 378, 380 may be crimped so as to encircle at least a portion of the elastic foam edge-support band 372 and at least a portion of a peripheral innerspring coil 374, 376 of the mattress core 382. Portions of the crimped ring 378, 380 may puncture the elastic foam edge-support band 372. Portions of the crimped ring 378, 380 may thread through a ventilation channel 384, 386 of the elastic foam edge-support band 372. For example, as illustrated in FIG. 16A, a first portion of the crimped ring 378, 380 is threaded through a ventilation channel 384, 386 and a second portion of the crimped ring 378, 380 punctures the elastic foam edge-support band 372.

In one embodiment, during assembly, at least a portion of an innerspring coil 374, 376 of the mattress core 382 may be sighted through a ventilation channel 384, 386 of the elastic foam edge-support band 372. In this embodiment, the attachment member 368, 370 is attached to the sighted innerspring coil 374, 376 of the mattress core 382. For example, the crimping of a crimped ring 378, 380 secures the crimped ring 378, 380 to the sighted innerspring coil 374, 376 of the mattress core 382. By way of further example, a portion of an innerspring coil 374, 376 may be sighted through a ventilation channel 384, 386. At least a portion of the crimpable ring 378, 380 may be threaded through the ventilation channel 384, 386 of the elastic foam edge-support band 372. The crimpable ring 378, 380 may be crimped so as to puncture the crimpable ring 378, 380 through the elastic foam edge-support band 372 such that the crimping secures the crimpable ring 378, 380 to the sighted innerspring coil 374, 376 of the mattress core 382.

FIG. 16B illustrates a perspective view of an embodiment providing such attachment members. In FIG. 16B, a mattress assembly 388 is provided which is comprised of an elastic foam edge-support band 390 disposed around an innerspring coil mattress core 392. Disposed between expansion joints 394 are ventilation channels 396 for ventilating atmosphere from the outer perimeter of the exemplary elastic foam edge-support band 390 to an interior of the mattress core 392. As illustrated in FIG. 16B, attachment members 398 each thread through a ventilation channel 396 of the elastic foam edge-support band 390. The attachment members 398 also puncture the elastic foam edge-support band 390. The attachment members 398 are disposed to encircle at least a portion of the outer perimeter coils 400 of the mattress core 392 and the elastic foam edge-support band 390, thereby attaching the elastic foam edge-support band 390 to the mattress core 392. In this embodiment, the outer perimeter width, outer perimeter length, and height of the mattress core may be substantially the same as the assembled inner perimeter width, assembled inner perimeter length, and assembled height of the elastic foam edge-support band, namely W₃₈, L₃₈, and H₃₈, respectively.

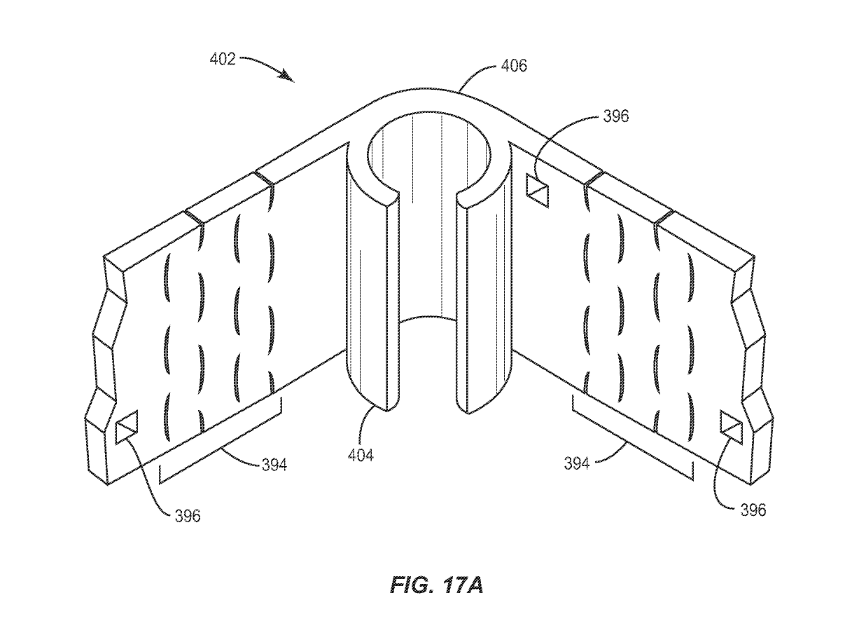

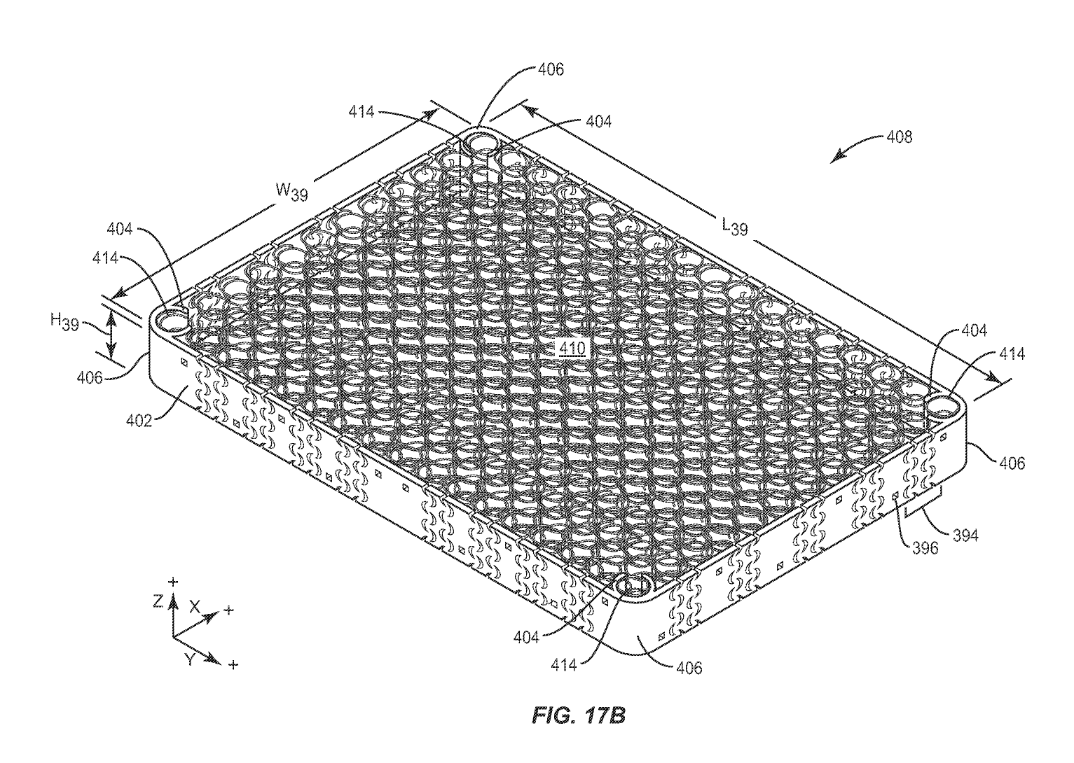

Referring now to FIG. 17A, one or more integrally formed spacers may be disposed in an elastic foam edge-support band 402 for positioning at least a portion of the elastic foam edge-support band 402 in relation to at least a portion of the mattress core around which it is disposed. In this regard, FIG. 17A illustrates a partial perspective view of an embodiment providing an integrally formed C-shaped spacer 404 disposed in a corner 406 of an elastic foam edge-support band 402. The C-shaped spacer 404 is adapted to position a corner 406 of the elastic foam edge-support band 402 in relation to a corner coil of a mattress core. For example, FIG. 17B illustrates an embodiment of a mattress assembly 408 wherein integrally formed C-shaped spacers 404 of the elastic foam edge-support band 402 each position a corner 406 of the elastic foam edge-support band 402 in relation to a corner coil 414 of an innerspring mattress core 410. In this embodiment, the outer perimeter width, outer perimeter length, and height of the mattress core may be substantially the same as the assembled inner perimeter width, assembled inner perimeter length, and assembled height of the elastic foam edge-support band, namely W₃₉, L₃₉, and H₃₉, respectively.

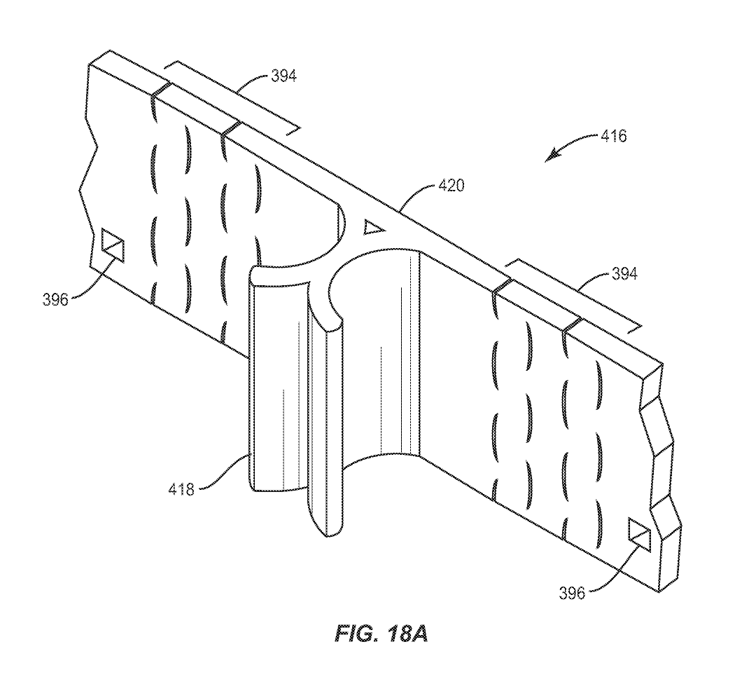

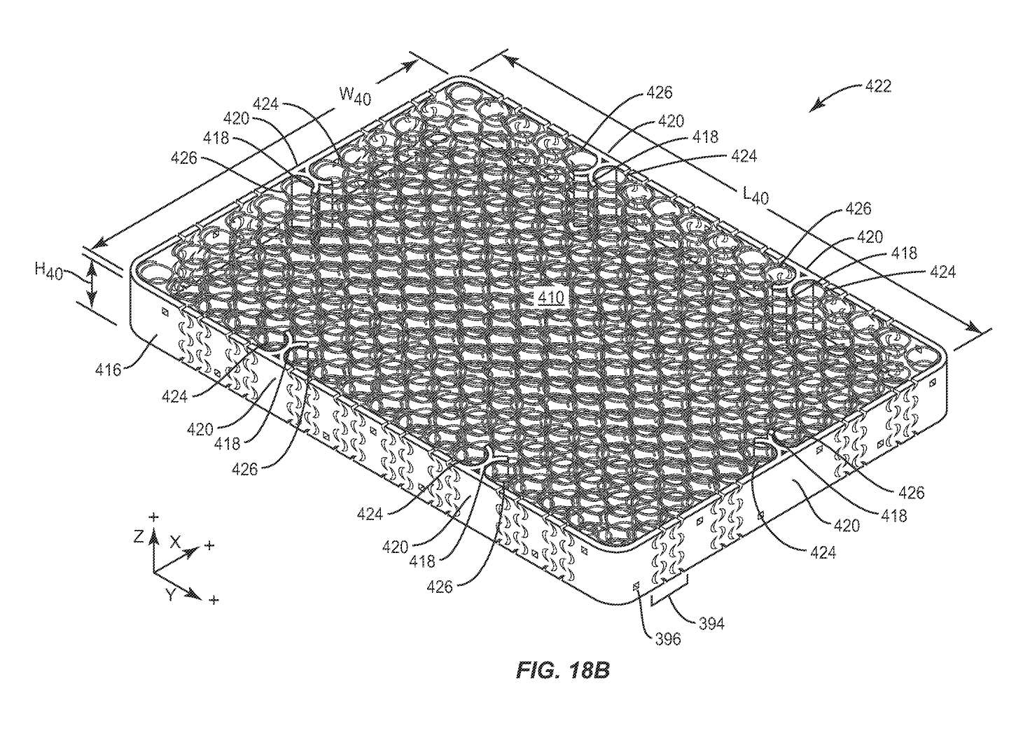

Other spacers may also be provided for positioning at least a portion of the elastic foam edge-support band in relation to at least a portion of the mattress core. In this regard, FIG. 18A illustrates a partial perspective view of an embodiment providing an integrally formed X-shaped spacer 418 disposed in a side 420 of an elastic foam edge-support band 416. The X-shaped spacer 418 is adapted to position at least a portion of the elastic foam edge-support band 416 in relation to a pair of adjacent outer coils of a mattress core 410. For example, FIG. 18B illustrates an embodiment of a mattress assembly 422 wherein integrally formed X-shaped spacers 418 of the elastic foam edge-support band 416 each position a side portion 420 of the elastic foam edge-support band 416 in relation to adjacent outer coils 424, 426 of an innerspring mattress core 410. In this embodiment, mattress core 410 has an outer perimeter width W₄₀, an outer perimeter length L₄₀, and a height H₄₀ which may be substantially the same as the assembled inner perimeter width, assembled inner perimeter length, and assembled height of the elastic foam edge-support band 430.

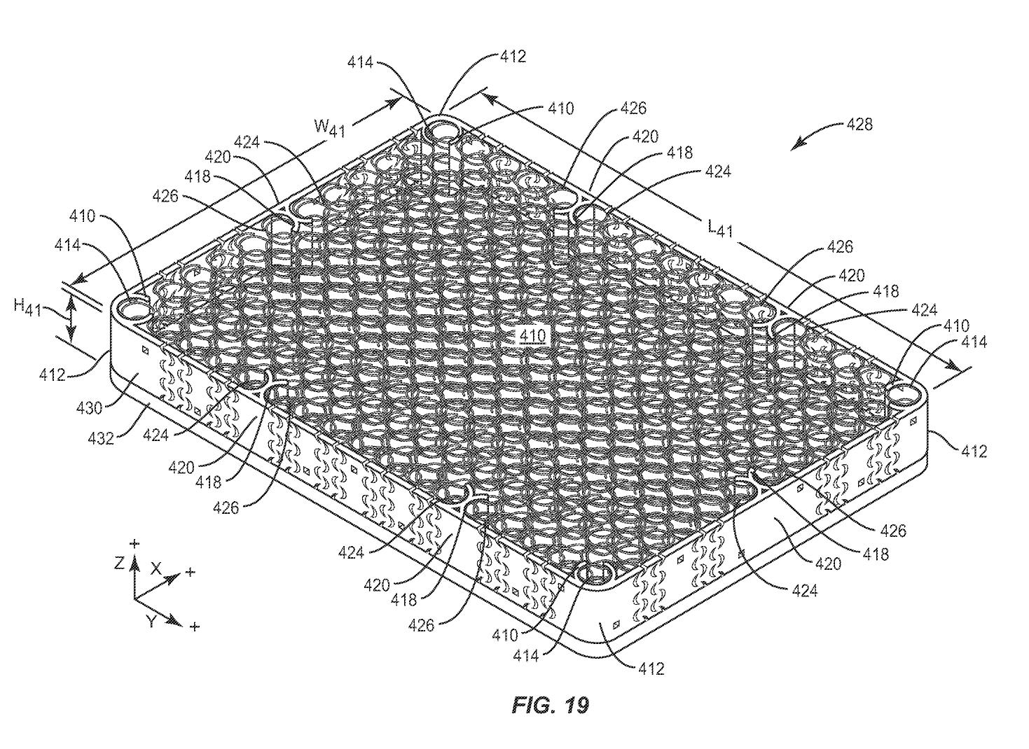

Two or more different types of integrally formed spacers may be disposed in an elastic foam edge-support band for positioning at least some portions of the elastic foam edge-support band in relation to at least some portions of the mattress core. In this regard, FIG. 19 illustrates a partial perspective view of an embodiment of a mattress assembly 428 providing both integrally formed C-shaped spacers 410 and X-shaped spacers 418. Each integrally formed C-shaped spacer 410 of the elastic foam edge-support band 430 may position a corner 412 of the elastic foam edge-support band 430 in relation to a corner coil 414 of an innerspring mattress core 410. Integrally-formed X-shaped spacers 410 are disposed in the sides 420 of the elastic foam edge-support band 430. Each X-shaped spacer 418 is adapted to position at least a portion of the elastic foam edge-support band 430 in relation to a pair of adjacent outer coils 424, 426 of an innerspring mattress core 410. The elastic foam edge-support band 430 is also comprised of a mattress base 432. At least a portion of the elastic foam edge-support band 430 may be secured to the mattress base 432. For example, elastic foam edge-support band 430 and the mattress base 432 may be secured together by a weld (e.g. a cohesive weld), an integrally formed tongue and groove, an adhesive (e.g. a glue), or a mechanical fastener (e.g. a crimped ring, staple, or clamp), as non-limiting examples. In this embodiment, the outer perimeter width W₄₁, outer perimeter length L₄₁, and height H₄₁, of the mattress core 410 may be substantially the same as the assembled inner perimeter width, assembled inner perimeter length, and assembled height of the elastic foam edge-support band 430.

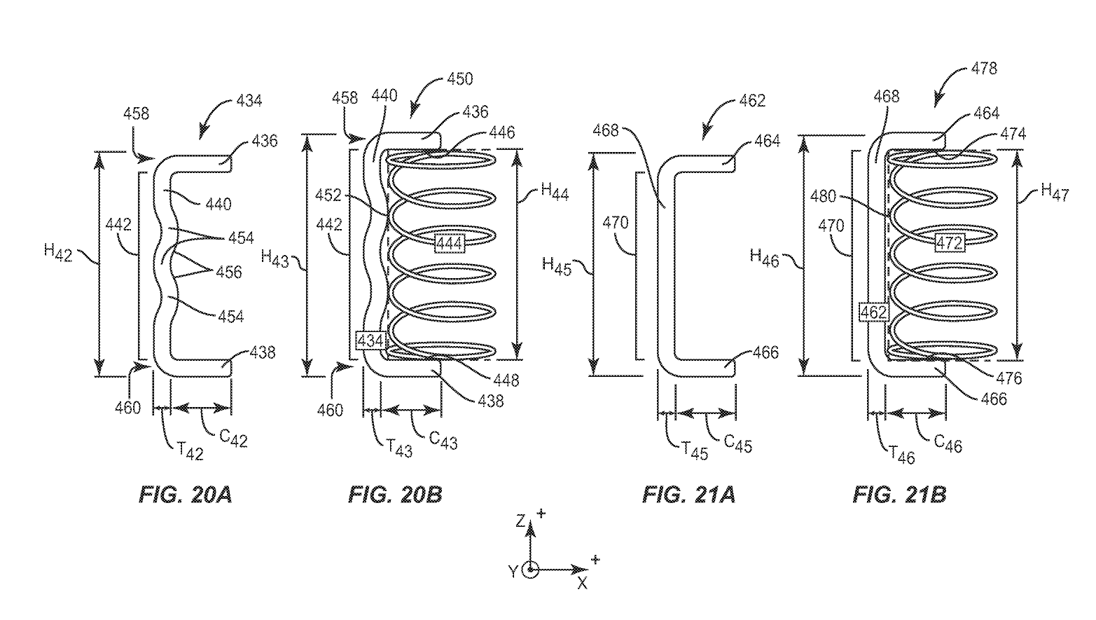

In addition to compressively engaging the outer perimeter of a mattress core, an elastic foam edge-support band may also compressively engage at least some additional surfaces of the mattress core to form the mattress assembly. In this regard, referring now to FIGS. 20A, 20B, 21A, and 21B, an elastic foam edge-support band 434, 462 may have a C-shaped cross-section. The C-shaped cross-section of the elastic foam edge-support band 434, 462 may include an upper leg (or ridge) 436, 464, a lower leg (or ridge) 438, 466 and a perimeter portion 440, 468. The C-shaped cross-section of the elastic foam edge-support band may include at least one expandable joint 442, 470. The at least one expandable joint 442, 470 may be integrally formed in the elastic foam edge-support band 434, 462. The at least one expandable joint 442, 470 may be configured to expand in a height dimension (dimension Z, in these embodiments) of the elastic foam edge-support band 434, 470 to allow the height of the at least one elastic foam edge-support band 434, 462 to be expanded when assembled. In this regard, FIGS. 20A and 21A depict an elastic foam edge-support band 434, 462 when preassembled, having a preassembled height H₄₂, H₄₅, a preassembled thickness T₄₂, T₄₅, and a preassembled leg length C₄₂, C₄₅.

FIGS. 20B and 21B depict elastic foam edge-support band 434, 462 stretched around at least one exemplary coil of an exemplary innerspring mattress core 444, 472 to form a mattress assembly 450, 478. When assembled, the elastic foam edge-support band 434, 462 has an assembled height H₄₃, H₄₆, an assembled thickness T₄₃, T₄₆, and an assembled leg length C₄₃, C₄₆. The assembled height H₄₃, H₄₆ of the elastic foam edge-support band 434, 462 is greater than the preassembled height H₄₂, H₄₅ of elastic foam edge-support band 434, 462 (in FIGS. 20A and 21A). When assembled, the height H₄₃, H₄₆ of the elastic foam edge-support band 434, 462 is also greater than the height H₄₄, H₄₇ of the mattress core 444, 472. When assembled, the top leg 436, 464 compressively engages a top surface 446, 474 of the mattress core 444, 472 and the bottom leg 438, 466 compressively engages a bottom surface 448, 476 of the mattress core 444, 472 to form the mattress assembly 450, 478. As previously discussed, the perimeter portion 440, 468 of the elastic foam edge-support band 434 may also compressively engage the outer perimeter 452, 480 of the mattress core 444, 472. The top leg 436, 464 and bottom leg 438, 466 of the elastic foam edge-support band 434, 462 may have a preassembled leg length C₄₂, C₄₅ and an assembled leg length C₄₃, C₄₆.

As depicted in FIGS. 20A and 20B, the at least one expandable joint 442 may include at least one non-planar portion 454 integrally formed in the at least one elastic foam edge-support band 434. The at least one non-planar portion 454 may allow the elastic foam edge-support band 434 to expand further in a height dimension (dimension Z, in these embodiments) than the elastic foam edge-support band 434 could expand without the at least one non-planar portion 454. The at least one non-planar portion 454 may include at least one inflection plane 456. The at least one non-planar portion 454 of the elastic foam edge-support band 434 may extend between a top edge 458 and a bottom edge 460 of the elastic foam edge-support band 434.

As depicted in FIGS. 20A, 20B, 21A, and 21B, the mattress core 444, 472 may have a height H₄₂, H₄₃, H₄₅, H₄₆ which is orthogonal to the sleep surface 446, 474 of the mattress core 444, 472. At least one elastic foam edge-support band 434, 462 may have a preassembled height H₄₂, H₄₅ which is less in distance than the height of the mattress core 444, 472. The at least one elastic foam edge-support band 434, 462 is compressively engaged along a top surface 446, 474 and bottom surface 448, 476 of the mattress core 444, 472 when assembled to form the mattress assembly 450, 478. The at least one elastic foam edge-support band 434, 462 also has an assembled height H₄₃, H₄₆ which is greater in distance than the preassembled height H₄₂, H₄₅ of the elastic foam edge-support band 434, 462.

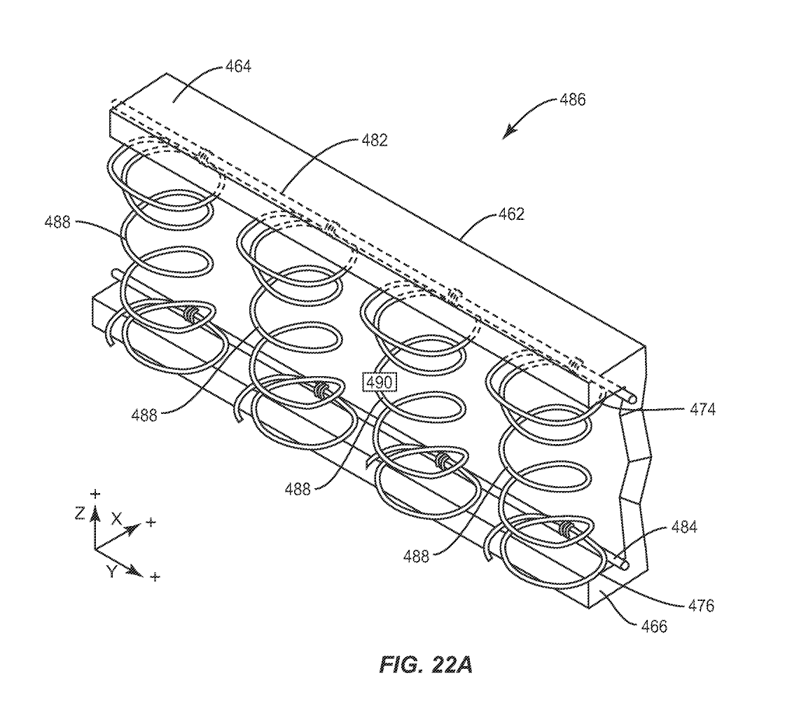

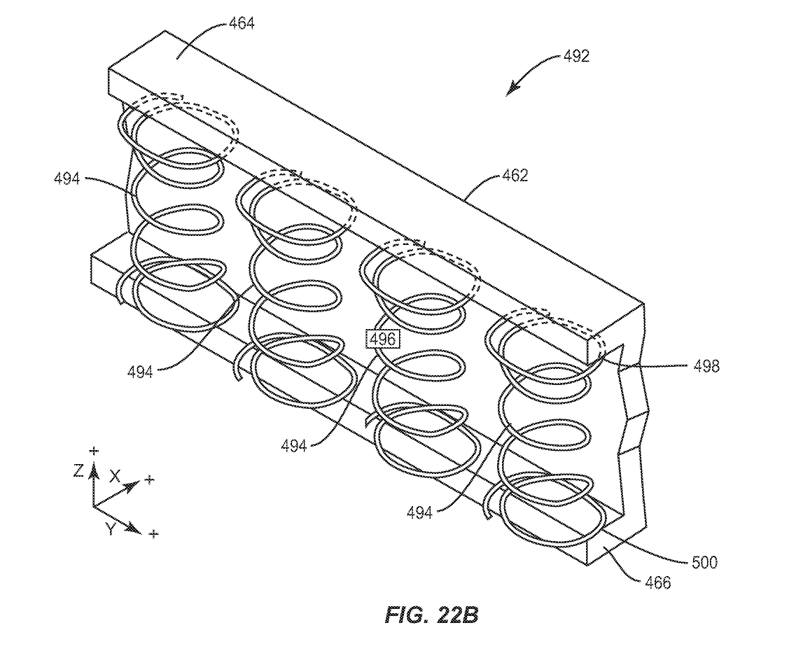

FIG. 22A depicts a partial perspective view of an exemplary mattress assembly 486. The exemplary mattress assembly 486 is comprised of an exemplary elastic foam edge-support band 462 having a C-shaped cross section stretched above the top and below the bottom of exemplary coils 488 of an innerspring mattress core 490. A top portion 464 of the C-shaped foam edge-support band 462 overlaps a top border wire 482 of the innerspring mattress core 490 along the top perimeter surface 474 of the coils 488 of the mattress core 490. A bottom portion 466 of the C-shaped foam edge-support band overlaps a bottom border wire 484 along the bottom perimeter surface 476 of the mattress core 490. The overlapping portions of the elastic foam edge-support band 462 compressively engage the top surface 474 and bottom surface 476 of the mattress core 490. This compressive engagement secures the elastic foam edge-support band 462 to the mattress core 490. Together, the elastic foam edge-support band 462 and the top border wire 482 and bottom border wire 484 each provide an increased edge-support for the mattress assembly 486. The elastic foam edge-support band 462 may overlap the top border wire 482 of the mattress core 490 along an entire top perimeter 474 of the mattress core 490 when assembled. The elastic foam edge-support band 462 may also overlap the bottom border wire 484 of the mattress core 490 along an entire bottom perimeter 476 of the mattress core 490 when assembled.

An elastic foam edge-support band may provide increased edge-support for a mattress assembly even when the mattress assembly does not have border wires. In this regard, a mattress assembly may be comprised of an elastic foam edge-support band stretched around a mattress core having no border wires, for example, without the top and/or bottom border wires 482, 484 depicted in FIG. 22A. In this regard, FIG. 22B depicts a mattress assembly 492 comprised of the elastic foam edge-support band 462 stretched around exemplary coils 494 of an exemplary innerspring mattress core 496 having no border wires. When disposed around the mattress core 496, the elastic foam edge-support band 462 provides edge-support for the mattress assembly 492. The exemplary mattress assembly 492 is comprised of an exemplary elastic foam edge-support band 462 having a C-shaped cross section stretched above the top and below the bottom of exemplary coils 494 of an innerspring mattress core 496. A top portion 464 of the C-shaped foam edge-support band 462 overlaps top and bottom portions of perimeter coils 494 of the innerspring mattress core 496 along the top perimeter surface 498 and bottom perimeter surface 500 of the mattress core 496. The overlapping portions of the elastic foam edge-support band 462 compressively engage the top surface 498 and bottom surface 500 of the mattress core 496. This compressive engagement secures the elastic foam edge-support band 462 to the mattress core 496, while also providing an increased edge-support for the mattress assembly 492.

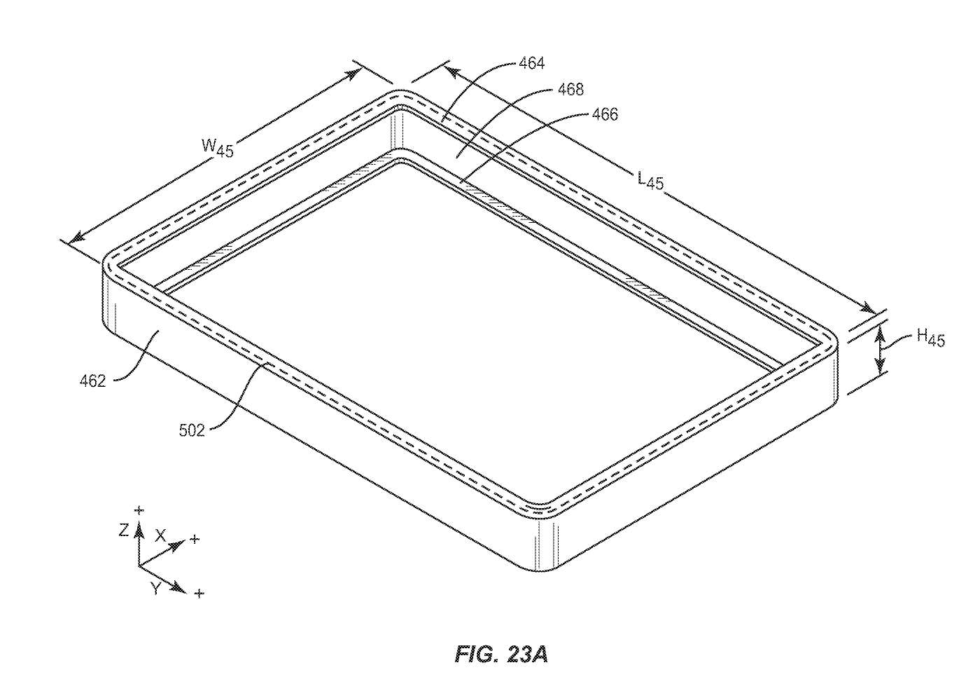

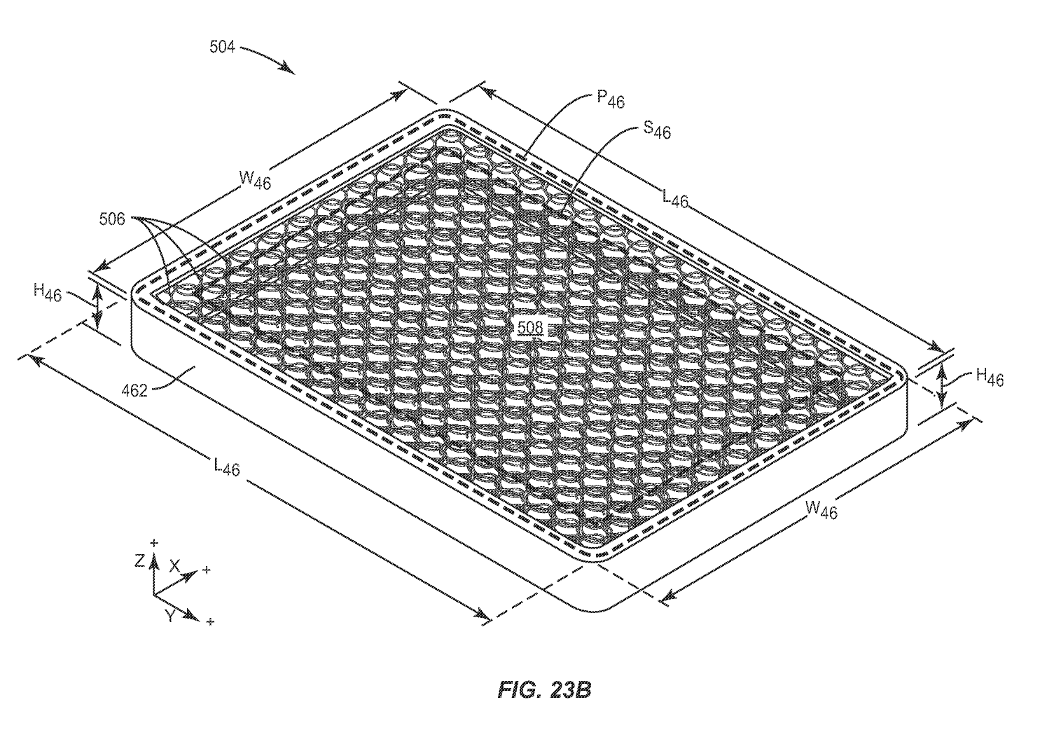

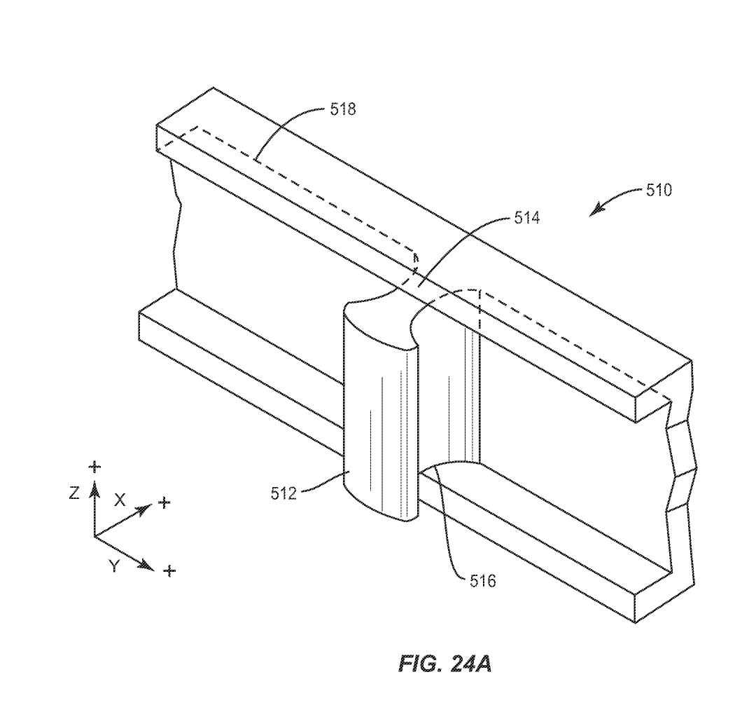

FIG. 23A is a perspective view of the exemplary elastic foam edge-support band 462 for providing edge support and corner support for a mattress assembly. Elastic foam edge-support band 462 has a C-shaped cross-section with an upper leg (or ridge) 464, a lower leg (or ridge) 466, and a perimeter portion 468. FIG. 23A depicts the elastic foam edge-support band 462 prior to the assembling of a mattress assembly 504 (FIG. 23B). As depicted in FIG. 23A, the top and bottom legs (or ridges) 464, 466 extend beyond the interior surface 502 of the elastic foam edge-support band 462. The top and bottom legs (ridges) 464, 466 extend towards the interior of the elastic foam edge-support band 462. Top and bottom legs (ridges) 464, 466 may extend along the entire circumference of the elastic foam edge-support band, including along the elastic foam edge-support band's entire length L₄₅ and width W₄₅. When disposed in a rectangular shape, the elastic foam edge-support band 462 has a preassembled inner perimeter width W₄₅, a preassembled inner perimeter length L₄₅, and a preassembled height H₄₅. These dimensions are the unstretched dimensions of the elastic foam edge support band 462, before the elastic foam edge-support band 462 is stretched around a mattress core 508, as depicted in FIG. 23B.

FIG. 23B depicts a mattress assembly 504 comprised of the elastic foam edge-support band 462 disposed around the outer perimeter P₄₆ of a mattress core 508. The mattress core 508 has an outer perimeter width W₄₆ disposed in a width dimension (dimension X, in this embodiment) of the sleep surface S₄₆ of the mattress core 508 and an outer perimeter length L₄₆ disposed in a length dimension (dimension Y, in this embodiment) of the sleep surface S₄₆ of the mattress core 508. Elastic foam edge-support band 462 is disposed in a rectangular-shaped form around the outer perimeter of the mattress core 508. As disposed in the mattress assembly 504, the preassembled inner perimeter width W₄₅ (FIG. 23A) of the elastic foam edge-support band 462 is less in distance than the outer perimeter width W₄₆ of the mattress core 508. As also disposed in the mattress assembly 504, the preassembled inner perimeter length L₄₅ (FIG. 23A) of the elastic foam edge-support band 462 is less in distance than the outer perimeter length L₄₆ of the mattress core 508. The elastic foam edge-support band 462 disposed in the mattress assembly 504 is compressively engaged along the outer perimeter P₄₆ of the mattress core 508 to form the mattress assembly 504.

The elastic foam edge-support band 462 may also compressively engage at least some portions of the top and bottom surfaces of the mattress core 508. As depicted in FIG. 23B, the elastic foam edge-support band 462 may compressively engage the top surface of the mattress core 508 along the top of an entire perimeter P₄₆ of the mattress core 508 when assembled. The elastic foam edge-support band 462 may also compressively engage the bottom surface of the mattress core 508 along the bottom of an entire perimeter P₄₆ of the mattress core 508 when assembled. As disposed in the mattress assembly 504, the elastic foam edge-support band 462 has an assembled inner perimeter width W₄₆, an assembled inner perimeter length L₄₆, and an assembled height H₄₆. The assembled inner perimeter width W₄₆ of the elastic foam edge-support band 462 is greater in distance than the preassembled inner perimeter width W₄₅ (FIG. 23A) of the elastic foam edge-support band 462. Furthermore, the assembled inner perimeter length L₄₆ of the elastic foam edge-support band 462 is greater in distance than the preassembled inner perimeter length L₄₆ (FIG. 23A) of the elastic foam edge-support band 462.

The mattress core 508 of the mattress assembly 504 may comprise a top and/or bottom border wire. As depicted in FIG. 23B, the elastic foam edge-support band may overlap a top border wire of the mattress core 508 along the top of an entire perimeter P46 of the mattress core 508 when assembled. The elastic foam edge-support band may also overlap a bottom border wire of the mattress core 508 along the bottom of an entire perimeter P46 of the mattress core 508 when assembled.

The mattress core 508 depicted in FIG. 23B is an exemplary innerspring mattress core comprised of exemplary innerspring coils 506. However, mattress core 508 may be any type of mattress core, including as further non-limiting examples, a pocketed coil spring mattress core (e.g. a marshall coil mattress core) and/or a mattress core formed from a cellular material (e.g. foam).

A C-shaped elastic foam edge-support band may also be comprised of integrally formed spacers, including as non-limiting examples, an X-spaced spacer 418 (FIG. 18A) and/or a C-shaped spacer (FIG. 17A). Other spacer configurations may also be used. As further non-limiting examples, an hourglass-shaped, arrowhead-shaped, or blunted arrowhead-shaped spacer may also be integrally formed in the C-shaped elastic foam edge-support band for spacing at least a portion of the elastic foam edge-support band in relation to adjacent outer coils of a mattress core. Spacers may also provide additional edge-support or corner-support to a mattress assembly.

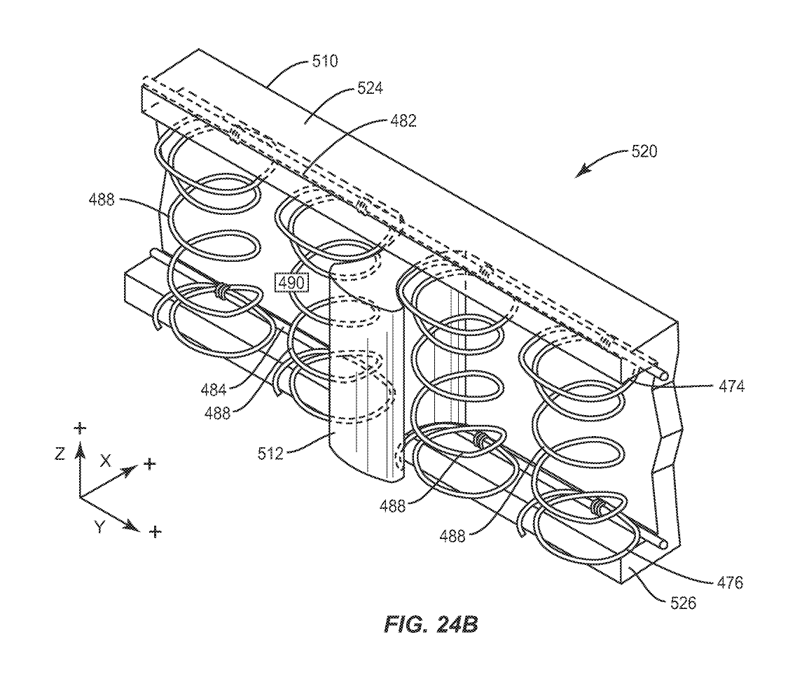

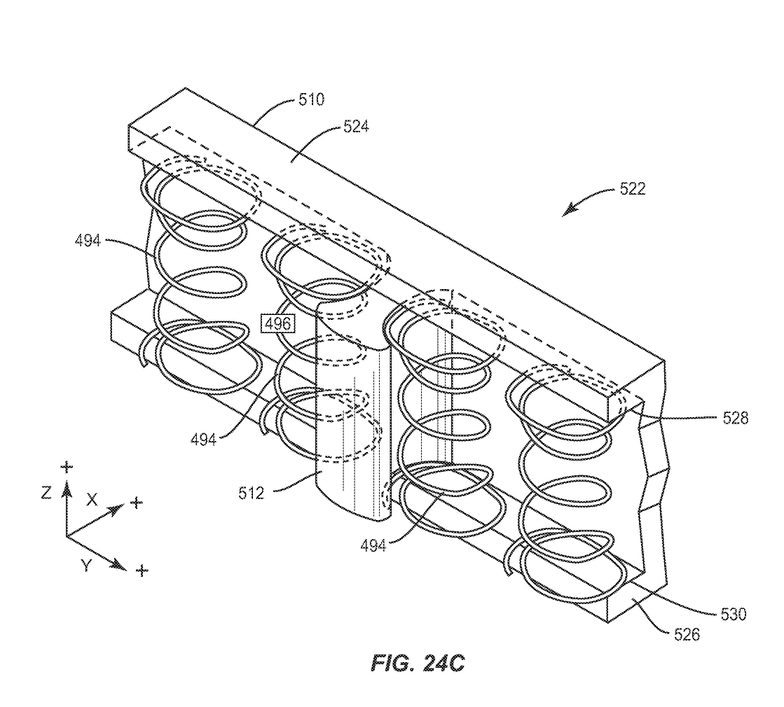

In this regard, FIG. 24A depicts an elastic foam edge-support band 510 comprised of at least one spacer 512 integrally formed in the elastic foam edge-support band 510. As depicted in FIG. 24A, the integrally formed spacer 512 may be positioned between and abutting an interior top surface 514 of the C-shaped cross section of the C-shaped elastic foam edge-support band and an interior bottom surface 516 of the C-shaped cross section of the C-shaped elastic foam edge-support band. The integrally formed spacer may also be positioned to abut an interior perimeter 518 of the elastic foam edge-support band. As depicted in FIG. 24A, the spacer may be hourglass-shaped. However, the spacer may also be formed in other shapes as previously discussed. So positioned, the integrally formed spacer positioned between and abutting the interior top surface 514 and the interior bottom surface 516 of the elastic foam edge-support band 510, the spacer 512 may increase the amount of edge-support provided by the elastic foam edge-support band 510 to a mattress core.

FIG. 24B depicts a partial perspective view of an exemplary mattress assembly 520. The exemplary mattress assembly 520 is comprised of an exemplary elastic foam edge-support band 510 compressively engaging an exemplary innerspring mattress core 490 comprised of exemplary innerspring coils 488. The exemplary elastic foam edge-support band 510 has a C-shaped cross section stretched above the top and below the bottom of exemplary coils 488 of an innerspring mattress core 490. A top portion 524 of the C-shaped foam edge-support band 510 overlaps a top border wire 482 of the innerspring mattress core 490 along the top perimeter surface 474 of the coils 488 of the mattress core 490. A bottom portion 526 of the C-shaped foam edge-support band 510 overlaps a bottom border wire 484 along the bottom perimeter surface 476 of the mattress core 490. The overlapping portions of the elastic foam edge-support band 524, 526 compressively engage the top surface 474 and bottom surface 476 of the mattress core 490. This compressive engagement secures the elastic foam edge-support band 510 to the mattress core 490. Together, the elastic foam edge-support band 510 and the top and bottom border wires 482, 484 each provide an increased edge-support for the mattress assembly 520. The elastic foam edge-support band 510 may overlap the top border wire 482 of the mattress core 490 along an entire top perimeter 474 of the mattress core 490 when assembled. The elastic foam edge-support band 510 may also overlap the bottom border wire 484 of the mattress core 490 along an entire bottom perimeter 476 of the mattress core 490 when assembled.

As previously discussed, an elastic foam edge-support band may provide increased edge-support for a mattress assembly even when the mattress assembly does not have border wires. In this regard, a mattress assembly may be comprised of an elastic foam edge-support band stretched around a mattress core having no border wires, for example, without the top and/or bottom border wires 482, 484 depicted in FIG. 24B. In this regard, FIG. 24C depicts a mattress assembly 522 comprised of the elastic foam edge-support band 510 stretched around exemplary coils 494 of an exemplary innerspring mattress core 496 having no border wires. When disposed around the mattress core 496, the elastic foam edge-support band 510 provides edge-support for the mattress assembly 522. The exemplary mattress assembly 522 is comprised of an exemplary elastic foam edge-support band 510 having a C-shaped cross section stretched above the top and below the bottom of exemplary coils 494 of an innerspring mattress core 496. A top leg (or ridge) 524 of the C-shaped foam edge-support band 510 overlaps top and bottom portions of perimeter coils 494 of the innerspring mattress core 496 along the top perimeter surface 528 and bottom perimeter surface 530 of the mattress core 496. Overlapping portions 524, 526 of the elastic foam edge-support band 510 compressively engage the top surface 528 and bottom surface 530 of the mattress core 496. This compressive engagement secures the elastic foam edge-support band 510 to the mattress core 496, while also providing an increased edge-support for the mattress assembly 522.

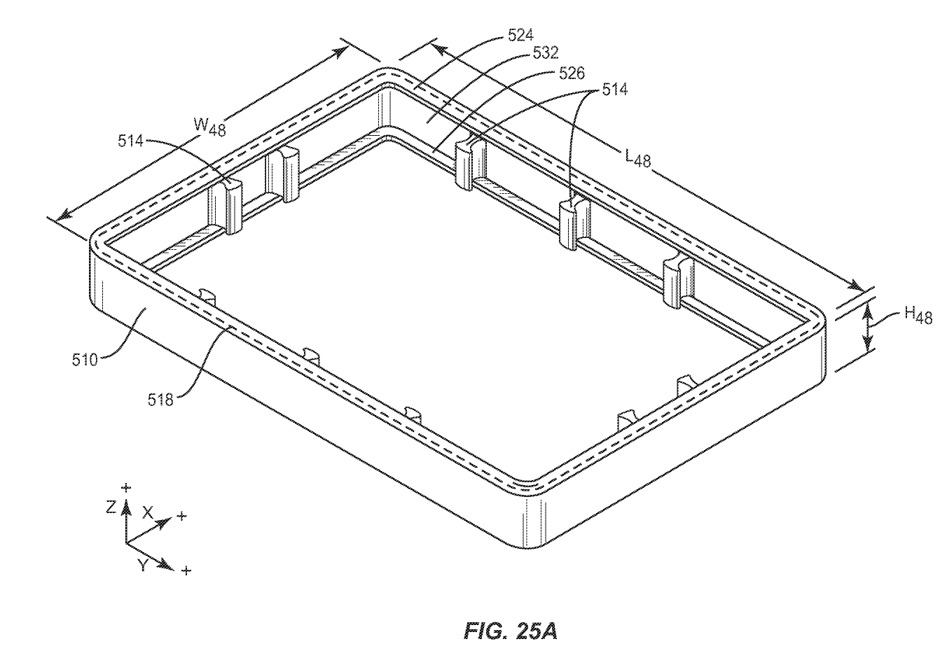

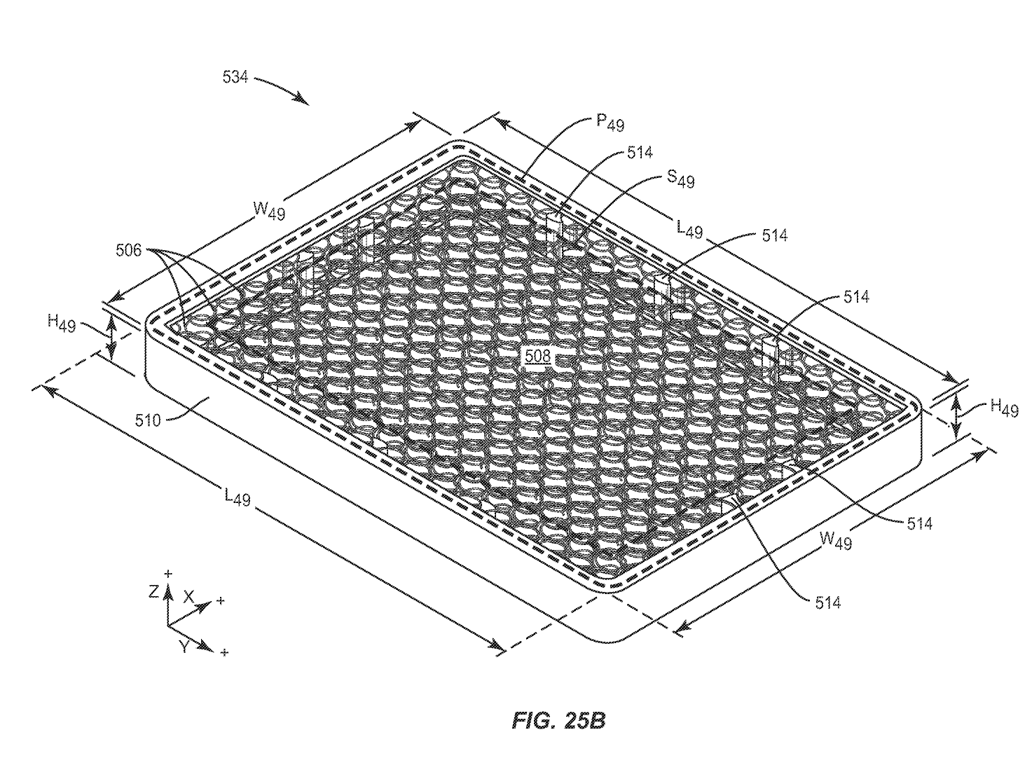

FIG. 25A is a perspective view of the exemplary elastic foam edge-support band 510 for providing edge support and corner support for a mattress assembly. Elastic foam edge-support band 510 has a C-shaped cross-section with an upper leg (or ridge) 524, a lower leg (or ridge) 526, and a perimeter portion 532. FIG. 25A shows the elastic foam edge-support band 510 prior to the assembling of a mattress assembly 534 (FIG. 25B). As depicted in FIG. 25A, the top and bottom legs (or ridges) 524, 526 extend beyond the interior surface 518 of the elastic foam edge-support band 510. The top and bottom legs (ridges) 524, 526 extend towards the interior of the elastic foam edge-support band 510. Top and bottom legs (ridges) 524, 526 may extend along the entire circumference of the elastic foam edge-support band, including along the elastic foam edge-support band's entire length L₄₈ and width W₄₈. When disposed in a rectangular shape, the elastic foam edge-support band 510 has a preassembled inner perimeter width W₄₈, a preassembled inner perimeter length L₄₈, and a preassembled height H₄₈. These dimensions are the unstretched dimensions of the elastic foam edge support band 510, before the elastic foam edge-support band 510 is stretched around a mattress core 508, as depicted in FIG. 25B.

FIG. 25B depicts a mattress assembly 534 comprised of the elastic foam edge-support band 510 disposed around the outer perimeter P₄₉ of a mattress core 508. The mattress core 508 has an outer perimeter width W₄₉ disposed in a width dimension (dimension X, in this embodiment) of the sleep surface S₄₉ of the mattress core 508 and an outer perimeter length L₄₉ disposed in a length dimension (dimension Y, in this embodiment) of the sleep surface S₄₉ of the mattress core 508. Elastic foam edge-support band 510 is disposed in a rectangular-shaped form around the outer perimeter of the mattress core 508. As disposed in the mattress assembly 534, the preassembled inner perimeter width W₄₈ (FIG. 25A) of the elastic foam edge-support band 510 is less in distance than the outer perimeter width W₄₉ of the mattress core 508. As also disposed in the mattress assembly 534, the preassembled inner perimeter length L₄₈ (FIG. 25A) of the elastic foam edge-support band 510 is less in distance than the outer perimeter length L₄₈ of the mattress core 508. The elastic foam edge-support band 510 disposed in the mattress assembly 534 is compressively engaged along the outer perimeter P₄₉ of the mattress core 508 to form the mattress assembly 534.

The elastic foam edge-support band 510 may also compressively engage at least some portions of the top and bottom surfaces of the mattress core 508. As depicted in FIG. 25B, the elastic foam edge-support band 510 may compressively engage the top surface of the mattress core 508 along the top of an entire perimeter P₄₉ of the mattress core 508 when assembled. The elastic foam edge-support band 510 may also compressively engage the bottom surface of the mattress core 508 along the bottom of an entire perimeter P₄₉ of the mattress core 508 when assembled. As disposed in the mattress assembly 534, the elastic foam edge-support band 510 has an assembled inner perimeter width W₄₉, an assembled inner perimeter length L₄₉, and an assembled height H₄₉. The assembled inner perimeter width W₄₉ of the elastic foam edge-support band 510 is greater in distance than the preassembled inner perimeter width W₄₈ (FIG. 25A) of the elastic foam edge-support band 510. Furthermore, the assembled inner perimeter length L₄₉ of the elastic foam edge-support band 510 is greater in distance than the preassembled inner perimeter length L₄₉ (FIG. 25A) of the elastic foam edge-support band 510.

The mattress core 508 of the mattress assembly 534 may comprise a top and/or bottom border wire. As depicted in FIG. 25B, the elastic foam edge-support band may overlap a top border wire of the mattress core 508 along the top of an entire perimeter P₄₆ of the mattress core 508 when assembled. The elastic foam edge-support band 510 may also overlap a bottom border wire of the mattress core 508 along the bottom of an entire perimeter P₄₆ of the mattress core 508 when assembled.

Integrally formed spacers 514 are disposed in the elastic foam edge-support band 510. Each integrally formed spacer 514 may position at least a portion of the elastic foam edge-support band 510 in relation to a pair of adjacent perimeter coils of the mattress core 508. When disposed between and abutting the top and bottom legs of the C-shaped elastic foam edge-support band, these spacers may also provide additional edge-support to the mattress assembly 534 so that the mattress assembly 534 further resists compression in height (the Z dimension, in this embodiment). Accordingly, the mattress assembly 534 provides increased support to a person sitting or laying on the edge of a mattress, thereby reducing the tendency for that edge of the mattress core to bulge, bend, or sag where an individual may disproportionally place force on the mattress core, such as during mounting onto and dismounting from the mattress.

Embodiments disclosed herein are exemplary, and may be provided together in any combination desired. Based on this disclosure, mattress assemblies may be provided by disposing any of the elastic foam edge-support bands disclosed herein around any of a variety of mattress cores, including as non-limiting examples, innerspring coil mattress cores, pocketed coil spring mattress cores (e.g. a marshall coil mattress core), and mattress cores formed from a cellular material (e.g. foam). Because each elastic foam edge-support band disclosed herein is adaptable to be disposed around a variety of types and dimensions of mattress cores, the embodiments disclosed herein enable a mattress core manufacturer to maintain a reduced inventory of elastic foam edge-support band SKUs while maintaining the manufacturer's ability to manufacture a variety of mattresses with different cores and dimensions. Further, the embodiments provided herein may provide a manufacturer with reduced mattress assembly times, thereby reducing the manufacturer's labor costs. For example, because the embodiments herein provide an elastic foam edge-support band, assemblies utilizing these embodiments may be more quickly installed and may necessitate fewer additional attachments than traditional mattress assembly methods.

Those skilled in the art will recognize improvements and modifications to the embodiments disclosed herein. Many modifications and other embodiments of the invention set forth herein will come to mind to one skilled in the art to which the invention pertains having benefit of the teachings presented in the foregoing descriptions and the associated drawings. These modifications include, but are not limited to, the type of mattress core, elastic foam edge-support band, mattress core, and the number and type of integrally formed expansion joints formed therein. Attachment members can be provided in the elastic foam edge-support band, but are optional and not required, If included, the number of attachment members can be varied as desired. The materials or compositions of the aforementioned components can be varied as well, including but not limited to whether exclusively thermoset or thermoplastic materials, or a composite of both. All such improvements and modifications are considered within the scope of the concepts disclosed herein.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art.

Further, it is to be understood that the embodiments are not limited to the specific embodiments disclosed and that modifications and other embodiments are intended to be included within the scope of the appended claims. It is intended that the embodiments cover the modifications and variations of this invention provided they come within the scope of the appended claims and their equivalents. Although specific terms are employed herein, they are used in a generic and descriptive sense only and not for purposes of limitation.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A mattress assembly, comprising:
a mattress core having an outer perimeter and a sleep surface disposed within the outer perimeter, the outer perimeter having an outer perimeter length disposed in a length dimension of the sleep surface and an outer perimeter width disposed in a width dimension of the sleep surface; and
at least one elastic foam edge-support band having a preassembled inner perimeter, the preassembled inner perimeter having a preassembled inner perimeter length and a preassembled inner perimeter width when the at least one elastic foam edge-support band is provided in a rectangular-shaped form,
the preassembled inner perimeter length of the at least one elastic foam edge-support band is less in distance than outer perimeter length of the mattress core, and the preassembled inner perimeter width of the at least one elastic foam edge-support band is less in distance than the outer perimeter width of the mattress core,
the at least one elastic foam edge-support band compressively engaged along the outer perimeter of the mattress core to form the mattress assembly, the at least one elastic foam edge-support band having an assembled inner perimeter length and an assembled inner perimeter width, and
the assembled inner perimeter length of the at least one elastic foam edge-support band is greater in distance than the preassembled inner perimeter length of the at least one elastic foam edge-support band, and the assembled inner perimeter width of the at least one elastic foam edge-support band is greater in distance than the preassembled inner perimeter width of the at least one elastic foam edge-support band.

2. The mattress assembly of claim 1, further comprising at least one expandable joint integrally formed in the at least one elastic foam edge-support band,
wherein the at least one expandable joint is configured to expand in at least one of a length or width direction of the at least one elastic foam edge-support band to allow the perimeter of the at least one elastic foam edge-support band to be expanded.

3. The mattress assembly of claim 2, wherein the at least one expandable joint is comprised of a plurality of openings integrally formed in the at least one elastic foam edge-support band.

4. The mattress assembly of claim 3, wherein the plurality of openings are configured to be expanded to different sizes when a tension force is placed on the at least one elastic foam edge-support band.

5. The mattress assembly of claim 4, wherein a first opening among the plurality of openings is disposed on a top edge of the at least one elastic foam edge-support band, and a second opening among the plurality of openings is disposed on a bottom edge of the at least one elastic foam edge-support band.

6. The mattress assembly of claim 4, wherein the plurality of openings are comprised of a plurality of punctures.

7. The mattress assembly of claim 2, wherein the at least one expandable joint is comprised of at least one non-planar portion integrally formed in the at least one elastic foam edge-support band.

8. The mattress assembly of claim 7, wherein the at least one non-planar portion extends between a top edge and a bottom edge of the at least one elastic foam edge-support band.

9. The mattress assembly of claim 7, wherein the at least one non-planar portion is comprised of at least one expandable enclosure having at least one interior.

10. The mattress assembly of claim 2, wherein the at least one expandable joint is comprised of a plurality of openings integrally formed in the at least one foam edge-support band.

11. The mattress assembly of claim 1, wherein the at least one elastic foam edge-support band provides edges of the mattress assembly with a greater resistance to z-axis compression than resistance to z-axis compression provided by the mattress core.

12. The mattress assembly of claim 1, wherein the at least one elastic foam edge-support band is comprised of a plurality of elastic foam edge-support bands.

13. The mattress assembly of claim 12, wherein a first elastic foam edge-support band of the plurality of elastic foam edge-support bands has a height which is greater in distance than a height of a second elastic foam edge-support band of the plurality of elastic foam edge-support bands.

14. The mattress assembly of claim 12, wherein a first elastic foam edge-support band of the plurality of elastic foam edge-support bands is formed of one or more different materials than a second elastic foam edge-support band of the plurality of elastic foam edge-support bands.

15. The mattress assembly of claim 1, wherein the at least one elastic foam edge-support band is assembled without any welds.

16. The mattress assembly of claim 15, wherein the at least one elastic foam edge-support band is formed from a mold.

17. The mattress assembly of claim 1, wherein the at least one elastic foam edge-support band is comprised of an elongated member having a first end and a second end, wherein the first end and the second end are secured together to form the at least one elastic foam edge-support band.

18. The mattress assembly of claim 1, further comprising at least one weld disposed in the at least one elastic foam edge-support band.

19. The mattress assembly of claim 1, wherein the at least one elastic foam edge-support band is comprised of:
a plurality of side members each having two ends; and
a plurality of corner members each having two ends,
wherein each end of each corner member of the plurality of corner members is secured to an end of a side member of the plurality of side members to form the elastic foam edge-support band.

20. The mattress assembly of claim 1, wherein the elastic foam edge-support band has a C-shaped cross section.

21. The mattress assembly of claim 20, wherein the elastic foam edge-support band further comprises at least one integrally formed spacer positioned between and abutting an interior top portion of the C-shaped cross section and an interior bottom portion of the C-shaped cross section.

22. The mattress assembly of claim 1,
the mattress core having a height orthogonal to the sleep surface; and
the at least one elastic foam edge-support band having a preassembled height, the preassembled height of the at least one elastic foam edge-support band is less in distance than the height of the mattress core,
the at least one elastic foam edge-support band compressively engaged along top and bottom surfaces of the mattress core when assembled to form the mattress assembly, and
the at least one elastic foam edge-support band having an assembled height, the assembled height of the at least one elastic foam edge-support band is greater in distance than the preassembled height of the elastic foam edge-support band.

23. The mattress assembly of claim 1, wherein the elastic foam edge-support band overlaps a top border wire of the mattress core along an entire top perimeter of the mattress core when assembled.

24. The mattress assembly of claim 1, wherein the elastic foam edge-support band overlaps a bottom border wire of the mattress core along an entire bottom perimeter of the mattress core when assembled.

25. The mattress assembly of claim 1, further comprising at least one expandable joint integrally formed in the at least one elastic foam edge-support band, the at least one expandable joint configured to expand in a height direction of the at least one elastic foam edge-support band to allow the height of the at least one elastic foam edge-support band to be expanded when assembled.

26. The mattress assembly of claim 25, wherein the at least one expandable joint is comprised of at least one non-planar portion integrally formed in the at least one elastic foam edge-support band.

27. The mattress assembly of claim 26, wherein the at least one non-planar portion extends between a top edge and a bottom edge of the at least one elastic foam edge-support band.

28. The mattress assembly of claim 1, further comprising at least one ventilation channel disposed in the at least one elastic foam edge-support band to ventilate atmosphere from the outer perimeter of the at least one elastic foam edge-support band to the assembled inner perimeter of the at least one elastic foam edge-support band.

29. The mattress assembly of claim 1, further comprising at least one attachment member fastening the at least one elastic foam edge-support band to the mattress core.

30. The mattress assembly of claim 29, wherein the at least one attachment member fastens the at least one elastic foam edge-support band to at least one innerspring coil of the mattress core.

31. The mattress assembly of claim 30, wherein the at least one attachment member comprises at least one crimped ring encircling at least a portion of the at least one innerspring coil of the mattress core and at least a portion of the at least one elastic foam edge-support band.

32. The mattress assembly of claim 1, further comprising a mattress base, wherein at least a portion of the at least one elastic foam edge-support band is secured to the mattress base.

33. The mattress assembly of claim 1, wherein the preassembled inner perimeter of the at least one elastic foam edge-support band is comprised from the group consisting of: inclusively between 80.0 percent and 98.3 percent of the outer perimeter of the mattress core, inclusively between 95.9 percent and 98.3 percent of the outer perimeter of the mattress core, and 96 percent of the outer perimeter of the mattress core.

34. A method of providing a mattress assembly, comprising:
providing a mattress core having an outer perimeter and a sleep surface disposed inside the outer perimeter, the outer perimeter having an outer perimeter length disposed in a length dimension of the sleep surface and an outer perimeter width disposed in a width dimension of the sleep surface;
providing at least one elastic foam edge-support band having a preassembled inner perimeter, the preassembled inner perimeter having a preassembled inner perimeter length and a preassembled inner perimeter width when the at least one elastic foam edge-support band is provided in a rectangular-shaped form,
the preassembled inner perimeter length of the at least one elastic foam edge-support band less in distance than outer perimeter length of the mattress core, and the preassembled inner perimeter width of the at least one elastic foam edge-support band less in distance than the outer perimeter width of the mattress core; and
disposing the at least one elastic foam edge-support band along the outer perimeter of the mattress core to form the mattress assembly such that the at least one elastic foam edge-support band compressively engages the outer perimeter of the mattress core along its width and length, the at least one elastic foam edge-support band having an assembled inner perimeter length and an assembled inner perimeter width,
wherein the assembled inner perimeter length of the at least one elastic foam edge-support band is greater in distance than the preassembled inner perimeter length of the at least one elastic foam edge-support band, and the assembled inner perimeter width of the at least one elastic foam edge-support band is greater in distance than the preassembled inner perimeter width of the at least one elastic foam edge-support band.

35. The method of claim 34, wherein the disposing comprises stretching the at least one elastic foam edge-support band along the outer perimeter of the mattress core to form the mattress assembly such that the at least one elastic foam edge-support band compressively engages the outer perimeter of the mattress core along its width and length.

36. The method of claim 34, further comprising forming the at least one elastic foam edge-support band without any welds.

37. The method of claim 34, further comprising forming the at least one elastic foam edge-support band with at least one weld.

38. The method of claim 34, further comprising:
providing a plurality of side members each having two ends;
providing a plurality of corner members each having two ends; and
securing each end of each corner member of the plurality of corner members to an end of a side member of the plurality of side members to form the elastic foam edge-support band.

39. The method of claim 34,
the mattress core having a height orthogonal to the sleep surface; and
the at least one elastic foam edge-support band having a preassembled height, the preassembled height of the at least one elastic foam edge-support band less in distance than the height of the mattress core,
the method further comprising:
disposing the at least one elastic foam edge-support band to compressively engage portions of top and bottom surfaces of the mattress core when assembled to form the mattress assembly, the at least one elastic foam edge-support band having an assembled height,
wherein the assembled height of the at least one elastic foam edge-support band is greater in distance than the preassembled height of the elastic foam edge-support band.

40. A mattress assembly, comprising:
a mattress core having an outer perimeter and a sleep surface disposed inside the outer perimeter, the outer perimeter having an outer perimeter length disposed in a length dimension of the sleep surface and an outer perimeter width disposed in a width dimension of the sleep surface; and
at least one elastic foam edge-support band having a preassembled inner perimeter, the preassembled inner perimeter having a preassembled inner perimeter length and a preassembled inner perimeter width,
at least one of the preassembled inner perimeter length and the preassembled inner perimeter width of the preassembled inner perimeter is less in distance than a corresponding at least one of the outer perimeter length and the outer perimeter width of the mattress core, and
the at least one elastic foam edge-support band compressively engaged along the outer perimeter of the mattress core to form the mattress assembly, the at least one elastic foam edge-support band having an assembled inner perimeter length and an assembled inner perimeter width, wherein at least one of the assembled inner perimeter length and the assembled inner perimeter width is greater in distance than a corresponding at least one of the preassembled inner perimeter length and the preassembled inner perimeter width of the at least one elastic foam support band.
